(19) United States
(12) Patent Application Publication
(10) Pub. No.: US 2013/0268881 A1
(43) Pub. Date: Oct. 10, 2013

(54) Letter Generation, Communication, And Management

(71) Applicant: Drew Charles Bartkiewicz, Canton, CT (US)

(72) Inventor: Drew Charles Bartkiewicz, Canton, CT (US)

(21) Appl. No.: 13/786,467

(22) Filed: Mar. 6, 2013

Related U.S. Application Data
(60) Provisional application No. 61/607,183, filed on Mar. 6, 2012.

(51) Int. Cl. G06F 3/0484

(52) U.S. Cl. CPC G06F 3/0484
USPC 715/780

(57) ABSTRACT

A computer implemented method and system for generating, communicating, and managing letters in different formats provide a letter management database (LMD) and a letter communication application (LCA) communicating with the LMD via a network. The LMD uploads, stores, aggregates, archives, curates, organizes, searches, and provides access to the letters. The LCA is accessible via a sender device and recipient devices and generates, communicates, manages, and provides access to the letters. The LCA generates a personalized letter based on a selection of displayed themes and writing style options, and media content and tags acquired from the sender device. The LCA acquires a selection of one or more delivery options and at least one recipient identifier from the sender device for delivering the generated personalized letter to one or more recipients and/or recipient devices. The LCA facilitates access to the generated personalized letter through one or more access modes via the LMD.

### CROSS REFERENCE TO RELATED APPLICATIONS

This application claims the benefit of provisional patent application No. 61/607,183 titled “Lett.rs Mail as Service Platform”, filed in the United States Patent and Trademark Office on Mar. 6, 2012.

The specification of the above referenced patent application is incorporated herein by reference in its entirety.

### BACKGROUND

In an age of instant communication where intimacy is sacrificed for immediacy, the need for a letter communication application that allows a user to create and manage letters is high. A letter is inspired by both digital and physical events, reveals a common link between people, and connects people all over the world. Communication through written letters typically requires people to actually think about what they are writing. Since the advent of digital media, people are communicating more but writing less. The number of people writing letters has drastically reduced and communication with others through a meaningful exchange of letters has reduced, for example, due to time constraints, unavailability of a recipient's physical or home address, etc. Accordingly, there is a need for a computer implemented method and a computer implemented system that enable a user to engage in a written form of communication using a digital writing desk to create new letters, preserve letters passed on, share letters with friends in different digital and non-digital formats, and access letters through multiple access modes.

Conventional communication systems do not support meaningful communication in the form of exchange of letters for both business and personal uses. Moreover, a conventional communication system cannot create new letters with the assistance of old handwritten letters or inspire creation of new letters from social media “likes”, “tweets”, etc., associated with letters of particular importance to the world. Furthermore, conventional communication systems do not facilitate searching of letters that transcend time and deserve a broader audience via multiple search options, for example, based on a category, a topic, a tag, a keyword, a timestamp, etc. Furthermore, conventional communication systems do not provide adequate access to the created letters in different digital and non-digital formats.

Hence, there is a long felt but unresolved need for a computer implemented method and a computer implemented system that create, communicate, and manage letters in multiple different formats, provide social network integration, provide search options for searching letters, provide a large variety of delivery options for delivering the created letters to a recipient using a single recipient identifier even though a sender does not know the physical address or an electronic address of the recipient, provide access to the created letters through multiple access modes, allow uploading, commenting, archiving, and preservation of hand written letters, create new letters with the assistance of old handwritten letters and other media content, and convert existing communication objects, for example, electronic mail to a letter. Furthermore, there is a need for a computer implemented method and a computer implemented system that generate revenue through a letter communication application using customizable objects that can adorn the letters and other revenue generation options.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The computer implemented method and system disclosed herein address the above stated needs for creating, communicating, and managing letters in multiple different formats, providing social network integration, searching letters via multiple search options, providing a large variety of delivery options for delivering the created letters to a recipient using a single recipient identifier even though a sender does not know the physical or home address or an electronic address of a recipient, providing access to the created letters through multiple access modes, allowing uploading, commenting, archiving, and preservation of hand written letters, and creating new letters with the assistance of old handwritten letters and other media content. As used herein, the term “sender” refers to a user who initiates creation and delivery of a letter to a recipient. Also, as used herein, the term “recipient” refers to a user who receives a letter from a sender. Moreover, the computer implemented method and system disclosed herein convert communication objects, for example, electronic mail (email) to a letter through application programming interfaces (APIs) to enable and manage a more meaningful communication. Furthermore, the computer implemented method and system disclosed herein generate revenue through a letter communication application using customizable adornment objects that can adorn the letters, customizable dynamic objects such as themes that create unique computer enabled letters, and by enabling delivery of a personalized letter via postal mail.

The computer implemented method and the computer implemented system disclosed herein provide a letter management database configured to upload, store, aggregate, archive, curate, organize, search, and provide access to letters in different formats, for example, a digital format and a non-digital format. The computer implemented method and the computer implemented system disclosed herein also provide a letter communication application executable by at least one processor configured to generate, communicate, manage, and provide access to letters in different formats. The letter communication application is accessible via a sender device and one or more recipient devices via a network. In an embodiment, the letter communication application is configured as a web based platform. In another embodiment, the letter communication application is configured as a software application downloadable on the sender device and each of the recipient devices. The letter communication application is configured to communicate with the letter management database via the network.

In an embodiment, the letter communication application registers the senders and the recipients and stores their profile information in the letter management database. The letter communication application assigns a unique identification code, for example, a post box number to each of the recipients on registration of the recipients. The unique identification code is configured as a recipient identifier for delivery of a personalized letter generalized by the letter communication application. Therefore, even though a sender does not know the physical address or an electronic address of a recipient, the sender can send a personalized letter to the recipient using the unique identification code assigned by the letter communication application.

The letter communication application displays multiple static and dynamic themes and writing style options, for example, a hand writing style on the sender device via a graphical user interface (GUI) provided by the letter communication application. The letter communication application acquires a selection of one or more of the displayed themes and one or more of the displayed writing style options from the sender device via the GUI for generating a personalized letter. The letter communication application acquires media content and tags for the generation of the personalized letter from the sender device via the GUI. The media content comprises, for example, one or more of textual content, image content, audio content, video content, multimedia content, digital content, electronic mail (email) content, voicemail content, document content, social media content such as “likes”, “tweets”, etc., and any combination thereof. In an embodiment, the letter communication application analyzes the acquired media content and converts selective portions of the acquired media content, for example, as connected and imbedded assets into a consequent letter. In an embodiment, the tags used for the generation of the personalized letter comprise labels generated from a part, for example, text, image, location, etc., of the personalized letter. The letter communication application allows a user to send for any one personalized letter and to add tags and comments to help the user remember and share the personalized letter at a later point in time. The letter communication application generates the personalized letter based on the acquired selection of one or more of the displayed themes and one or more of the displayed writing style options, and the acquired media content and tags. In an embodiment, the letter communication application displays multiple customizable display elements, for example, images, videos, textual content, etc., on the sender device via the GUI. The letter communication application acquires a selection of one or more of the customizable display elements from the sender device via the GUI. In addition to the acquired selection of one or more of the displayed themes and one or more of the displayed writing style options, and the acquired media content and tags, the letter communication application is also configured to generate the personalized letter based on the acquired selection of one or more of the customizable display elements.

The letter communication application displays multiple delivery options on the sender device via the GUI for delivering the generated personalized letter. The delivery options comprise, for example, delivering the generated personalized letter on demand to each of one or more recipients via postal mail, printing the generated personalized letter for delivering the printed personalized letter, posting the generated personalized letter on an electronic dashboard provided on the GUI by the letter communication application of each of the recipients, and delivering a digital notification of the generated personalized letter to each of the recipient devices via one or more of multiple communication modes. The communication modes comprise, for example, electronic mail (email), a short message service (SMS), a multimedia messaging service (MMS), etc. To deliver the generated personalized letter to each of the recipients via postal mail, the letter communication application acquires transactional information from the sender device via the GUI. The transactional information comprises, for example, stationery options for printing the generated personalized letter, payment options for delivering the generated personalized letter via postal mail, etc. To deliver the digital notification of the generated personalized letter to each of the recipient devices, the letter communication application delivers the digital notification to an electronic mail address of each of the recipients, or posts the digital notification on the electronic dashboard of each of the recipients, or delivers the digital notification to a social network identification address of each of the recipients, or delivers the digital notification to each of one or more of multiple electronic platforms and channels via the electronic dashboard.

The delivery options further comprise, for example, delivering the generated personalized letter at a present date or a future date to each of the recipients via postal mail or digital mail. The delivery options further comprise, for example, delivering the generated personalized letter to each of the recipients based on changes detected in a social graph of a sender and each of the recipients. The letter communication application acquires a selection of one or more of the displayed delivery options and at least one recipient identifier of each of one or more recipients from the sender device via the GUI. The recipient identifier is, for example, a unique identification code such as a post box number, an electronic mail address, a postal address, a social network identification address of each of the recipients, etc. The letter communication application delivers the generated personalized letter in one or more of the different formats to the recipients and/or the recipient devices of the recipients using the acquired selection of the displayed delivery options and the recipient identifier. In an embodiment, the letter communication application creates a physical address using the recipient identifier for delivering the generated personalized letter to each of the recipients via postal mail.

The letter communication application further sends and receives digital notifications on multiple transaction events via one or more of different communication modes. The transaction events are, for example, delivery of the generated personalized letter, arrival of the generated personalized letter, receipt of a comment on a specific shared letter object displayed on a user's electronic dashboard, receipt of comments about a media object, for example, the generated personalized letter, sharing the generated personalized letter or the other letters via the electronic dashboard, etc. In an embodiment, the letter communication application delivers the generated personalized letter to each of the recipients based on changes detected in a social graph of the sender and each of the recipients. The letter communication application delivers the generated personalized letter to a recipient when an application programming interface (API) driven event is triggered. An API driven event is an event triggered by an API, for example, an event on a user's Facebook® application such as a change in status on a user's Facebook® profile.

The letter communication application facilitates access to the generated personalized letter through one or more of multiple access modes via the letter management database. In an embodiment, the access mode is a digital access identifier, for example, a uniform resource locator (URL), a quick response (QR) code, a digital watermark, etc., inserted on the generated personalized letter. The digital access identifier is configured to allow each of the recipient devices to add the generated personalized letter to the electronic dashboard provided on the GUI by the letter communication application, or retrieve the generated personalized letter from the letter management database, or to preserve and share the generated personalized letter. In another embodiment, the access mode is the electronic dashboard provided on the GUI by the letter communication application for sharing the generated personalized letter and other letters. In another embodiment, the access mode is the recipient identifier for retrieval of the generated personalized letter from the letter management database by each of the recipients. In another embodiment, the access modes comprise digital notifications of the generated personalized letter delivered to each of the recipient devices, for example, via the email address of each of the recipients, the electronic dashboard, the social network identification address of each of the recipients, one or more of the electronic platforms and channels, etc.

The letter communication application further uploads and stores existing letters in the letter management database. The letter communication application, in communication with the letter management database, is configured to preserve the existing letters or generate the personalized letter using the existing letters. In an embodiment, the letter communication application enables searching for the generated personalized letter and other letters in the letter management database via one or more of multiple search options. The search options comprise, for example, a category based search, a topic based search, a tag based search, a keyword based search, a timestamp based search, a user based search, a date based search, and a popularity based search.

In an embodiment, the letter communication application archives the generated personalized letter from an electronic dashboard displayed on the GUI on the sender device and each of the recipient devices. In another embodiment, the letter communication application acquires approval from the sender device and each of the recipient devices via the GUI for sharing the generated personalized letter publicly on the electronic dashboard. In another embodiment, the computer implemented method and system disclosed herein integrates multiple social networking applications within the letter communication application via the network. The integration is configured to facilitate generation and delivery of the personalized letter, and communication of the generated personalized letter via the network.

In an embodiment, the letter communication application provides customizable adornment objects for display on an electronic dashboard provided on the GUI. The customizable adornment objects are configured for one or more of a static display, an integration of media files and digital links to electronic commerce destinations, advertisements, and revenue generation options, and triggering of one or more incentives. In an embodiment, the letter communication application generates revenue by providing customizable adornment objects for display and selection on the electronic dashboard and for sponsorship, for a predetermined fee. In another embodiment, the letter communication application generates revenue by providing one or more themes for the generation of the personalized letter and for sponsorship for a predetermined fee. In another embodiment, the letter communication application generates revenue by delivering the generated personalized letter to each of the recipients via postal mail.

The letter communication application provides a medium for experiencing the timeless art of letter communication by creating a postal and letter delivery system with a digital to paper closed loop in a cloud computing environment. The letter communication application converts any digital object to a personalized letter using an application programming interface, and transforms the digital object to a digital letter or a paper letter, accessible by notification links in the cloud computing environment. The converted digital objects and media objects are manageable within the letter communication application and network for letter creation, delivery, and organization. The letter communication application allows a user to design a life around meaningful communications by collecting letters on the user's personal letter display, that is, on the electronic dashboard.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein.

FIG. 1 illustrates a computer implemented method for generating, communicating, and managing letters of multiple different formats.

FIG. 2 exemplarily illustrates a graphical representation showing analysis and conversion of selective portions of media content into a consequent letter.

FIGS. 3A-3D exemplarily illustrate a process flow diagram comprising the steps for creating, sharing, preserving, organizing, and delivering a personalized letter.

FIG. 4 exemplarily illustrates a structural design of the letter communication application.

FIG. 5 exemplarily illustrates functions performed by the letter communication application via different interface sections provided on a graphical user interface.

FIGS. 6A-6F exemplarily illustrate screenshots of a graphical user interface provided by the letter communication application for registering and logging a user into the letter communication application.

FIGS. 7A-7K exemplarily illustrate screenshots of a graphical user interface provided by the letter communication application, showing different interface sections provided by the letter communication application.

FIGS. 8A-8B exemplarily illustrate screenshots of a graphical user interface provided by the letter communication application configured as a software application downloadable on a user device.

FIGS. 9A-9C exemplarily illustrate screenshots of a graphical user interface provided by the letter communication application for generating a personalized letter.

FIGS. 10A-10C exemplarily illustrate screenshots of a graphical user interface provided by the letter communication application, showing multiple delivery options for delivering the generated personalized letter.

FIGS. 11A-11F exemplarily illustrate screenshots of a graphical user interface provided by the letter communication application for delivering the generated personalized letter via postal mail.

FIGS. 12A-12B exemplarily illustrate screenshots of a graphical user interface provided by the letter communication application, showing different viewing options provided by the letter communication application.

FIGS. 13A-13C exemplarily illustrate screenshots of a graphical user interface provided by the letter communication application for editing and composing a new personalized letter from an existing letter stored in a letter management database.

FIG. 14 exemplarily illustrates a screenshot of a graphical user interface provided by the letter communication application for uploading and preserving letters and sharing information about the letters.

FIG. 15 exemplarily illustrates a screenshot of a graphical user interface provided by the letter communication application, showing letters from developers of the letter communication application.

FIG. 16 exemplarily illustrates a screenshot of a graphical user interface provided by the letter communication application, showing various application programming interfaces of the letter communication application.

FIG. 17 exemplarily illustrates a screenshot of a graphical user interface provided by the letter communication application, showing the steps involved in generating and receiving a personalized letter as well as browsing options provided to a user by the letter communication application.

FIGS. 18A-18D exemplarily illustrate screenshots of a graphical user interface provided by the letter communication application, showing customizable adornment objects provided by the letter communication application for display on an electronic dashboard provided on the graphical user interface.

FIG. 19 exemplarily illustrates revenue generation options provided by the letter communication application.

FIG. 20 exemplarily illustrates an implementation of the letter communication application in an online classroom environment.

FIGS. 21A-21B illustrate embodiments of a computer implemented system for generating, communicating, and managing letters of multiple different formats.

FIG. 22 exemplarily illustrates an architecture of a computer system employed by the letter communication application for generating, communicating, and managing letters of multiple different formats.

### DETAILED DESCRIPTION OF THE INVENTION

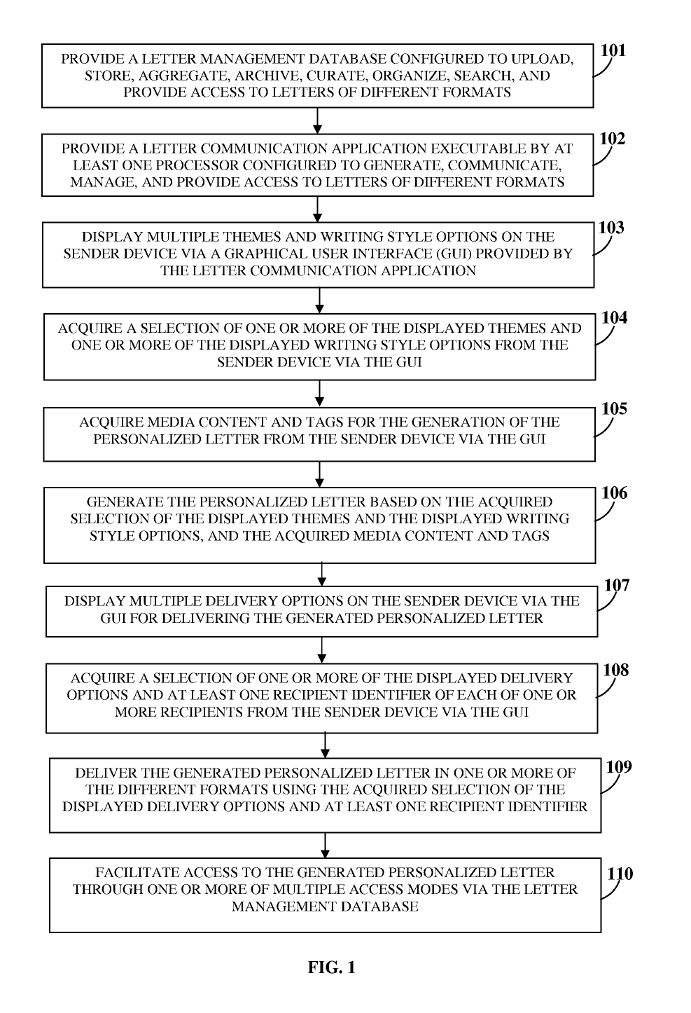

FIG. 1 illustrates a computer implemented method for generating, communicating, and managing letters of multiple different formats. The computer implemented method disclosed herein revives and enhances the concept of personalized letters by providing a relational letter management database and a thoughtful communication platform for education, publishing, consumer brands, and anyone who loves to write letters. The computer implemented method disclosed herein provides 101 a letter management database configured to upload, store, aggregate, archive, curate, organize, search, and provide access to letters in different formats, for example, digital formats and non-digital formats. The letter management database stores, for example, letters from different centuries. The letter management database also stores interesting personal letters and noteworthy letters from celebrities, for example, Marilyn Monroe, Elvis Presley, Beyoncé, and former presidents such as Eisenhower. In an embodiment, the letter management database is a cloud database that runs on a cloud computing platform, for example, PC Backup™ of MyPCBackup, Ltd., Amazon EC2 of Amazon Technologies Inc., GoGrid® of GoGrid, LLC, and the Rackspace® cloud of Rackspace US, Inc.

The computer implemented method disclosed herein also provides 102 a letter communication application executable by at least one processor configured to generate, communicate, manage, and provide access to letters in different formats. The letter communication application facilitates, inspires, and organizes the world's lasting communications. The letter communication application is configured to communicate with the letter management database via a network. The network is, for example, a wired network, a wireless network, a network that implements Wi-Fi® of the Wireless Ethernet Compatibility Alliance, Inc., an ultra-wideband communication network (UWB), a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a long-term evolution (LTE) mobile communication network, etc., a local area communication network, an internet connection network, an infrared communication network, etc., or a network formed from a combination of these networks.

The letter communication application allows users, for example, senders and recipients to catalog, preserve, organize, share, and communicate in a more thoughtful way, utilizing a hybrid digital and/or analog system. As used herein, the term “sender” refers to a user who initiates creation and delivery of a letter to a recipient using the letter communication application. Also, as used herein, the term “recipient” refers to a user who receives a letter from a sender via the letter communication application. Also, as used herein, the term “user” refers to a sender or a recipient of a personalized letter. The letter communication application assists worldwide culture by shedding light on historical letters and helping create new letters. The letter communication application is accessible via a sender device and one or more recipient devices via the network. As used herein, the term “sender device” refers to a user device utilized by a sender of a letter to access the letter communication application and the letter management database. Also, as used herein, the term “recipient device” refers to a user device utilized by a recipient of a letter to access the letter communication application and the letter management database. The sender device and the recipient devices are also referred to as a “user device”. The user device is a linear electronic device or a non-linear electronic device, for example, a personal computer, a tablet computing device, a mobile computer, a mobile phone, a smart phone, a portable computing device, a laptop, a personal digital assistant, a touch centric device, a workstation, a client device, a portable electronic device, a network enabled computing device, an interactive network enabled communication device, any other suitable computing equipment, and combinations of multiple pieces of computing equipment, etc. In an embodiment, the letter communication application is configured as a software application downloadable on the user device. In another embodiment, the letter communication application is configured as a web based platform, for example, a website hosted on a server or a network of servers. The user device can access the letter communication application configured as the web based platform via the network, for example, the internet. The letter communication application is configured as the web based platform for curating, aggregating, and organizing multiple paper letters into a social and display model, while integrating web services and a relational letter management database to create a system for letter writing in a digital environment.

In an embodiment, the letter communication application registers the senders and the recipients and stores their profile information in the letter management database. The letter communication application assigns a unique identification code, for example, a post box number to each of the recipients on registration of the recipients with the letter communication application. The unique identification code is configured as a recipient identifier for delivery of a personalized letter generated by the letter communication application. Therefore, even though a sender does not know the physical address or an electronic address of a recipient, the sender can send a personalized letter to the recipient using the unique identification code assigned by the letter communication application. In an embodiment, the unique identification code is linked to a recipient's address registered with the letter communication application for delivery of the personalized letter.

In an embodiment, the computer implemented method and system disclosed herein are implemented in a cloud computing environment. The letter communication application, in communication with the letter management database, offers a collection of letters to users by bringing cloud based syncing across various sender devices and recipient devices worldwide. In an embodiment, the letter communication application is implemented as a mail-as-a-service model hosted in the cloud computing environment and helps users create more meaningful exchanges of thoughts, feelings, and ideas by allowing the users to convert their life's significant moments into rich, timeless letters. The mail-as-a-service operates with web, mobile, and other web and real world integrations. The letter communication application allows the users to create and deliver letters via the cloud as a personal post office, upload and preserve handwritten personal letters in the letter management database, display meaningful letters publicly by displaying them on an electronic dashboard provided on a graphical user interface (GUI) by the letter communication application, explore thousands of personal and noteworthy letters and share them socially via social networks, and send open public letters or petitions for supporting a cause, a person, or a brand. The letter communication application provides application programming interfaces (APIs) for allowing digital assets and communications to seamlessly travel to real world communications, for example, from electronic mail to a paper letter and vice versa. The letter communication application can be used, for example, by internet users, businesses, letter writers, archivists, entertainment seekers, etc., via websites, mobile devices, and other network and real world integrations. The real world integrations comprise paper letters as well as geo-locations.

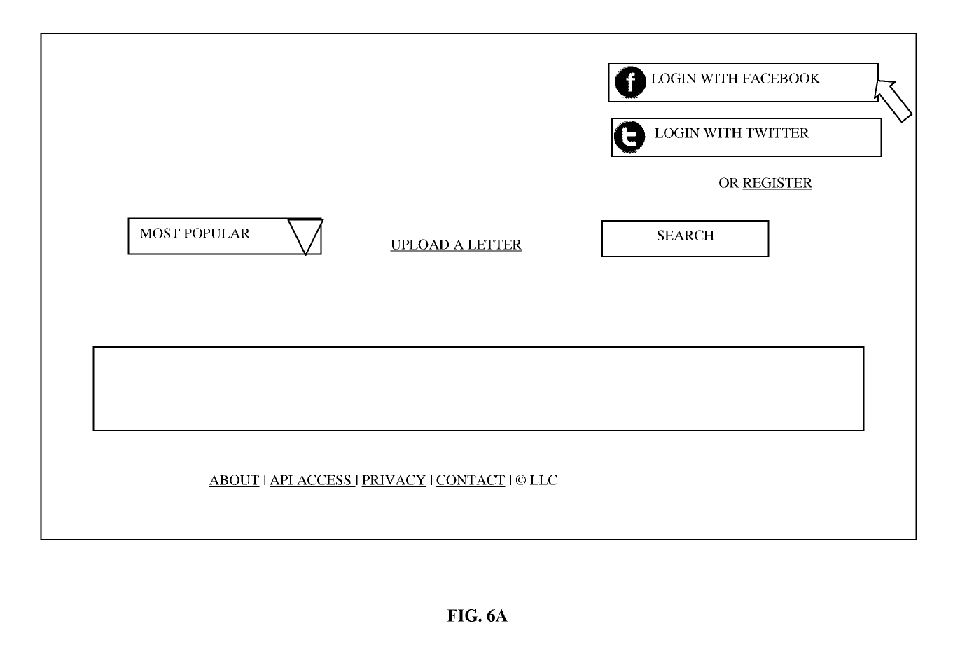

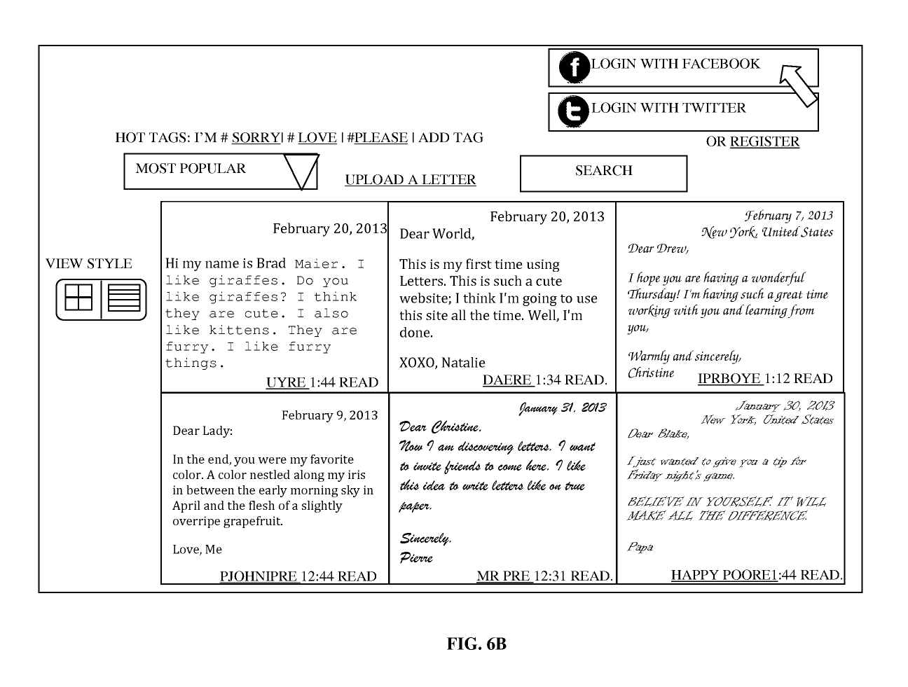

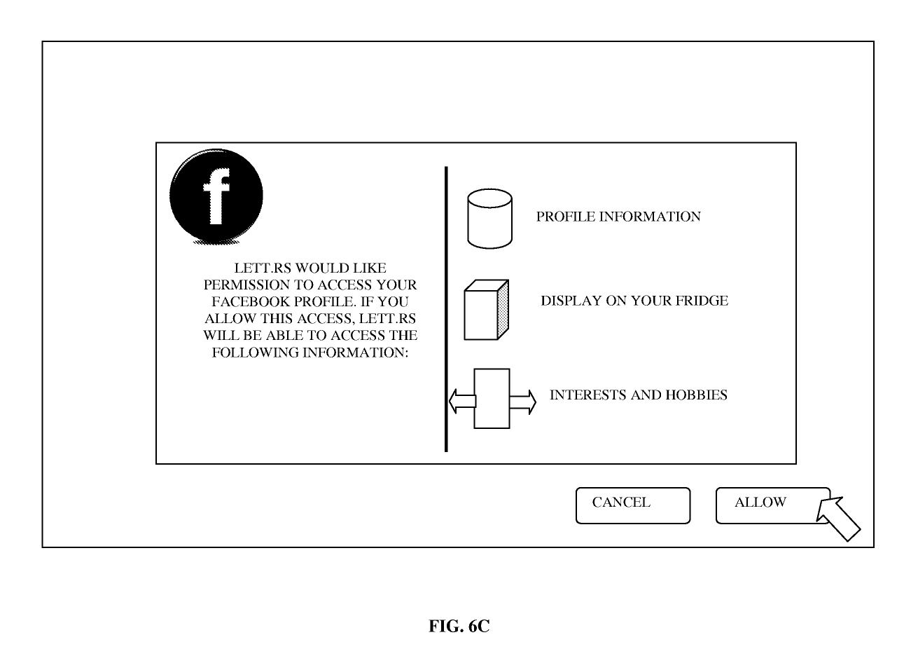

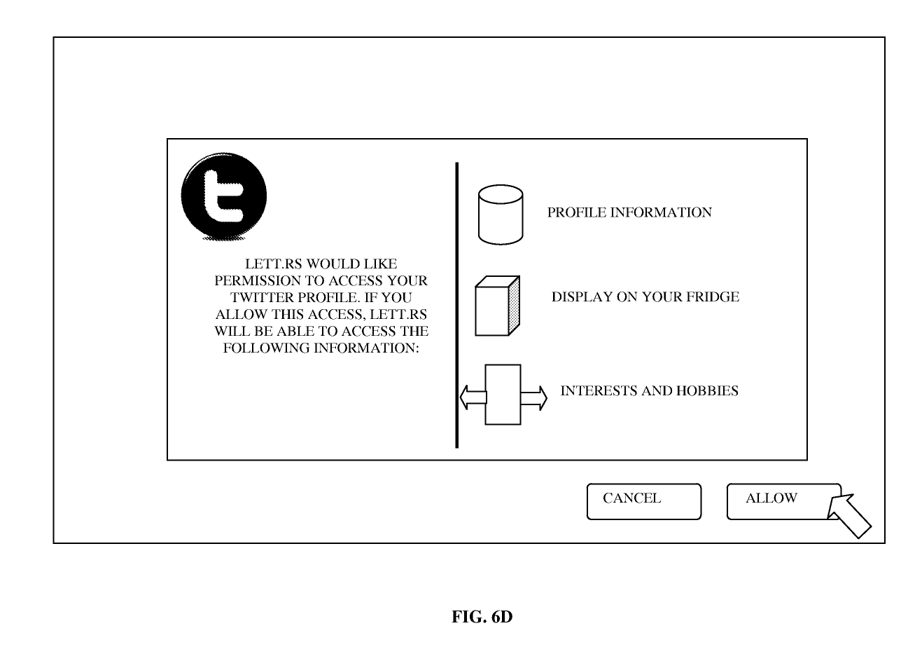

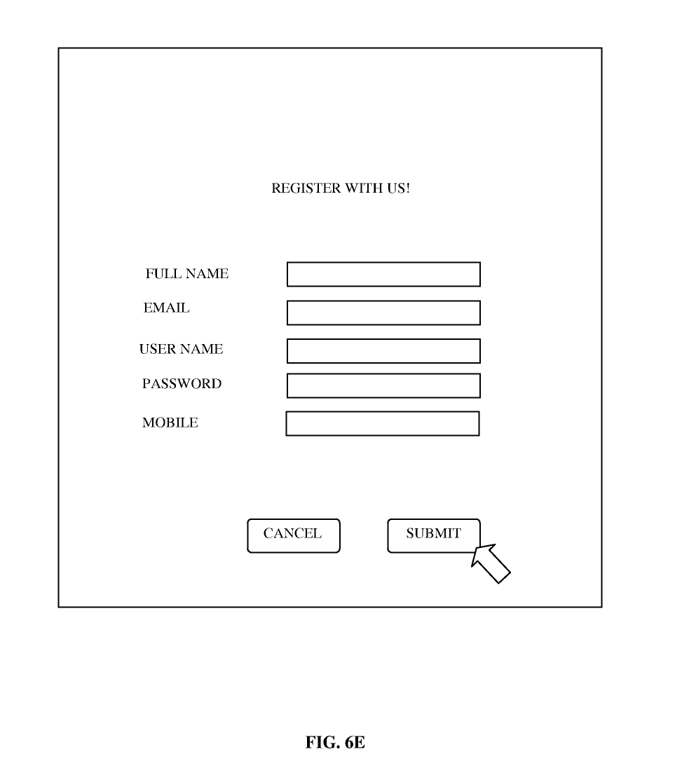

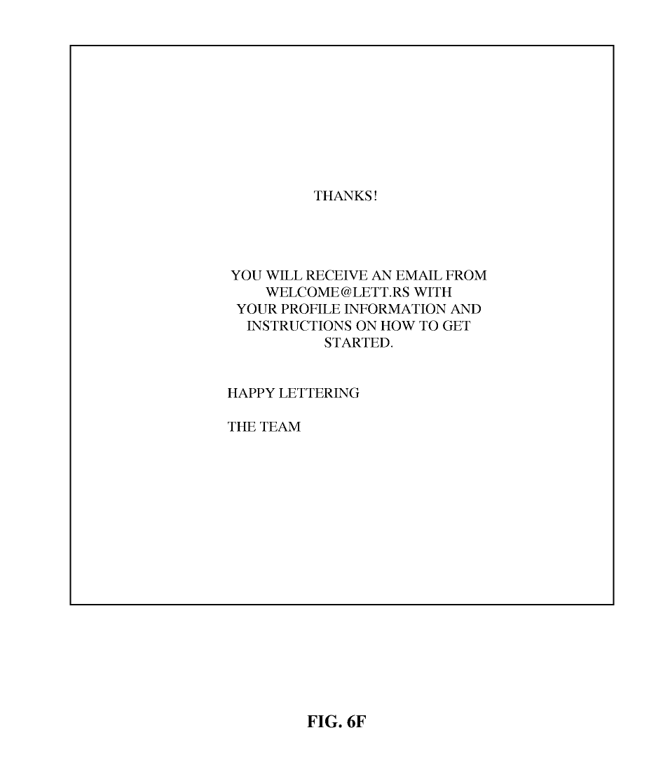

The cloud architecture of the letter management database allows the distribution of a digital letter anywhere in the world, for example, with an internet browser or via the letter communication application. After registration with the letter communication application, the users can log into the letter communication application using a login identifier. The letter communication application acquires the login identifier via a graphical user interface (GUI) provided by the letter communication application on the user device as disclosed in the detailed description of FIGS. 6A-6D. The login identifier is, for example, a unique login name, an electronic mail (email) address, a social network identification address, a password, etc. The letter communication application requires a user to enter one specific login identifier to access the letter management database and the letter communication application via the GUI on the user device.

The letter communication application displays 103 multiple themes and writing style options on the sender device via the GUI. The writing style options comprise, for example, a handwritten style, a typed style, etc. The letter communication application acquires 104 a selection of one or more of the displayed themes and one or more of the displayed writing style options from the sender device via the GUI for generating a personalized letter. In an embodiment, the letter communication application allows a user to generate a personalized letter using his/her handwriting. The user can write a personalized letter in his/her own handwriting by uploading a writing sample of the user's handwriting to the letter communication application via the GUI. The letter communication application incorporates the user's handwriting style into the personalized letter. The letter communication application also acquires 105 media content and tags for generating the personalized letter from the sender device via the GUI. The media content comprises, for example, one or more of textual content, image content, audio content, video content, multimedia content, digital content, voicemail content, electronic mail content, messaging content, document content, social media content, etc., and any combination thereof. The social media content comprises “likes” used by users to express that they like, enjoy, or support certain content, messages or “tweets” sent using Twitter® of Twitter, Inc., etc., that can be used to generate the personalized letter. The social media content inspires generation of new letters. The messaging content comprises, for example, content from chat messages, textual messages, etc. Tags are labels that can be applied to any part of the personalized letter, for example, to text, to images, etc. Tags also comprise location information. In an embodiment, the tags used for the generation of the personalized letter comprise labels generated from a part, for example, text, image, location, etc., of the personalized letter.

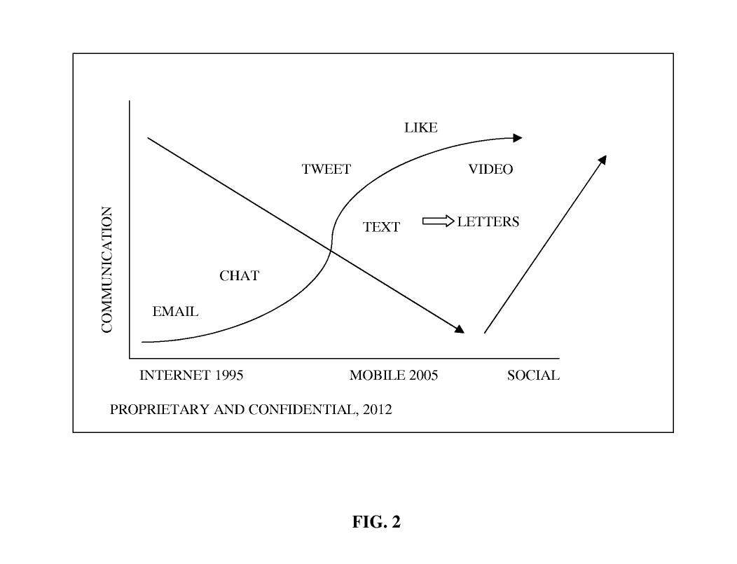

The letter communication application allows a user to create the personalized letter from any digital content. The letter communication application incorporates the media content and tags into the personalized letter via an application programming interface (API) of the letter communication application. The letter communication application analyzes the acquired media content and converts selective portions of the acquired media content, for example, as connected and imbedded assets into a consequent letter as disclosed in the detailed description of FIG. 2. As such, almost every letter is different, resulting in generation of letter objects or personalized letters through original user generated words, enhanced by dynamic themes, tagged, located, and then imbedded with the dynamic media content, with all the letters being manageable within the network and letter creation, delivery, and organization system disclosed herein.

The letter communication application generates 106 the personalized letter, also referred to as a “letter object”, based on the acquired selection of one or more of the displayed themes, one or more of the displayed writing style options, and the acquired media content and tags. In an embodiment, the letter communication application displays multiple customizable display elements on the sender device via the GUI. The customizable display elements comprise, for example, icons, images, clip art, symbols, alphanumeric characters, etc. The letter communication application acquires a selection of one or more customizable display elements from the sender device via the GUI. In addition to the acquired selection of one or more of the displayed themes and one or more of the displayed writing style options, and the acquired media content and tags, the letter communication application is configured to generate the personalized letter based on the acquired selection of one or more of the customizable display elements.

In an embodiment, the letter communication application archives the generated personalized letter in a digital format or a non-digital format, from the electronic dashboard displayed on the GUI of the sender device and each of the recipient devices. The generated personalized letter can be archived both by the sender via the archiving interface section, exemplarily labeled as a “desk drawer”, and the recipient via the storage interface section, exemplarily labeled as a “shoebox”, and if both agree, the generated personalized letter can be shared in different ways with the world on a user's individual electronic dashboard exemplarily labeled as a “fridge”. In another embodiment, the letter communication application acquires approval from the sender device and each of the recipient devices via the GUI for sharing the generated personalized letter publicly on the electronic dashboard provided on the GUI by the letter communication application. The letter communication application provides a dual-share approval process for a digitally delivered postal letter. Archiving feeds the letter management database that is searchable. The letter communication application also stores new personalized letters generated by the letter communication application into the letter management database. The letter communication application organizes the generated personalized letters and the existing or old letters based on various criteria, for example, letters sent, letters received, letters shared, letters read, letters tagged, letters commented upon, legacy of letters, etc., and arranges the letters, for example, by year, by user, by topic, etc.

The letter communication application allows a user to search for the generated personalized letter and other letters in the letter management database via one or more of multiple search options. The search options comprise, for example, a category based search, a topic based search, a tag based search, a keyword based search, a timestamp based search, a user based search, a date based search, a popularity based search, etc. The category based search is a search performed by the letter communication application in the letter management database based on a general class of ideas, terms, or objects that mark divisions or coordinates within the letters. The categories comprise, for example, courage, love, loss, achievement, support, hope, etc. The topic based search is a search performed by the letter communication application in the letter management database based on a subject of discussion or conversation of the letters. The tag based search is a search performed by the letter communication application in the letter management database based on the different tags or labels applied to the letters. The keyword based search is a search performed by the letter communication application in the letter management database based on a keyword or a descriptive word used as a reference point. A time stamp based search is a search performed by the letter communication application in the letter management database based on the time at which an event is recorded by a computing device. A user based search is a search performed by the letter communication application in the letter management database based on a user identifier, for example, a username, a user's name, a user's social network identifier, etc. The date based search is a search performed by the letter communication application in the letter management database based on the day, month, or year a letter was sent or received. The popularity based search is a search performed by the letter communication application in the letter management database based on a quality of a letter, for example, a well-liked letter, a common letter or a letter having a high social status, etc.

The letter communication application displays 107 multiple delivery options on the sender device via the GUI for delivering the generated personalized letter. The delivery options comprise, for example, delivering the generated personalized letter on demand to each of one or more recipients via postal mail, printing the generated personalized letter for delivering the printed personalized letter, posting the generated personalized letter on an electronic dashboard provided on the GUI by the letter communication application of each of the recipients, and delivering a digital notification of the generated personalized letter to each of the recipient devices via one or more of multiple communication modes. The communication modes comprise, for example, a short message service (SMS), a multimedia messaging service (MMS), an electronic mail, a telephonic mode of communication, etc., or any combination thereof. To deliver the digital notification of the generated personalized letter to each of the recipient devices, the letter communication application delivers the digital notification, for example, to an electronic mail address of each recipient, or posts the digital notification on the electronic dashboard provided on the GUI by the letter communication application of each recipient, or delivers the digital notification to a social network identification address of each recipient, or delivers the digital notification to each of one or more of multiple electronic platforms and electronic channels via the electronic dashboard. In an embodiment, the letter communication application sends a notification link with each of the digital notifications, to allow recipients to access a digital copy of the generated personalized letter. The letter communication application uses the electronic mail address, the social network identification address, etc., of each of the recipients to send the digital notifications, through which the recipients can retrieve the generated personalized letter stored in the letter management database.

The letter communication application delivers the generated personalized letter to each of one or more recipients via postal mail by acquiring transactional information from the sender device via the GUI. The transaction information comprises, for example, stationery options for printing the generated personalized letter, payment options for delivering the generated personalized letter via postal mail, etc. The delivery options further comprise delivering the generated personalized letter at a present date or a future date to the recipients via postal mail or digital mail. In an embodiment, the letter communication application delivers the generated personalized letter to each of the recipients based on changes in a social graph of a sender and/or each of the recipients. For example, a user can write a letter for a future event, for example, the wedding of his son, and store the letter in the letter management database. The user can set delivery of the letter through the letter communication application when the status on the social graph, for example, the relationship status of his son changes to “married”. In an example, the letter communication application monitors the Facebook® status of the user's son and detects the change in the son's relationship status. On detecting the change in the son's relationship status, the letter communication application then sends the stored letter to the son via digital mail or via postal mail, as per the user's predefined instructions or settings, even if the event of status change happens long after the user is gone.

The letter communication application acquires 108 a selection of one or more of the displayed delivery options and at least one recipient identifier of each of the recipients from the sender device via the GUI. The recipient identifier is, for example, the assigned unique identification code, an electronic mail address, a postal address, and a social network identification address or identifier of each recipient. Needing only one specific recipient identifier of a recipient, for example, an electronic mail (email) address or a twitter handle, a sender can request to send a paper letter through the letter communication application and complete the fulfillment of the letter to anywhere in the world, for example, from an internet browser or a mobile application. Needing only that same one recipient identifier, a sender can deliver a letter into the digital cloud through the letter communication application for retrieval by one recipient. The letter communication application delivers 109 the generated personalized letter in one or more of different formats to one or more recipients and/or one or more recipient devices of the recipients, using the acquired selection of one or more of the displayed delivery options and at least one recipient identifier. In an embodiment, the letter communication application sends a link of the digital generated personalized letter to the recipient in addition to providing the recipient with an option to save, print, or send a postal mail.

The letter communication application facilitates 110 access to the generated personalized letter through one or more of multiple access modes via the letter management database. In an embodiment, one of the access modes is a digital access identifier inserted on the generated personalized letter. The digital access identifier is, for example, a uniform resource locator (URL), a quick response (QR) code, a digital watermark, etc., used to access the letter management database. The digital access identifier is configured to allow each recipient device to add the generated personalized letter to the electronic dashboard provided on the GUI by the letter communication application or retrieve the generated personalized letter from the letter management database. The digital access identifier is also configured to preserve and share the generated personalized letter. In another embodiment, another one of the access modes is an electronic dashboard provided on the GUI for sharing the generated personalized letter and other letters. The letter communication application allows users to create a unique written communication and send the communication digitally or via hand mailed paper letter to one or more users, for a different impression. The recipient of the generated personalized letter can enter the QR code for that specific generated personalized letter on the GUI and add a digital version for displaying on the recipient's electronic dashboard, with the sender's consent, or store the generated personalized letter into the letter management database for organizing, saving, and cherishing.

In another embodiment, one of the access modes is at least one recipient identifier used by each of one or more recipients for retrieval of the generated personalized letter from the letter management database. In another embodiment, another access mode comprises the digital notifications of the generated personalized letter delivered to the recipient devices, for example, via the electronic mail address of each of the recipients, the electronic dashboard, the social network identification address of each of the recipients, one or more multiple electronic platforms and channels, etc. The letter communication application sends the digital notifications to the recipients with notification links to access digital copies of the generated personalized letter.

The letter communication application also sends and receives digital notifications on multiple transaction events via one or more of multiple communication modes. The transaction events comprise, for example, a delivery of the generated personalized letter, arrival of the generated personalized letter, receipt of a comment on a specific shared letter object displayed on a user's electronic dashboard, receipt of comments about a unique media object, for example, the generated personalized letter, triggering of an application programming interface (API) driven event, sharing the generated personalized letter or the other letters on the electronic dashboard, etc. An API driven event is an event triggered by an API, for example, an event on a user's Facebook® application such as a change in the status on a user's Facebook® profile. The notification links generated by the letter communication application allow the recipients to retrieve and read the generated personalized letter within the letter communication application. As such, the closed loop network of letter creation and letter reading maintains the integrity of the letter communication application for personal creation, delivery, and organization. When a recipient desires to share the retrieved personalized letter and displays the retrieved personalized letter on an electronic dashboard provided on the GUI, the letter communication application generates a digital notification, delivered, for example, via electronic mail, with a unique link, back to the sender of the personalized letter, to grant sharing rights for such letter media within the letter communication application and on the electronic dashboard. Furthermore, comments on a specific shared letter object displayed on a recipient's electronic dashboard also generate notifications of comments about the letter object.

The computer implemented method and system disclosed herein integrate multiple social networking applications within the letter communication application via the network. The integration is configured to facilitate the generation, delivery, and communication of the personalized letter via the network. Examples of social networking applications comprise, for example, blogs such as Slogger, LiveJournal, Open Diary, TypePad® of Six Apart Ltd., WordPress® of WordPress Foundation, ExpressionEngine® of PMachine, Inc., Xanga® of Xanga.com, Inc.; micro-blogging and presence applications comprising, for example, Twitter® of Twitter, Inc., Plurk, Tumblr.® of Tumblr, Inc., Jaiku® of Google, Inc., Fmylife®; social networking such as Bebo® of Bebo, Inc., Facebook® of Facebook, Inc., Linkedin® of Linkedin Corporation, MySpace® of MySpace Inc., Orkut® of Google, Inc., Skyrock®, Hi5® of Hi5 Networks, Inc., Ning® of Ning, Inc., Elgg and social network aggregation applications such as NutshellMail, FriendFeed® of Facebook, Inc., etc. The letter communication application combines social media technologies and cloud computing with old-fashioned letter writing and revives an old art form by making letters accessible across a range of mobile and social platforms. The integration of social networking applications within the letter communication application allows tracking and detection of changes to a user's social graph, thereby allowing future deliveries of personalized letters based on changes in the user's social graph. The letter communication application provides a social letter and digital courier system as a meaningful digital communication between a sender and a recipient, which can be posted publicly or preserved privately for free. The basis of the computer implemented method and the computer implemented system disclosed herein allow for the creation of an entire personal postal system in the cloud.

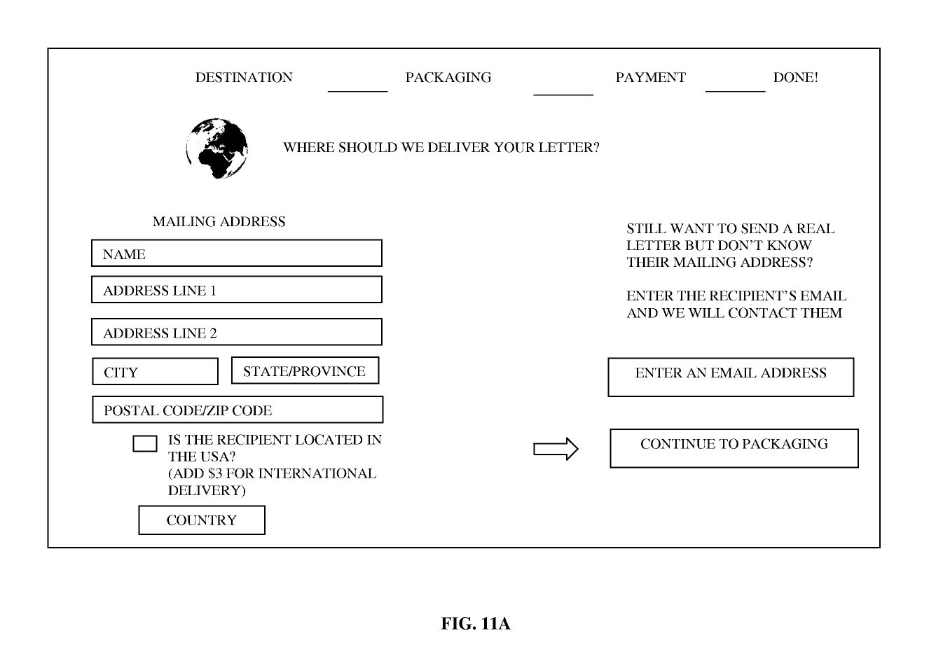

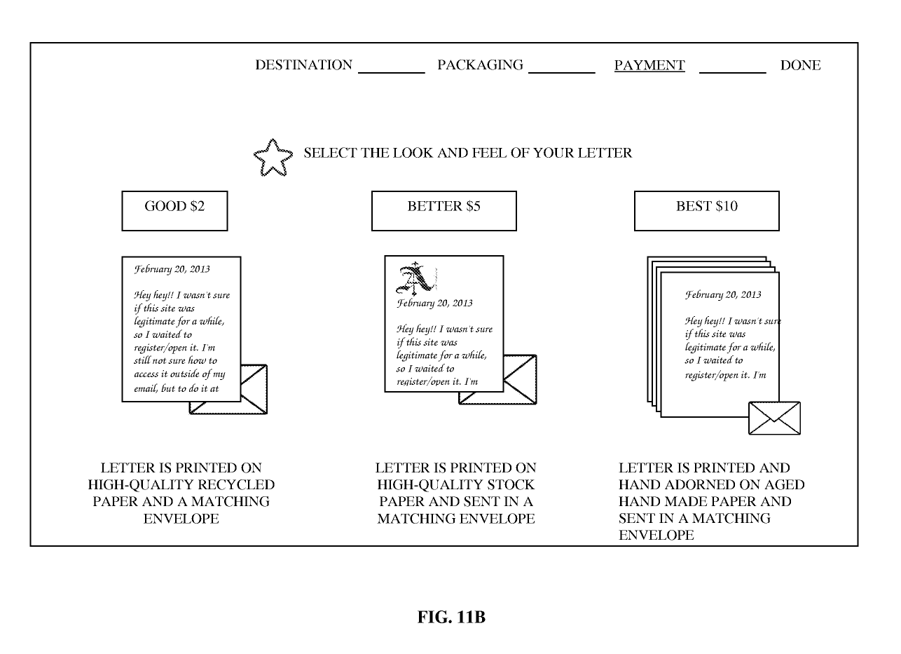

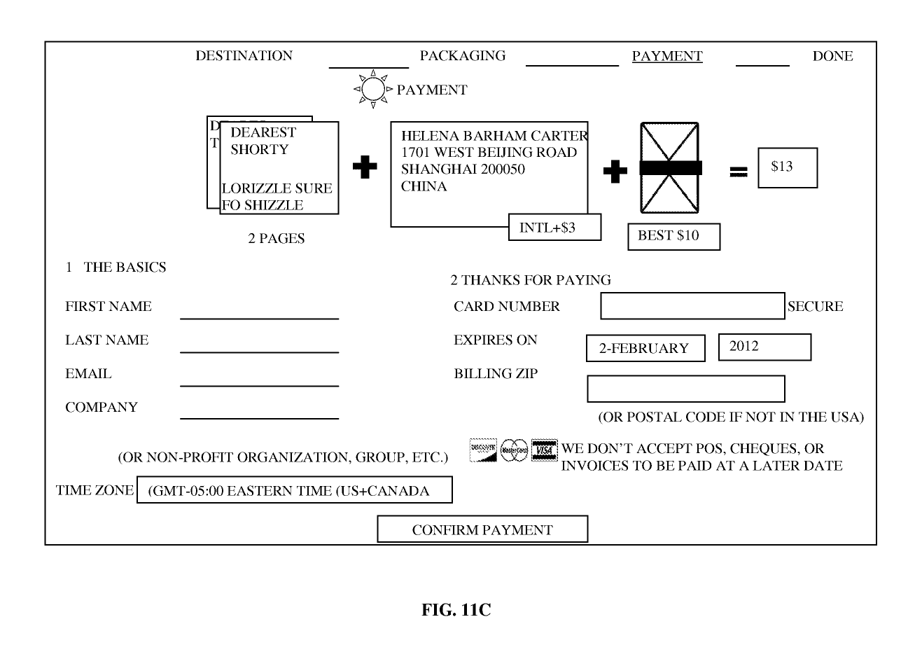

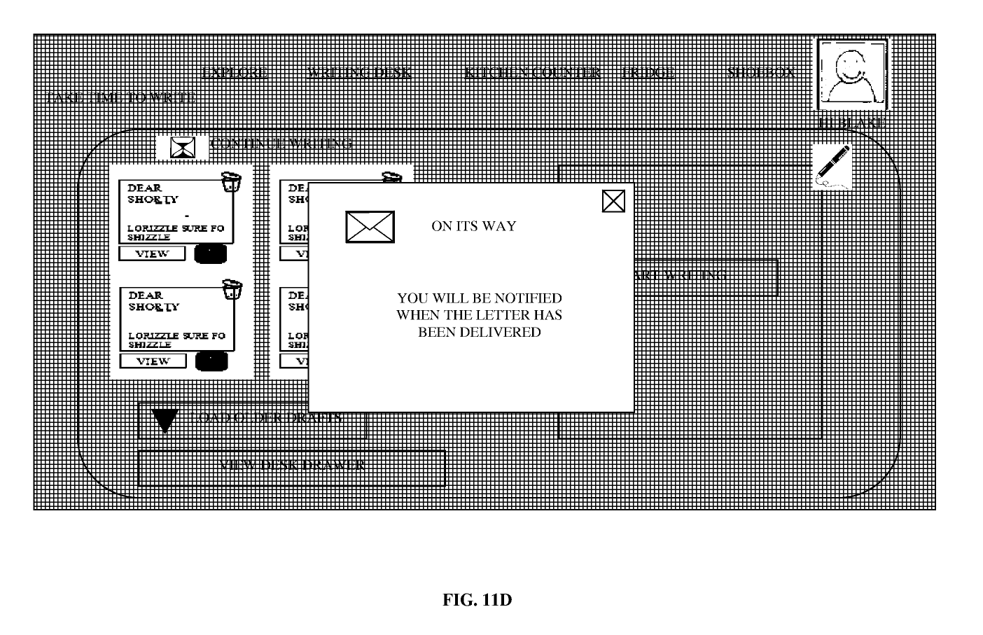

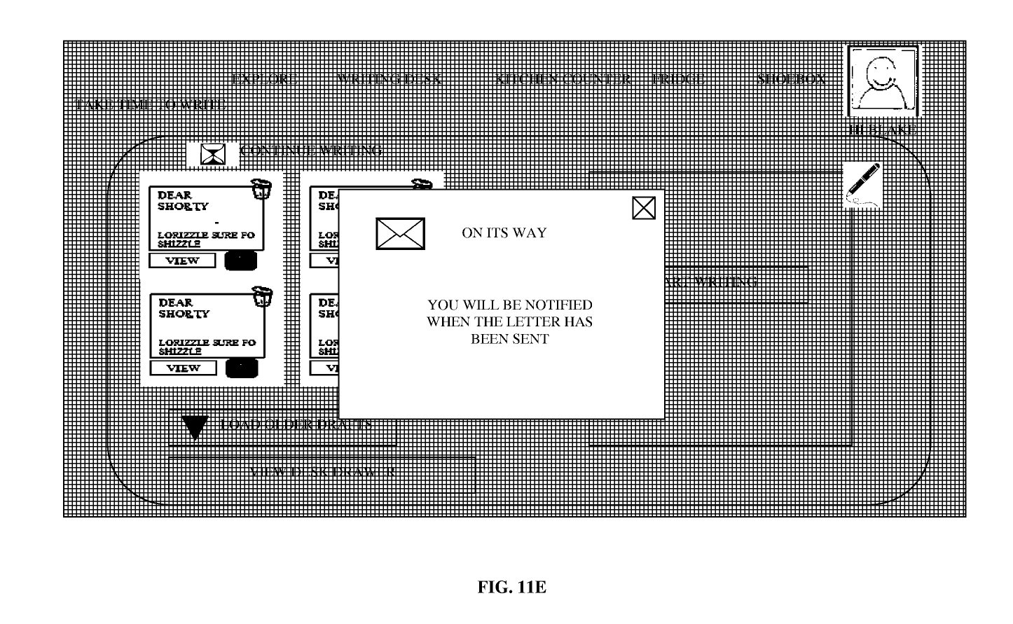

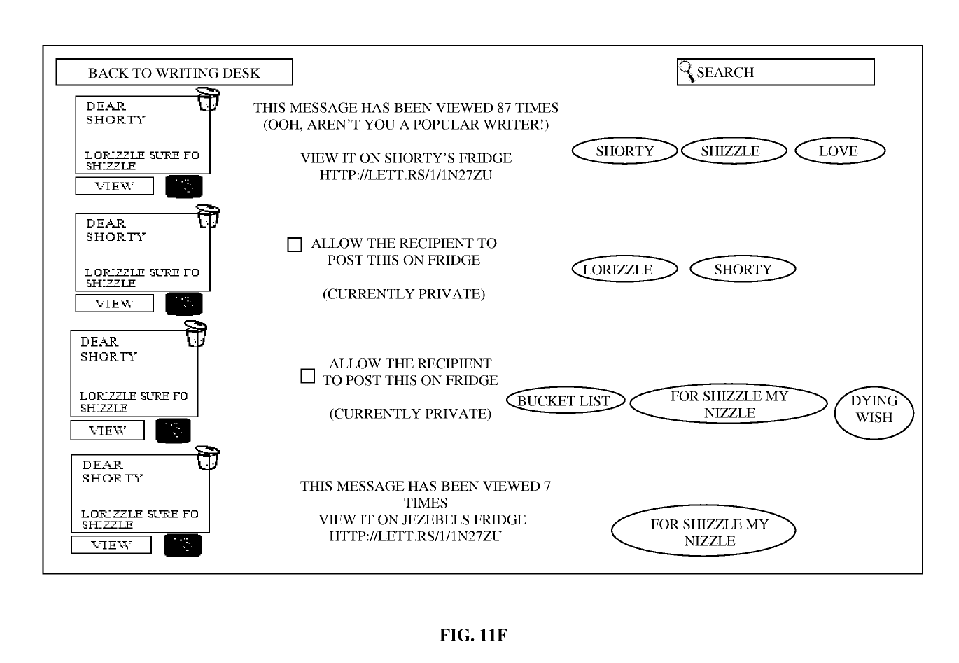

FIG. 2 exemplarily illustrates a graphical representation showing analysis and conversion of selective portions of media content into a consequent letter. The letter communication application leverages application programming interfaces (APIs) for allowing the conversion of the media content to be transformed into letters. The letter communication application analyzes the media content comprising, for example, electronic mail (email), chat, tweets, likes, text, information graphics, video, etc., and converts selective portions of the media content into a consequent letter. For example, the letter communication application converts existing communication objects such as an email into a digital letter or a paper letter. In an embodiment, the letter communication application attaches selective portions of the media content to the personalized letter via the APIs. The letter communication application delivers the consequent letter as a digital letter or a paper letter to one or more recipients. The selective portions of the media content or digital objects are convertible to generate a letter or to be attached to a letter via the APIs. Consider an example where a user wants to capture digital moments of his/her life that deserve to be remembered and merit a more thoughtful communication. The user can use special pictures, photos from his/her mobile device, for example, the iPhone® of Apple, Inc., tweets from Twitter® of Twitter, Inc., email, and texts as ingredients to a great story. The letter communication application allows the user to save the digital media content in the letter management database for later use, and incorporate the digital media content into a personalized letter. The letter communication application allows the user to send the letter to his/her friends, his/her family, and his/her social network, digitally, or via postal mail as disclosed in the detailed description of FIG. 1 and FIGS. 11A-11F.

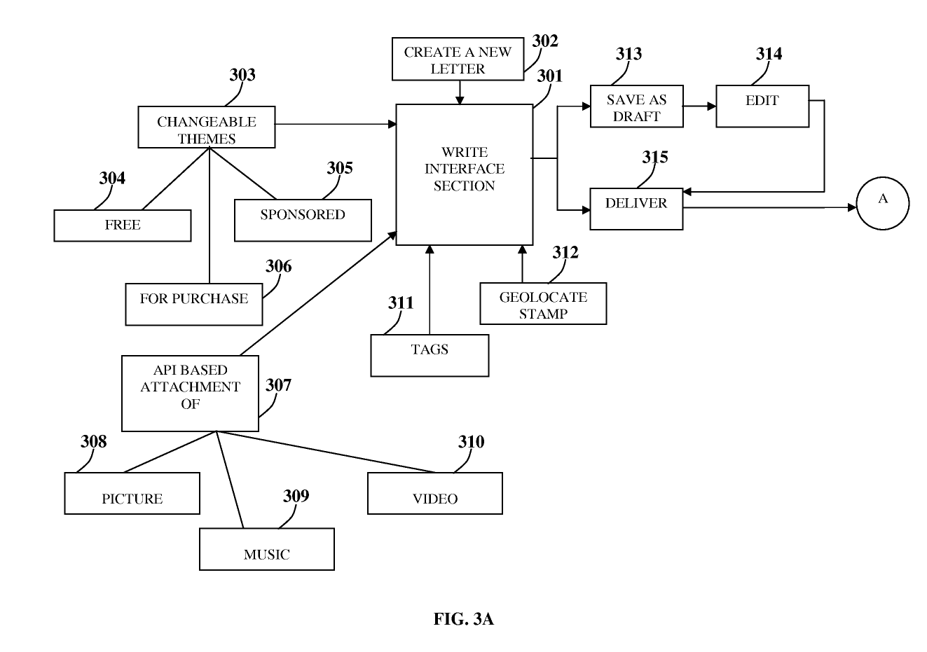

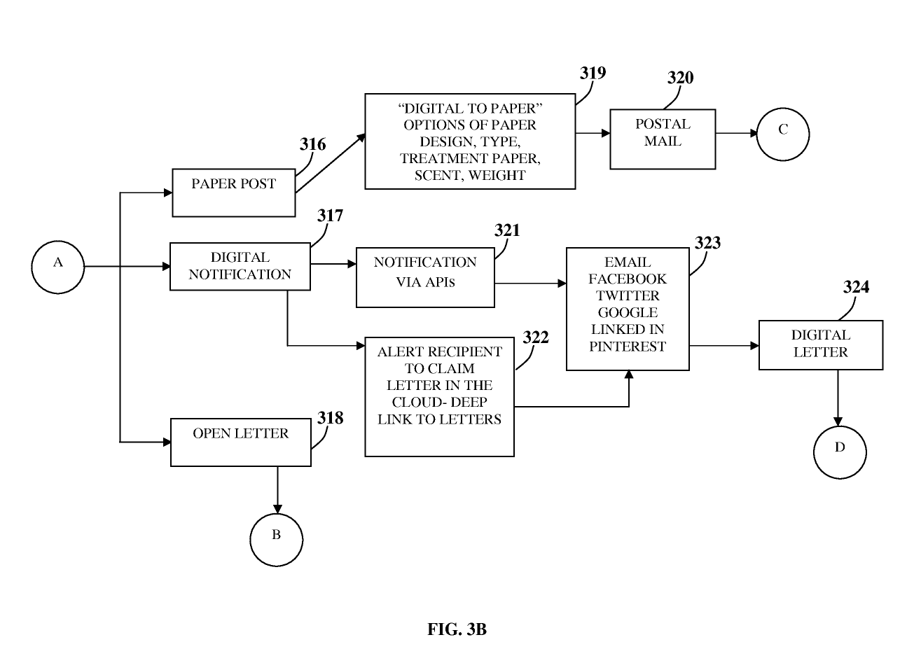

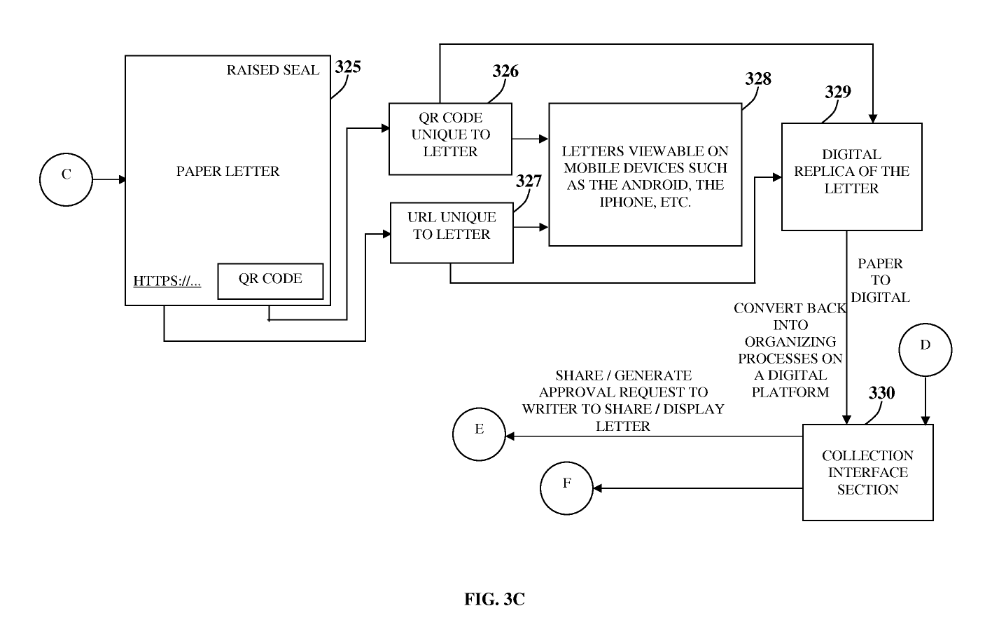

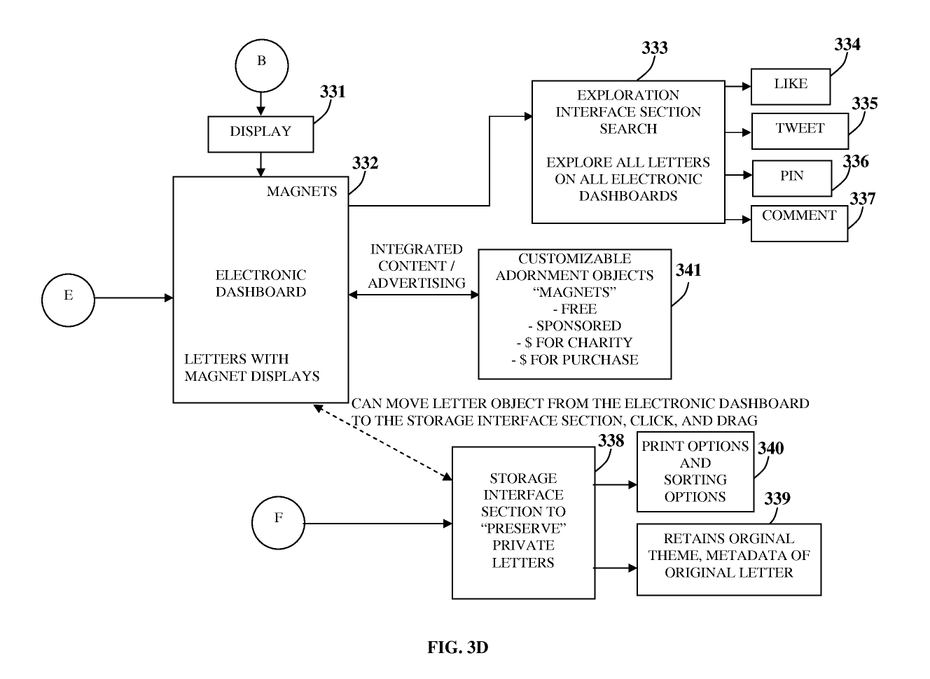

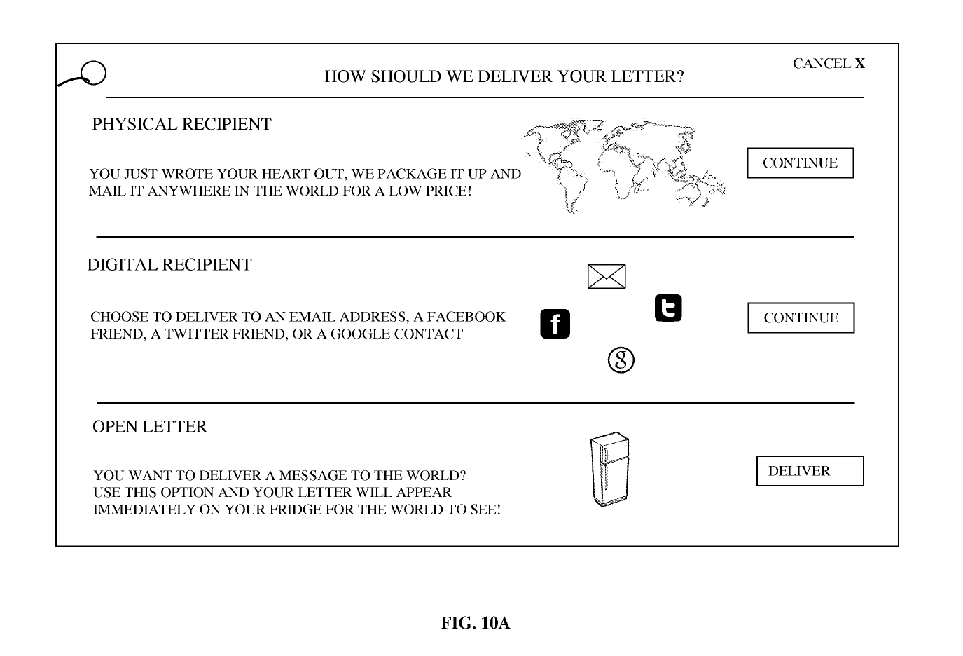

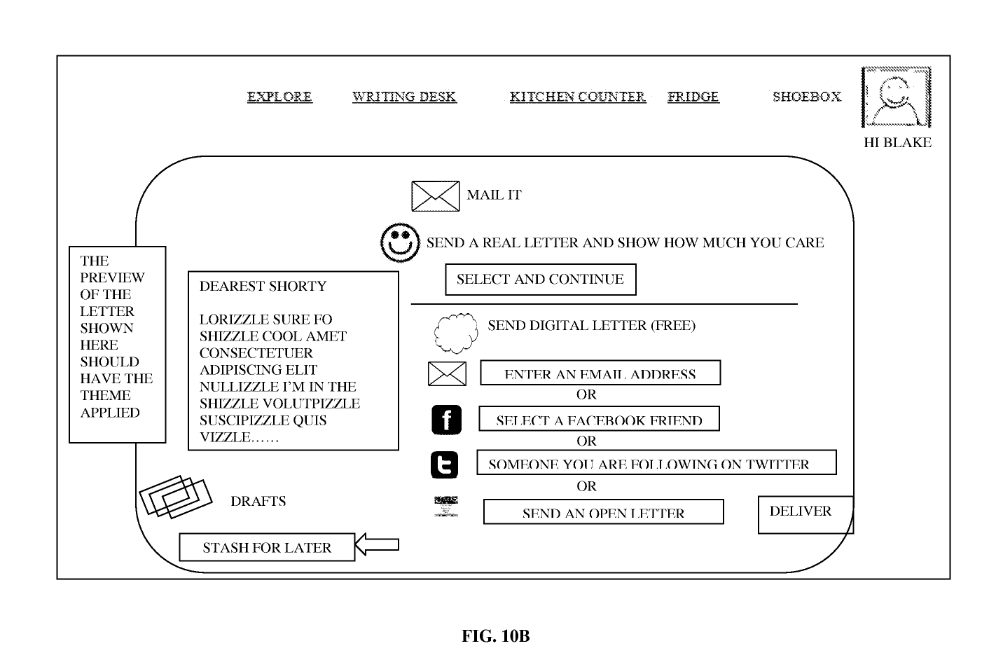

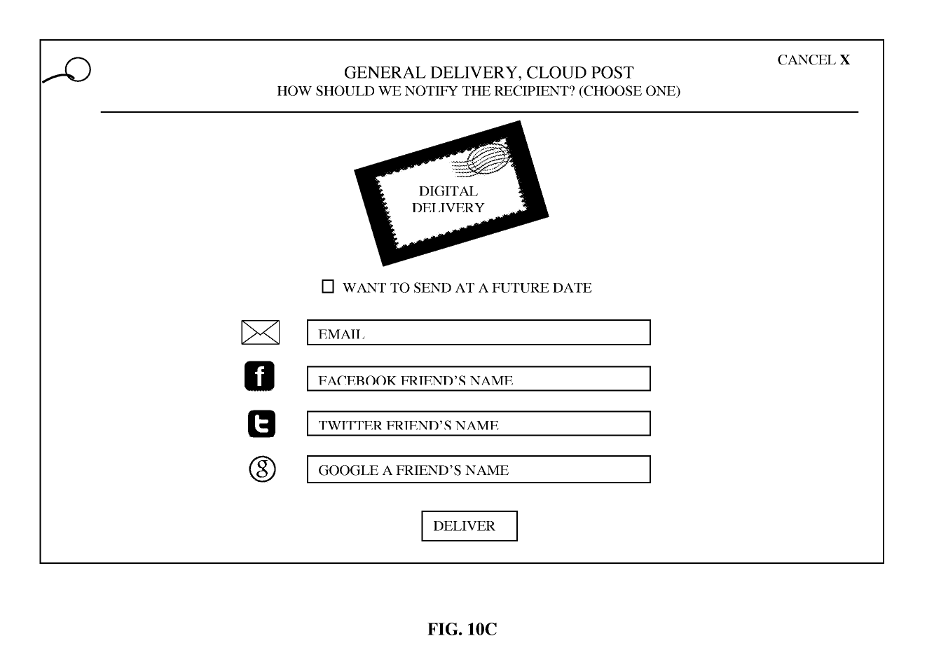

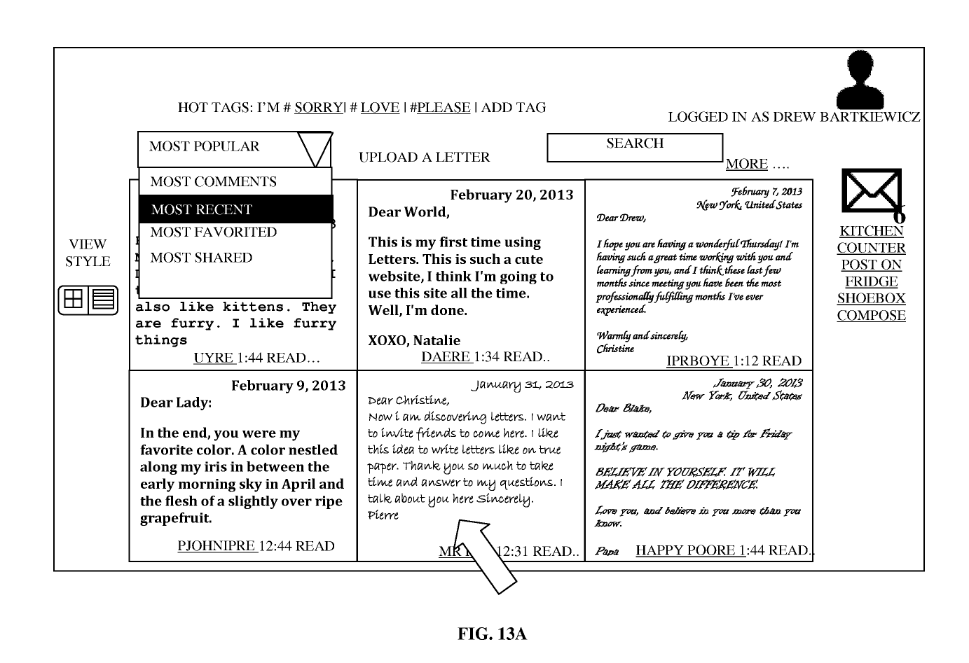

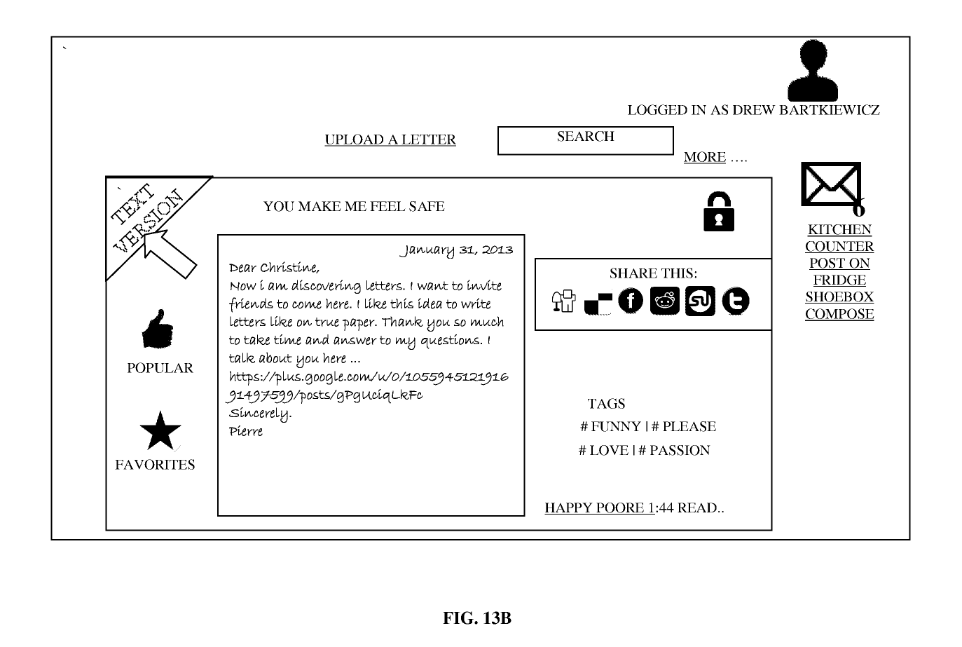

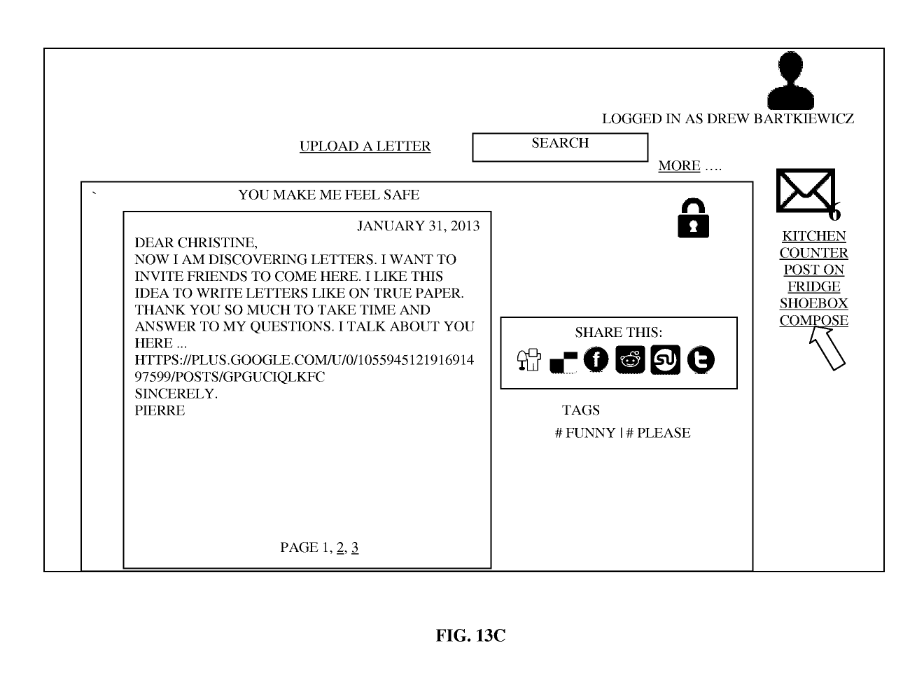

FIGS. 3A-3D exemplarily illustrate a process flow diagram comprising the steps for creating, sharing, preserving, organizing, and delivering a personalized letter. The letter communication application allows a user to create a personalized letter using multiple themes and one or more writing style options as disclosed in the detailed description of FIG. 1 and FIGS. 13A-13C. The letter communication application provides a write interface section 301 on the graphical user interface (GUI) of the user device for creating 302 a new letter. The write interface section 301 provides changeable themes 303 for personalizing the letter and making the letter more attractive. The changeable themes 303 are either free 304, sponsored 305, or can be purchased 306. The write interface section 301 integrates media content, for example, pictures 308, music 309, video 310, etc., using an application programming interface (API). That is, the write interface section 301 allows an API based attachment 307 of media content to the personalized letter. The write interface section 301 also allows a user to add tags 311 and geolocate stamps 312 to the personalized letter. Once the personalized letter has been created, the letter communication application saves 313 the personalized letter as a draft for future editing 314 or delivers 315 the personalized letter using multiple delivery options as disclosed in the detailed description of FIG. 1 and FIGS. 10A-10C.

The delivery options comprise, for example, an option to deliver via paper post 316, delivery via a digital notification 317, and delivery as an open letter 318. As used herein, the term “open letter” refers to a letter that is publicly posted on the electronic dashboard 332 provided on the GUI by the letter communication application 401 and is intended to be publicly read by a wide audience, or intended for an individual, but that is nonetheless widely distributed using the electronic dashboard 332. If the user chooses the option to deliver via paper post 316, the letter communication application provides 319 multiple digital to paper options, for example, options for selecting a paper design, a paper type, a paper treatment, scent, weight, etc. The letter communication application then prints the paper letter for delivery via postal mail 320. The printed paper letter 325 has a raised seal. The letter communication application embeds digital access identifiers, for example, a quick response (QR) code 326 and a digital link or a uniform resource locator (URL) 327 in the paper letter 325. The QR code 326 and the URL 327 are unique to a paper letter 325. The URL 327 embedded on the paper letter 325 is a digital link to a digital replica 329 of the paper letter 325 and provides a paper to digital loop. The letter communication application thus facilitates digital access to the paper letter 325 via the QR code 326 and the URL 327. The QR code 326 and the URL 327 allow the digital replica 329 of the paper letter 325 to be viewable 328 on mobile devices, for example, mobile devices using Android of Google, Inc., the iPhone® of Apple, Inc., etc., via a collection interface section 330. The collection interface section 330 obtains the digital replica 329 of the paper letter 325 using the QR code 326 and the URL 327 and enables viewing and organization of the paper letter 325. Furthermore, the retrieval of the paper letter back into the digital letter is performed, for example, by the unique URL to that paper letter or the unique QR code to that paper letter, for digital preservation and sharing.

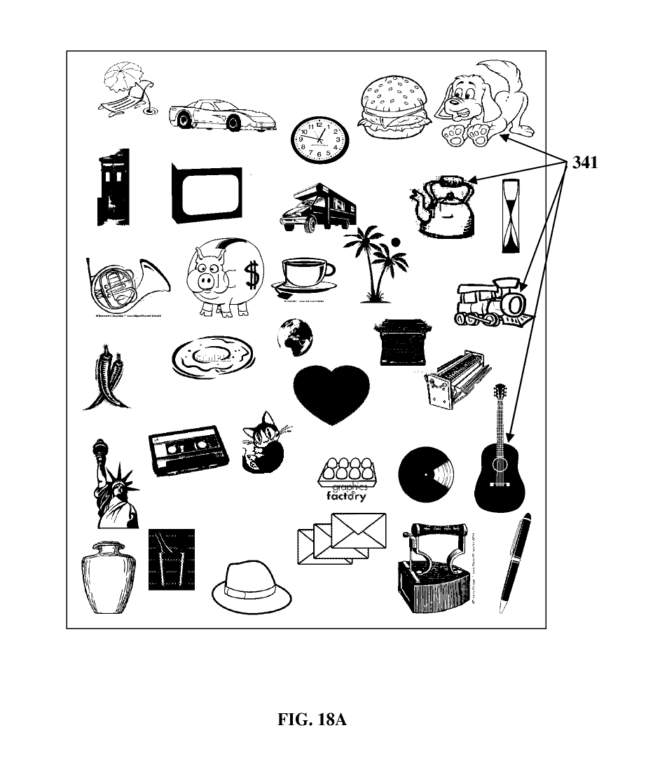

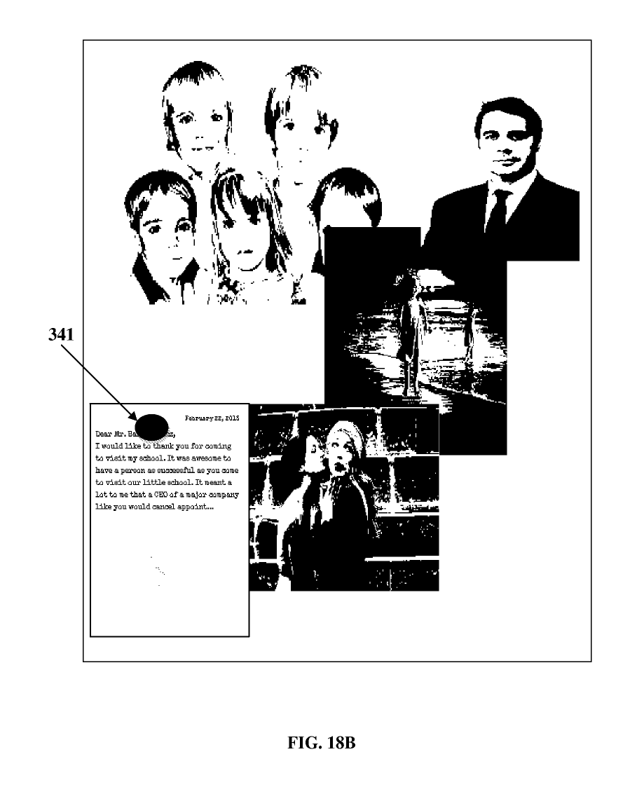

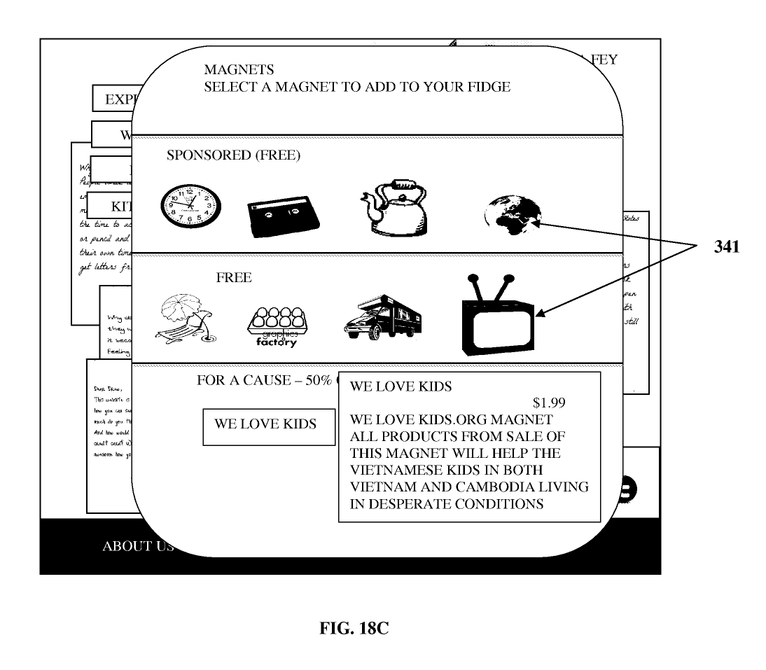

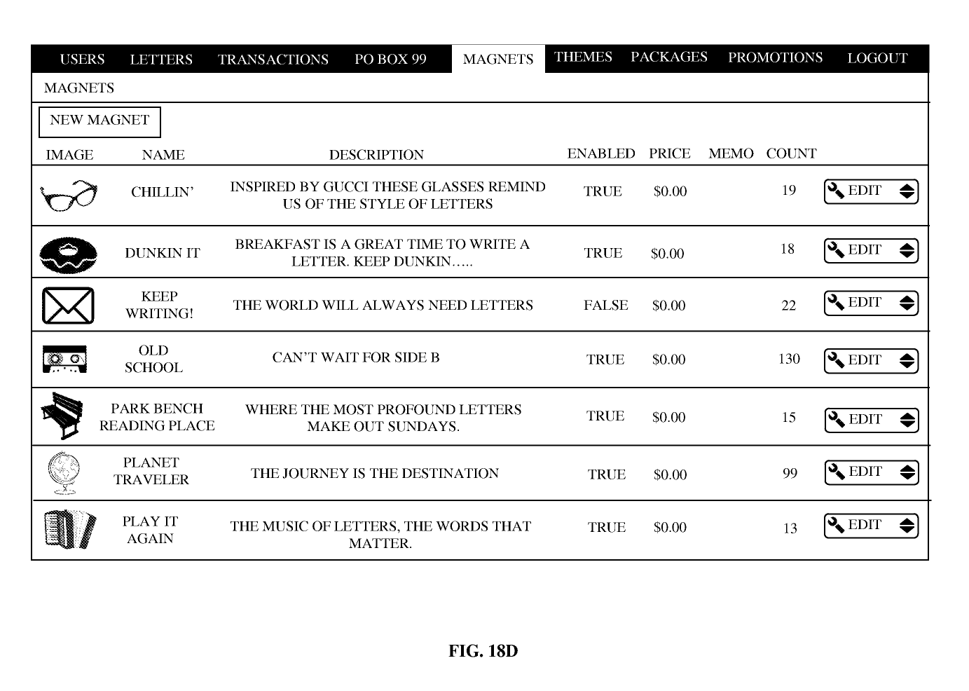

The letter communication application generates and transmits an approval request to the sender device to share or display the digital replica 329 of the paper letter 325 on the electronic dashboard 332. The letter communication application also preserves the digital replica 329 of the paper letter 325 in a storage interface section 338. The storage interface section 338 provides print options and sorting options 340 and also retains 339 the original theme and metadata of the original letter. The letter communication application displays 331 an open letter 318 on the electronic dashboard 332. The electronic dashboard 332 provides integrated content advertising via customizable adornment objects 341, for example, magnets as disclosed in the detailed description of FIGS. 18A-18D. The customizable adornment objects 341 are free, sponsored or are purchasable. The user may also move letters from the electronic dashboard 332 to the storage interface section 338, for example, by a click action, a drag action, etc.

If a user chooses the digital notification 317 option, the letter communication application sends a notification 321 of the personalized letter via application programming interfaces (APIs) or alerts 322 the recipient to claim the personalized letter from the cloud based letter management database. The letter communication application transmits the digital notifications, for example, via email, Facebook® of Facebook, Inc., Twitter® of Twitter, Inc., Google® of Google, Inc., LinkedIn® of LinkedIn, Ltd., Pinterest® of Pinterest, Inc., etc., 323. The digital notifications provide links to access and retrieve the digital letter 324. The electronic dashboard 332 allows a user to search for and explore other letters from other electronic dashboards via an exploration interface section 333. The user can like 334, tweet 335, pin 336, or comment 337 on all the letters on the electronic dashboard 332.

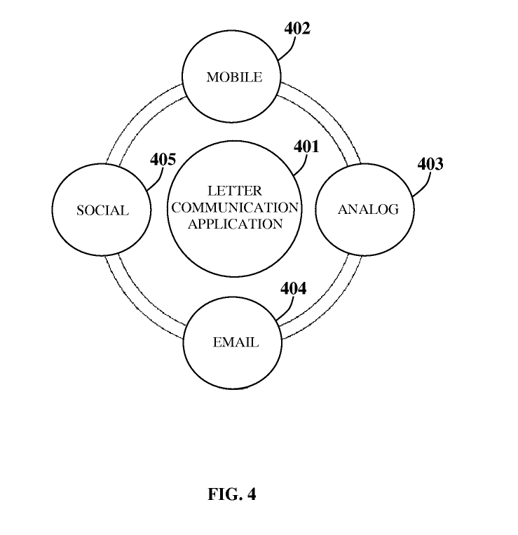

FIG. 4 exemplarily illustrates a structural design of the letter communication application 401. The letter communication application 401 configured as a mobile application 402, via a user device, for example, a mobile device captures and imbeds, for example, a picture, tweet, voicemail, etc., into a personalized letter. The letter communication application 401 provides an analog 403 mail service option and sends letters on demand via postal mail. The letter communication application 401 also sends personalized letters on demand via proprietary digital mail or as a mail-as-a-service platform. The letter communication application 401 also provides an option for creating a digital to paper loop and a paper to digital loop. The letter communication application 401 converts communications of significance, for example, an email 404 to letters of consequence via an application programming interface (API) provided by the letter communication application 401. The letter communication application 401 integrates social networking applications 405 for posting, sharing, and socializing the personalized letter or other letters via a write interface section 301 exemplarily illustrated in FIG. 3A and a digital courier defined by the letter communication application 401, to distribute the personalized letter and/or other letters across multiple electronic platforms and electronic channels.

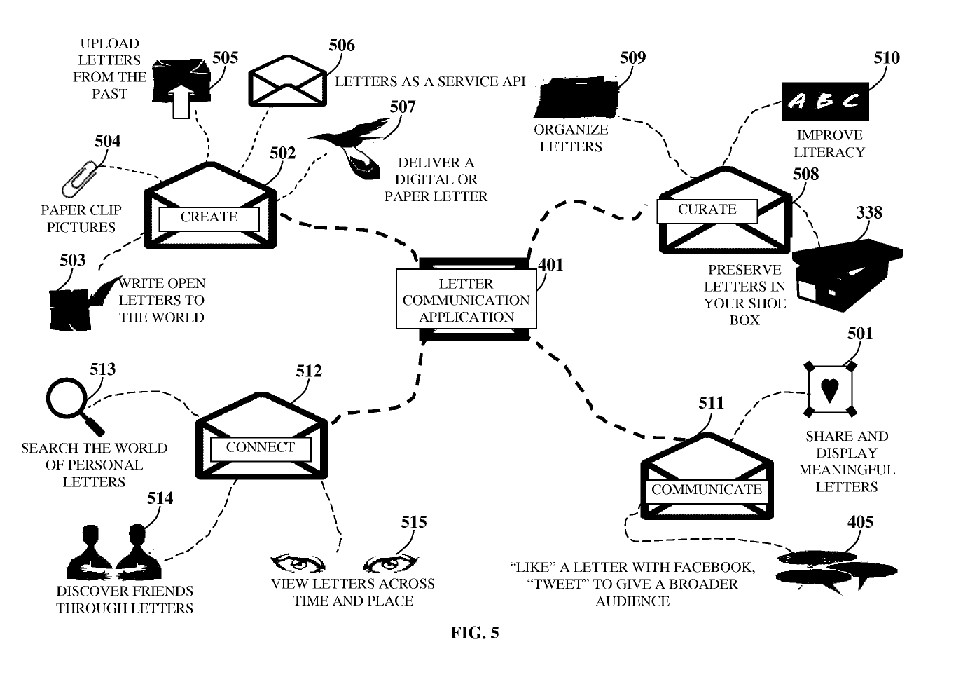

FIG. 5 exemplarily illustrates functions performed by the letter communication application 401 via different interface sections provided on a graphical user interface (GUI). The letter communication application 401 organizes and creates digital and paper letters. The letter communication application 401 creates 502, curates 508, connects 512, and communicates 511 multiple letters in different formats. The letter communication application 401 makes a letter stand out in this digital age. The letter communication application 401 allows a user to enter a letter network, for example, around themes, location, life stage, pursuits, etc. The letter communication application 401 also provides letter writing tools to users and creates 502 or generates more creative and expressive letters. The letter communication application 401 creates 502 personalized letters, for example, using paper clip pictures 504, uploaded letters from the past 505, letters as a service application programming interface (API) 506, etc. The letter communication application 401 allows a user to write 503 open letters to the world and delivers 507 the personalized letter via digital mail or postal mail.

The letter communication application 401 curates 508 and preserves the personalized letters in a storage interface section 338, exemplarily labeled as the “shoebox” to improve 510 literacy and organize 509 the personalized letters and other letters. The letter communication application 401 communicates 511 with social networking applications 405, for enabling users to “like” a personalized letter or “tweet” about the personalized letter to give the personalized letter a broader audience. The letter communication application 401 allows users to send letters for various occasions, for example, to thank a friend, share a life experience, and to organize the user's favorite letters received during the user's life journey. The letter communication application 401 provides a medium to send a private one-to-one communication of importance, or an open letter, for example, to the president. The letter communication application 401 shares and displays 501 meaningful letters via an electronic dashboard 332 exemplarily illustrated in FIG. 3D. The letter communication application 401 also helps users to make new friends, for example, by managing communications and interactions associated with different letters. The letter communication application 401 connects 512 users in the world through more meaningful communication. A letter, inspired by both digital and physical events, can reveal a common link between users.

The letter communication application 401 allows the user to search 513 the world of personal letters, discover 514 friends through letters, and view 515 letters across time and place. Consider an example where a user wants to discover new friends and explore topics that the other users care about. The letter communication application 401 allows the user to browse publicly shared letters to find other users who care deeply about a certain event, subject, business, or cause. The letter communication application 401 allows the user to send a paper letter to connect to the other users while also protecting the other users' privacy of their physical addresses. The user can send a digital notification about the paper letter to the recipient's email address, a Facebook® identity of Facebook, Inc., or a Twitter® handle of Twitter, Inc., from where the recipient can retrieve a digital copy of the paper letter. The letter communication application 401 allows a user to write a personalized letter to anyone, for example, the president as easily as the user can write to his/her best friend. The letter communication application 401 allows a user to send an open letter to the world about a subject the user cares about.

The letter management database stores a collection of letters of election events, political events, and other letters, for example, love letters from Henry VIII to Anne Boleyn, hidden letters of wartime love, love letters lost on their way home, Abraham Lincoln's letters, letters sent to local veterans by kids, etc. A user can upload any paper letter that mattered to the user, or to a loved one who has passed, and can organize and share the letter using the letter communication application 401. The letter communication application 401 allows users to delete digital letters at any time Millions of precious letters from the past can inspire meaningful letters of today. The letter communication application 401 provides the letter management database configured to upload, store, aggregate, archive, curate, organize, search, and provide access to letters in different formats, creates a connection between the world's letter writers, aggregates the letters of the world, inspires new letter writers, and captures history through the lens of personalized letters. Consider an example where a user sends notes to his/her son as he passes through major events in his young life. The letter communication application 401 allows the son to store the letters he receives over time in the letter management database. The letter communication application 401 also allows the user to send paper letters via postal mail, with a digital record, for the most significant passages in his/her son's life, for example, birthdays, little league tryouts, graduations, failures, achievements, etc.

FIGS. 6A-6F exemplarily illustrate screenshots of a graphical user interface (GUI) provided by the letter communication application 401 exemplarily illustrated in FIG. 4, for registering and logging a user into the letter communication application 401. The letter communication application 401 acquires a login identifier or an identity indicator from the user device via the GUI for logging a user into the letter communication application 401 as exemplarily illustrated in FIGS. 6A-6B. The login identifier or identity indicator comprises, for example, an electronic mail address or a social network identifier such as a Facebook® identity or a Twitter® handle. FIGS. 6A-6B exemplarily illustrate the login options provided to the user, for example, login with Facebook®, login with Twitter®, and a register option to authenticate the user prior to providing access to the letter management database and the letter communication application 401. If the user chooses to login via one of the social network identifiers, the letter communication application 401 requests the user's permission to access the user's profile on the respective social network as exemplarily illustrated in FIGS. 6C-6D.

In an embodiment, the letter communication application 401 also acquires user information from social media plug-ins, for example, Facebook® of Facebook, Inc. The letter communication application 401 also provides a registration option to first time users via the GUI. The letter communication application 401 acquires user information, for example, a name, an email address, a unique username, a mobile phone number, and a password from an unregistered user via the GUI as exemplarily illustrated in FIG. 6E. Once registered, the letter communication application 401 allows the user to access the letter management database and create, send, and receive multiple personalized letters in different formats. On registration, the letter communication application 401 also sends a welcome notification, for example, to the email address of the user, with details such as the user's profile information and instructions on how to get started as exemplarily illustrated in FIG. 6F.

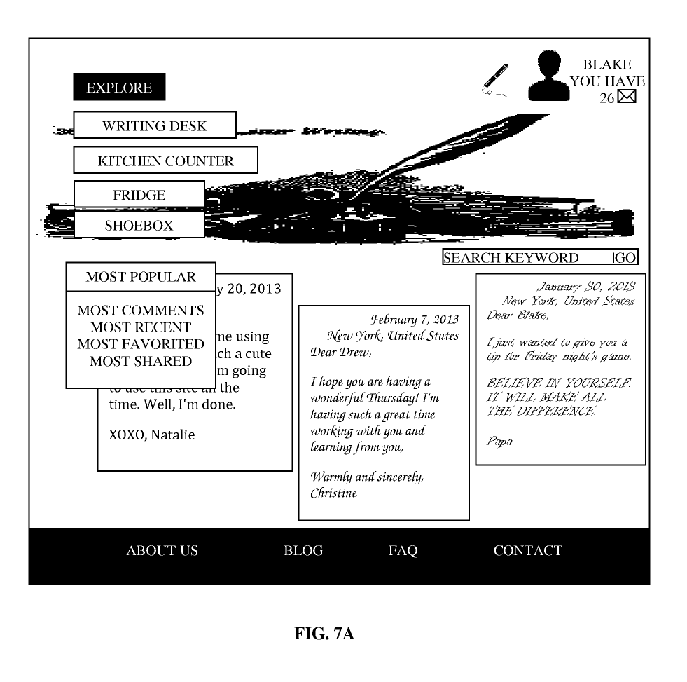

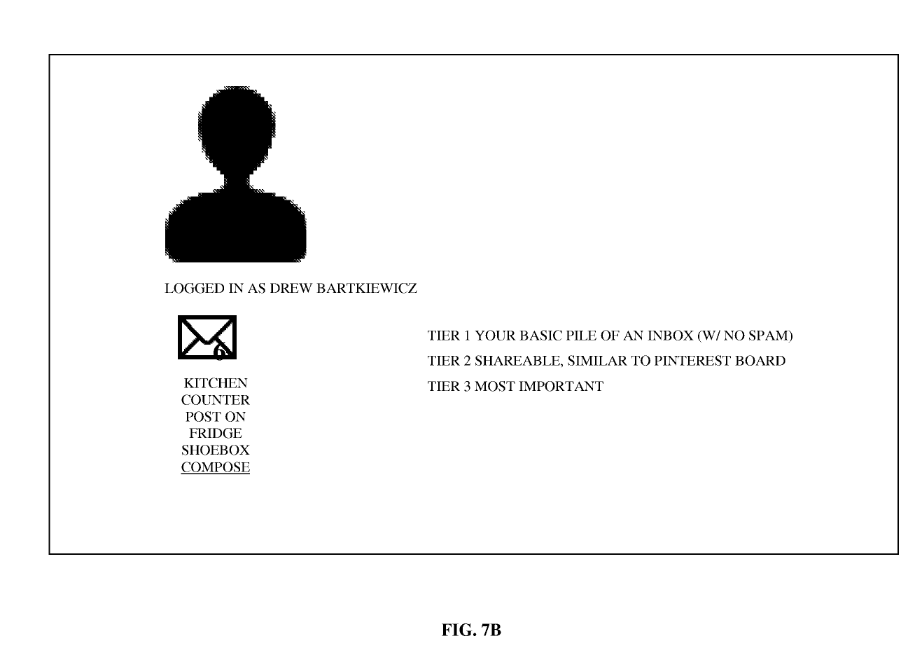

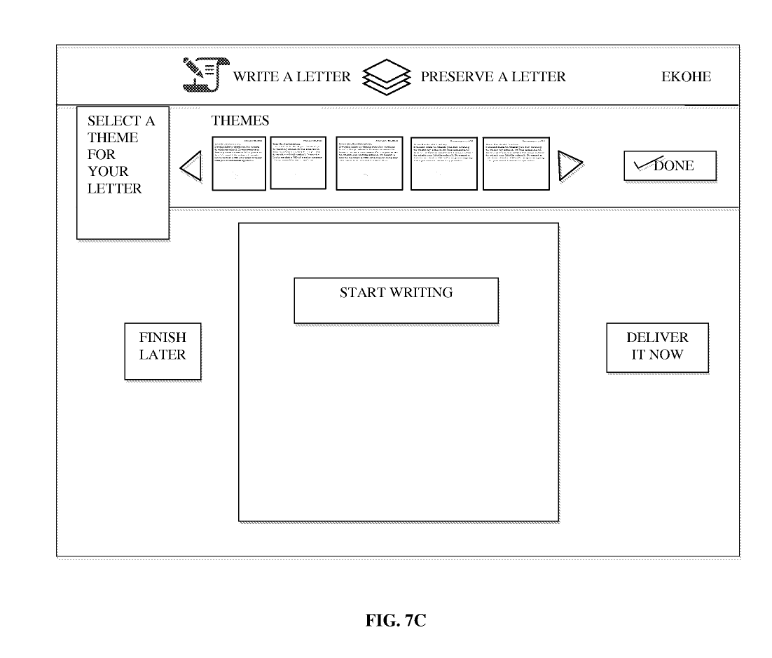

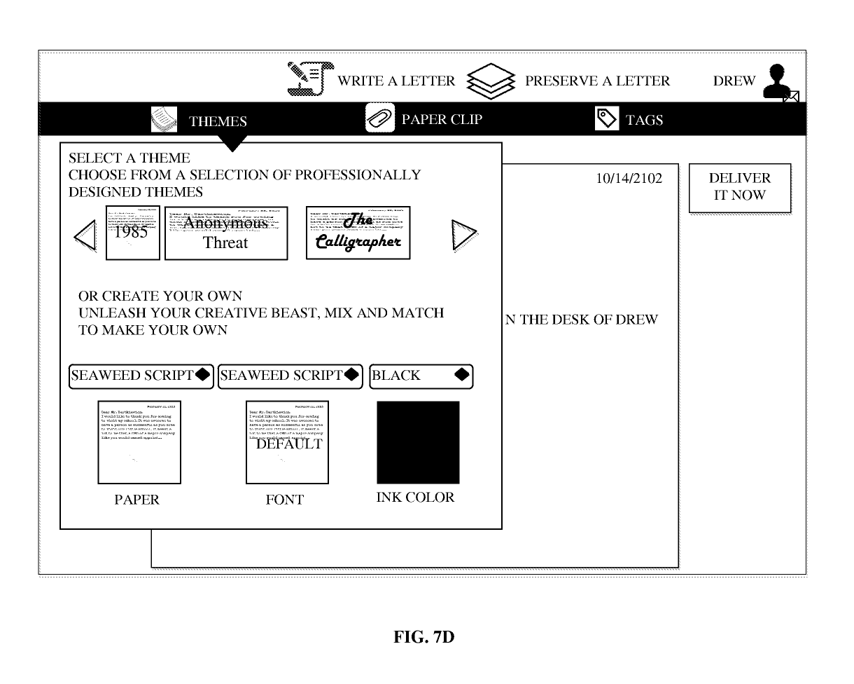

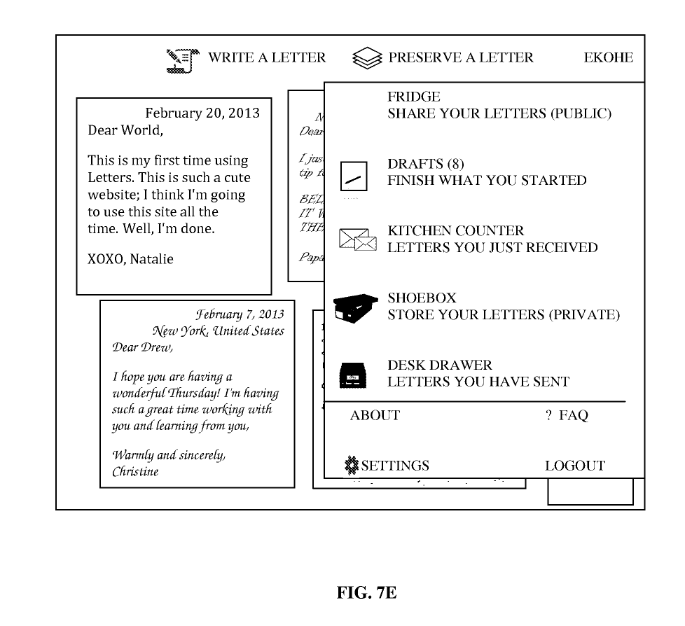

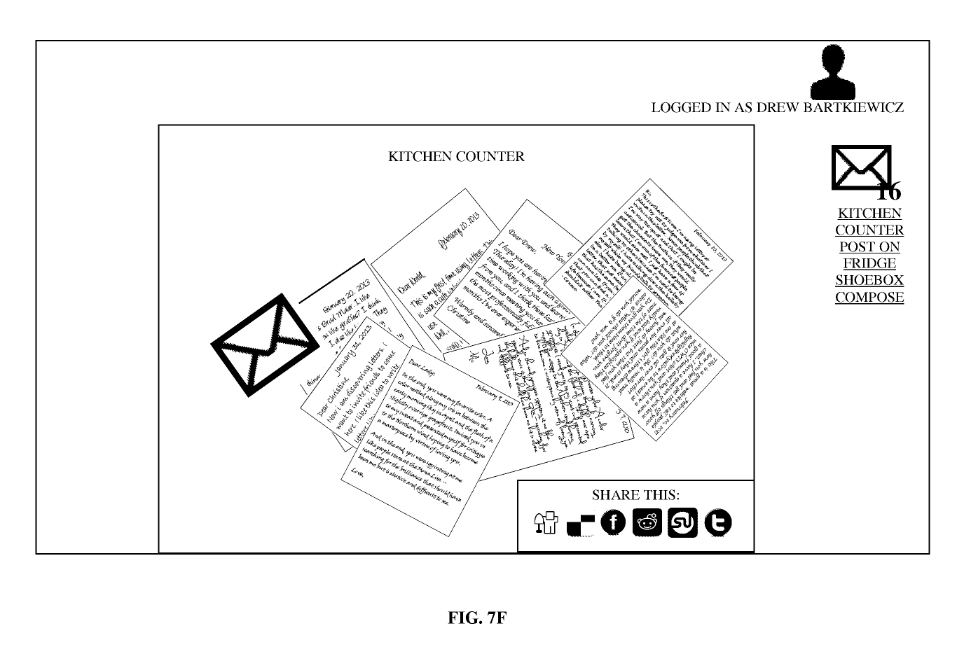

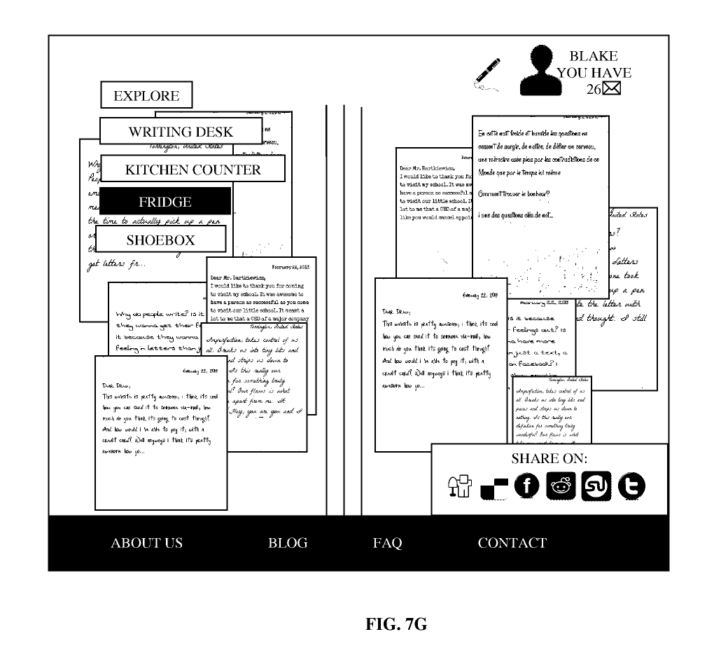

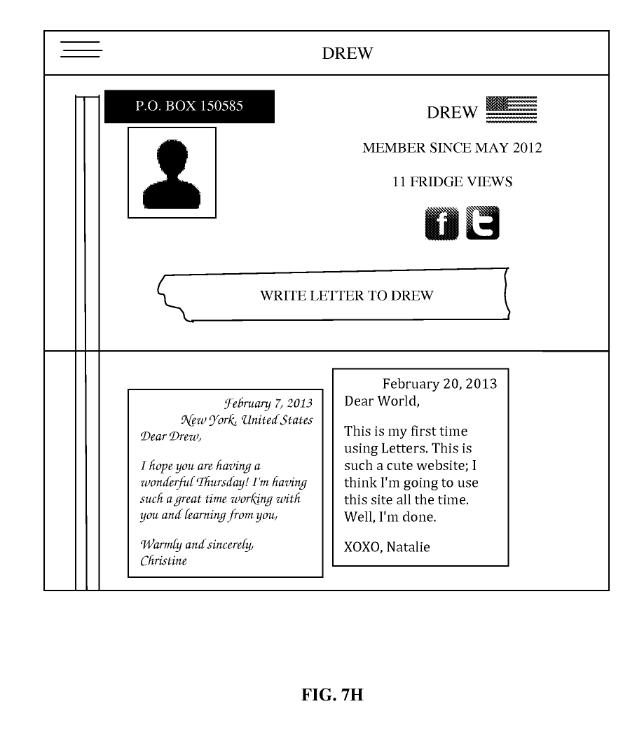

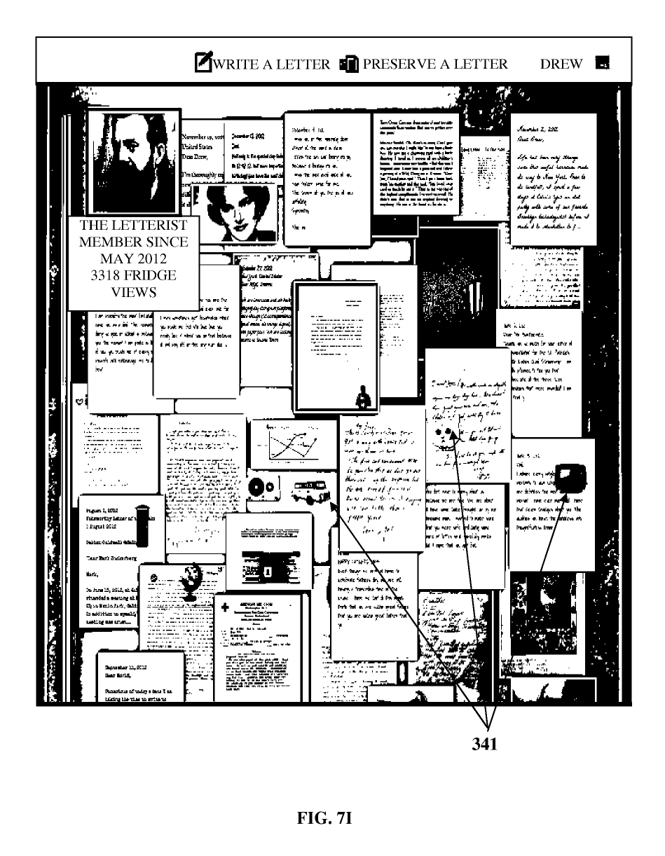

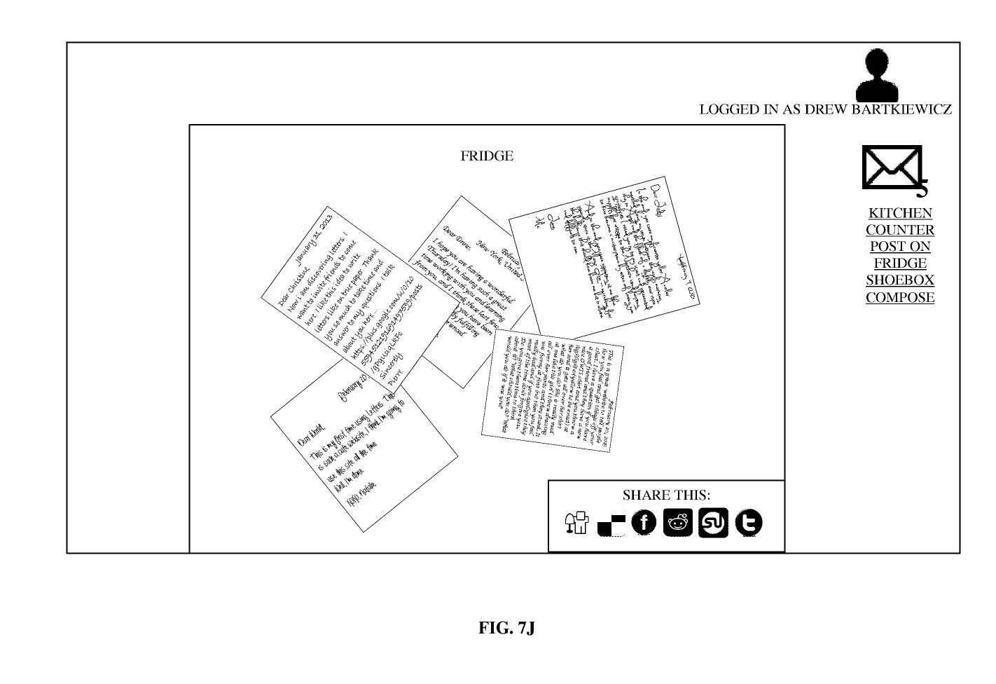

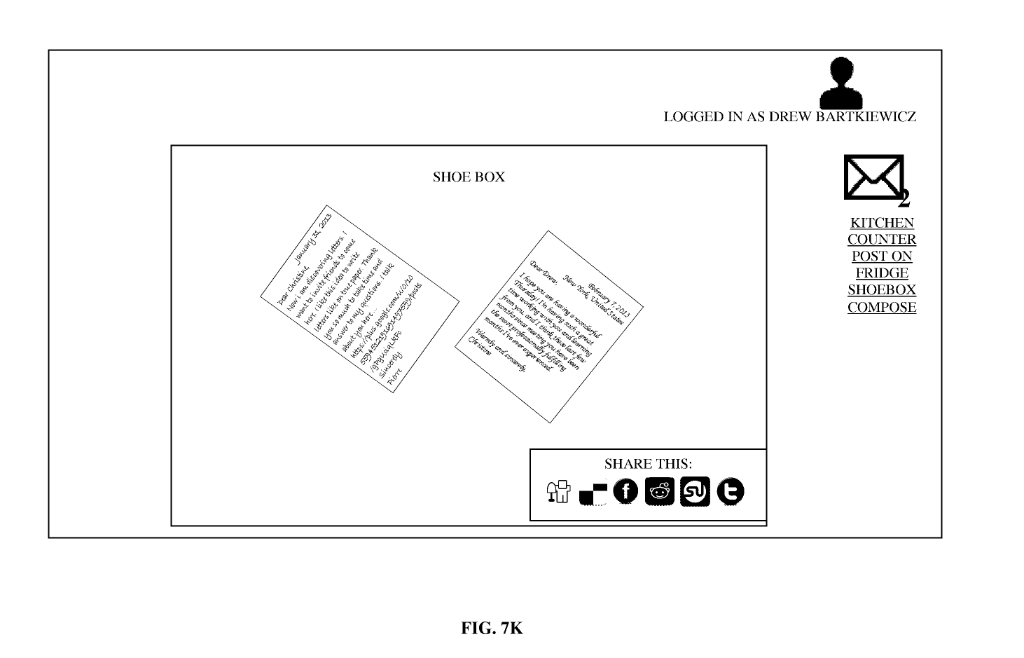

FIGS. 7A-7K exemplarily illustrate screenshots of a graphical user interface (GUI) provided by the letter communication application 401 exemplarily illustrated in FIG. 4, showing different interface sections provided by the letter communication application 401. The interface sections of the letter communication application 401 comprise, for example, an exploration interface section 333, a write interface section 301 exemplarily labeled as a “writing desk”, a preserve interface section, an electronic dashboard 332 exemplarily labeled as a “fridge”, a collection interface section 330 exemplarily labeled as a “kitchen counter”, a storage interface section 338 exemplarily labeled as a “shoebox”, and an archiving interface section as exemplarily illustrated in FIGS. 3A-3D and FIGS. 7A-7K. On successful login, the letter communication application 401 directs the user to an exploration interface section 333 via the GUI as exemplarily illustrated in FIGS. 7A-7B. The exploration interface section 333 provides links to the different interface sections provided by the letter communication application 401 and a link for composing a new personalized letter. The user can send for any one letter and add tags and comments to help the user remember the letter and share the letter at a later point in time. The exploration interface section 333 also provides different tier options for sharing and organizing the letters.

The write interface section 301 is configured to enable writing and delivery of a personalized letter as exemplarily illustrated in FIG. 7C. The write interface section 301 helps a user to create and deliver typed, audio, and visual communications across multi-channels of social media, email, text, and postal mail or paper post with a digital preservation loop of paper letter back to digital. The write interface section 301 provides a writing place which mimics the delivery of letter writing from physical world elements. A user can start writing a new letter on the write interface section 301 and personalize the letter with the different themes found in paper style. The letter communication application 401 delivers a hand written letter, retrieved by a recipient device onto the write interface section 301, deliverable within the letter communication application 401 and network. A user can also write an open letter to the world which goes into the electronic dashboard 332 for display as a meaningful communication that matters to the user. The user can create a letter today and decide to deliver the letter on a date that is days, months, or even years from now. The write interface section 301 provides multiple themes for personalizing the letter as exemplarily illustrated in FIG. 7D. A user can select one of the professionally designed themes available in the letter communication application 401 or the user can unleash his/her creative beast and create his/her own theme using multiple theme creation options, for example, paper options, font options, ink color options, etc.

The preserve interface section is configured to enable upload, adding of comments and dates, and archiving of a hand written letter in the letter management database via the storage interface section 338 and the electronic dashboard 332 as exemplarily illustrated in FIG. 7E. The letter communication application 401 captures a hand written letter as an attachment object for delivery and organization within the letter communication application 401 and the network. A user can upload and preserve letters from his/her past or handwritten letters and secure the letters in the letter management database or share the letters via the electronic dashboard 332. For every letter object uploaded to the letter communication application 401 for preservation or display on the electronic dashboard 332, the letter communication application 401 places a digital watermark on the letter object for authentication and association within the letter communication application 401. The letter communication application 401 provides access to the different interface sections, for example, the electronic dashboard 332 exemplarily labeled as the “fridge”, “drafts”, the collection interface section 330 exemplarily labeled as the “kitchen counter”, the storage interface section 338 exemplarily labeled as the “shoebox”, and an archiving interface section exemplarily labeled as the “desk drawer” via the GUI as exemplarily illustrated in FIG. 7E.

The collection interface section 330 exemplarily labeled as the “kitchen counter” is configured to receive the generated personalized letter and enable viewing and organization of the generated personalized letter and other letters as exemplarily illustrated in FIG. 7F. The collection interface section 330 allows a user to organize the letters into a private space or a personal space in the letter communication application 401. The electronic dashboard 332, exemplarily labeled as the “fridge” is configured to display the generated personalized letter, customized adornment objects 341 exemplarily illustrated in FIG. 3D, and the other letters as exemplarily illustrated in FIGS. 7G-7J. The electronic dashboard 332 also displays the unique identification code, for example, a post box number as exemplarily illustrated in FIG. 7H. The unique identification code is a unique and universal identifier to a recipient's digital address and physical address. The unique identification code allows a sender who does not know a recipient's physical address, social networking identification address, or email address to send a letter to the recipient through multiple delivery options.

The storage interface section 338 exemplarily labeled as the “shoebox” is configured to enable sliding and dragging of the generated personalized letter and the other letters to the electronic dashboard 332 as exemplarily illustrated in FIG. 7K. The letter communication application 401 generates a dual share request and sends the dual share request to the sender or the original writer to display a private letter on the electronic dashboard 332. The archiving interface section exemplarily labeled as the “desk drawer” is configured to maintain the delivered personalized letter and the other letters based on sort parameters. The sort parameters comprise, for example, design, theme, content, origin, tags, destination, etc. The archiving interface section maintains the metadata for sort, the organization processes, etc.

The letter management database allows users to browse many walls of letters created by other users via the electronic dashboard 332. The electronic dashboard 332 provides a fun way to discover writing skills and obtain inspiration from other users who share the same interests. Consider an example where a user uses the letter communication application 401 to share his/her personal style by incorporating things he/she cares about into embedded letters. The user can share letters he/she receives that have significance, that are creative or just fun. The user can personalize the layout of the electronic dashboard 332 and allow the world to explore his/her letter collection through the electronic dashboard 332. Consider another example where a user uses the letter communication application 401 to organize his/her life of meaningful communications into the storage interface section 338. The letter communication application 401 allows the user to deliver, tag, and save all the letters that he/she receives. The letter communication application 401 allows the user to compile all letters he/she receives, offline and online, to tell his/her life story. The user can organize and sort, for example, by specific person, by year, or by subject to keep his/her storage interface section 338 an accessible and meaningful part of his/her life.

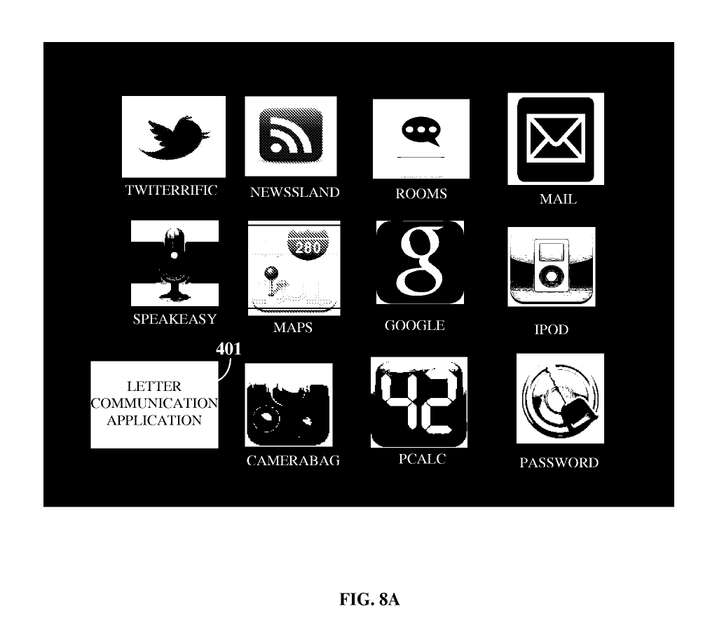

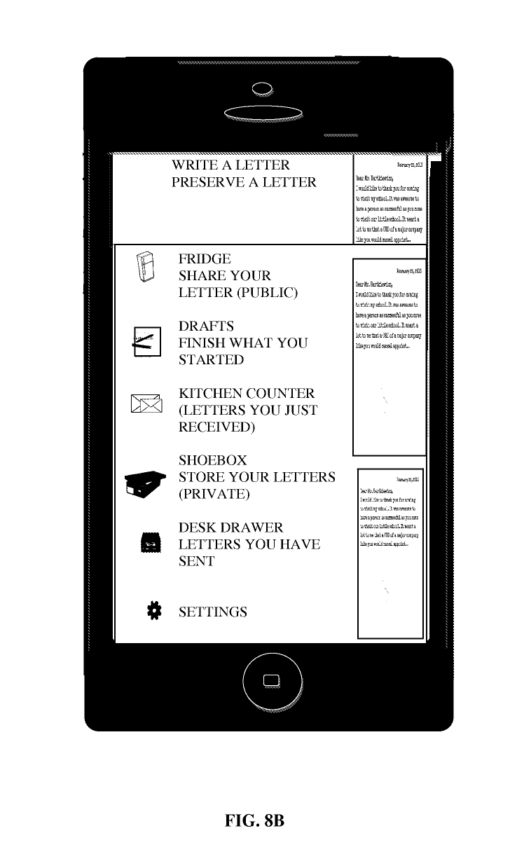

FIGS. 8A-8B exemplarily illustrate screenshots of a graphical user interface (GUI) provided by the letter communication application 401 configured as a software application downloadable on a user device. FIG. 8A exemplarily illustrates a screenshot of the GUI displayed on the user device, for example, a mobile device, showing the letter communication application 401 as one of the software applications downloaded on the mobile device. FIG. 8B exemplarily illustrates a screenshot of the GUI displayed on a mobile device, showing the different interface sections of the letter communication application 401 as disclosed in the detailed description of FIGS. 7A-7K.

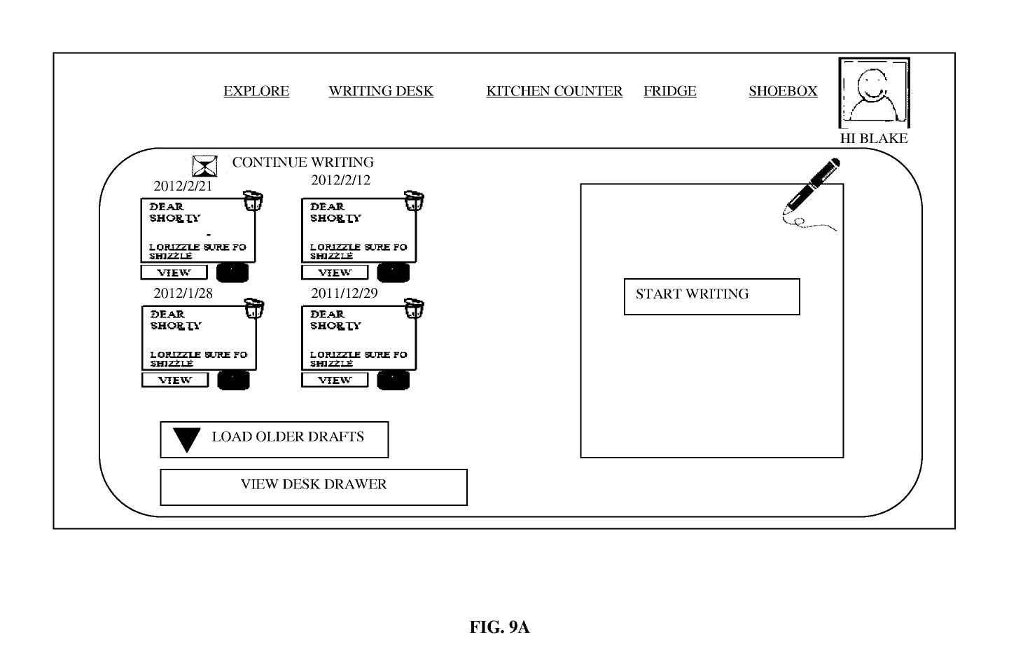

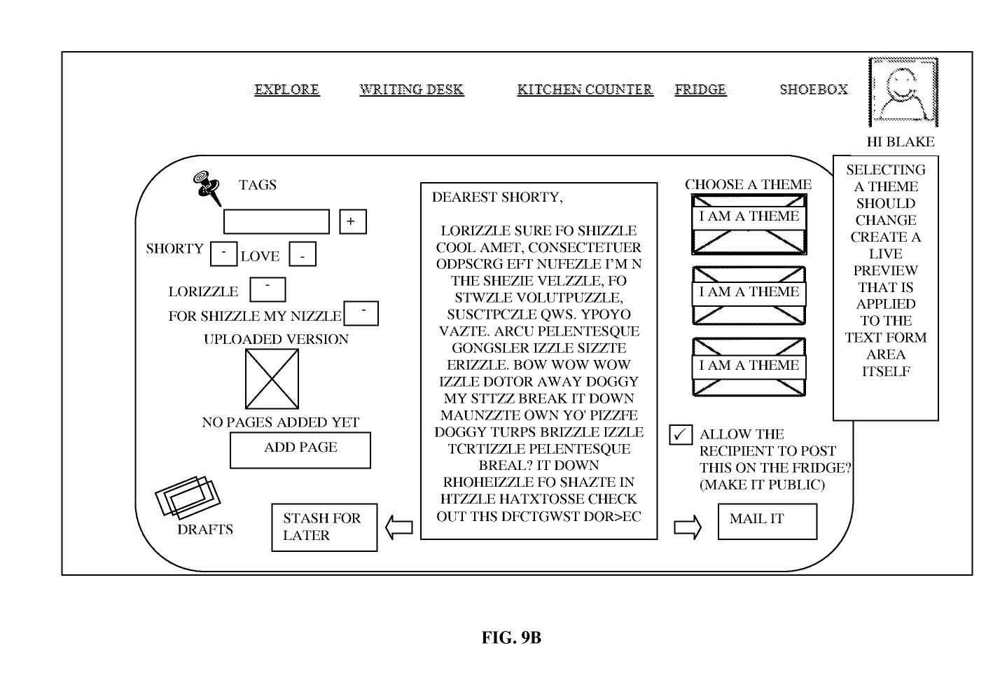

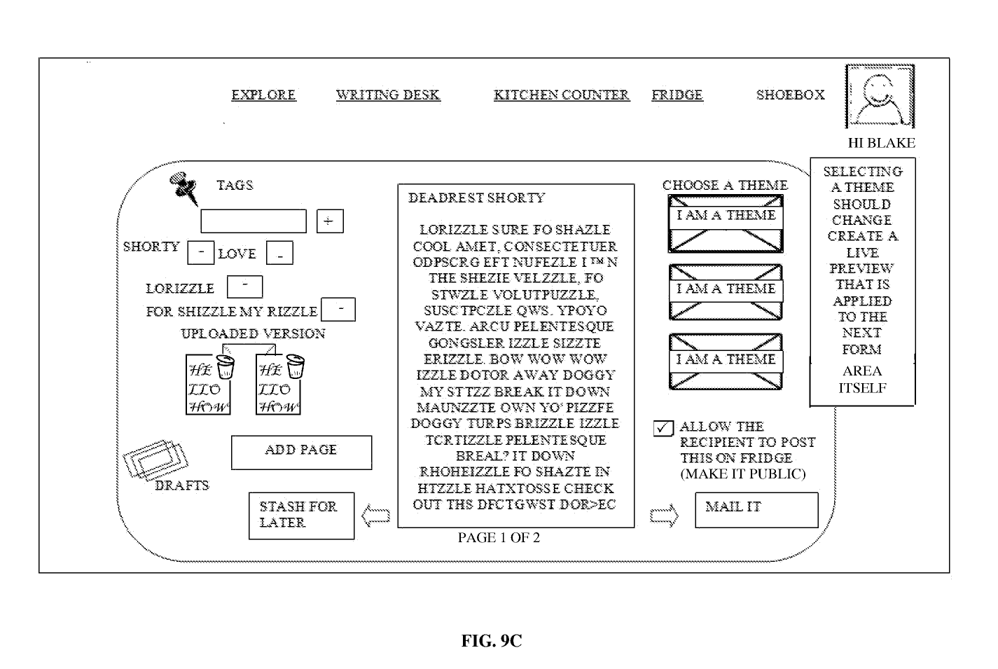

FIGS. 9A-9C exemplarily illustrate screenshots of a graphical user interface (GUI) provided by the letter communication application 401 exemplarily illustrated in FIG. 4, for generating a personalized letter. The write interface section 301 exemplarily illustrated in FIG. 3A, allows a user to write a letter from the web based platform or the website or a mobile device. The user can start a new letter via the write interface section 301 or continue writing a letter from the “drafts” section on the GUI as exemplarily illustrated in FIG. 9A. The draft section contains letters in progress started on a user device or via the website. The letter communication application 401 provides an option on the write interface section 301 to load older drafts. The write interface section 301 provides a link to view the archiving interface section exemplarily labeled as the “desk drawer” as exemplarily illustrated in FIG. 9A. The user can upload other letters and add dynamic themes to personalize a new letter via the write interface section 301 on the GUI as exemplarily illustrated in FIG. 9B. The dynamic themes comprise, for example, themes that play a song when the user begins writing. The dynamic themes also comprise, for example, a fusion of fonts, templates, art, commerce, etc. The themes can be custom created by the user or sponsored, for example, by a brand, a person, or a cause. The themes can be seasonal, commemorative and can be bought and owned by one person or by a company. The topic of the new personalized letter can, for example, be about a humanitarian cause, a famous person, an event, or a political movement. The letter communication application 401 integrates themes which become dynamic spaces for digital links, displays, application programming interface (API) calls, action buttons, advertising, and electronic commerce. The letter communication application 401 blends vintage themes of letters past with emerging ideas of letters present via the write interface section 301. The user can also upload multiple pages for any one letter and add tags and comments to help the user remember the letter and share the letter at a later point in time as exemplarily illustrated in FIG. 9C. The user can also add a geo-locate stamp and attach an API driven picture, song or video to the letter. The user can then stash the personalized letter for later use or mail the personalized letter. The generated personalized letter can also be shared with the world via the electronic dashboard 332 exemplarily illustrated in FIG. 3D, with the user's consent.

FIGS. 10A-10C exemplarily illustrate screenshots of a graphical user interface (GUI) provided by the letter communication application 401 exemplarily illustrated in FIG. 4, showing multiple delivery options for delivering the generated personalized letter. The letter communication application 401 allows a user to send the personalized letter to a physical recipient, a digital recipient, or as an open letter as exemplarily illustrated in FIGS. 10A-10B. The letter communication application 401 allows a user to send a real letter via postal mail to one or more recipients. If the user chooses to send the personalized letter to a physical recipient, the letter communication application 401 provides different packaging options to mail the personalized letter anywhere in the world for a low price as disclosed in the detailed description of FIGS. 11A-11F. The letter communication application 401 further provides a free digital mail option to the user. The digital mail option allows a user to choose to deliver the personalized letter to a digital recipient at a future date by sending digital notifications, for example, to an email address of a recipient, a Facebook® friend, a Twitter® friend or a Google® contact as exemplarily illustrated in FIG. 10C. The user can also send digital notifications of the personalized letter to someone the user is following on Twitter®. The open letter option allows the user to deliver a message to the world. If the user chooses to deliver the personalized letter as an open letter, the letter communication application 401 posts the letter immediately on the user's electronic dashboard 332 exemplarily illustrated in FIG. 3D for the world to see.

FIGS. 11A-11F exemplarily illustrate screenshots of a graphical user interface (GUI) provided by the letter communication application 401 exemplarily illustrated in FIG. 4, for delivering the generated personalized letter via postal mail. The letter communication application 401 provides a digital letter-as-a-service platform for international digital distribution, and also provides a fee based paper mail-as-a-service option for handmade, hand sent, paper distribution to enhance the letter experience and provide letters on demand. The letter communication application 401 processes millions of digital letters using cloud computing platforms. The letter communication application 401 sends the generated personalized letter via postal mail using a postal address or the recipient identifier. The digital to paper post identification process requires only one recipient identifier of a specific recipient to send a paper letter to anywhere in the world from an internet browser or a mobile application.

The letter communication application 401 reverse engineers the social and email addresses of the users to create physical addresses for letter delivery. If the user knows the postal address of the recipients, the user can send the personalized letter by entering the postal address of all the recipients via the GUI as exemplarily illustrated in FIG. 11A. The letter communication application 401 allows the user to send a paper letter to one or more recipients even if the user does not know the postal addresses of the recipients. The letter communication application 401 creates the physical address using at least one recipient identifier for delivering the generated personalized letter to one or more recipients via postal mail. The letter communication application 401 acquires a recipient identifier, for example, an email address, a contact number, etc., of each of the recipients from the user via the GUI.

In an embodiment, the letter communication application 401 contacts the recipients, for example, by sending an email to each of the recipients, by initiating a call to each of the recipients, or by sending a short messaging service (SMS) to each of the recipients, and acquires the postal address of each of the recipients for delivering the generated personalized letter via postal mail. In another embodiment, the letter communication application 401 acquires the unique identification code, for example, the post box number of each of the recipients, from the sender device via the GUI. The unique identification code may be linked to the physical or postal address of each of the recipients, thereby allowing the letter communication application 401 to deliver the generated personalized letter via postal mail. The paper mail service, also referred to as postal mail, is also internationally available. To send a paper letter via postal mail, the letter communication application 401 communicates with a main postal center located at a geographical location, for example, Collinsville, Connecticut.

Once the mailing address is acquired, the letter communication application 401 allows the user to select the look and feel of the personalized letter, for example, by providing stationary options on the GUI as exemplarily illustrated in FIG. 11B. The different stationery options comprise, for example, high quality recycled paper, high quality stock paper, handmade paper, etc. The letter communication application 401 also provide matching envelopes in the selected paper type. A user may also create a handwritten personalized envelope via the letter communication application 401. The letter communication application 401 enters handwriting on the selected paper envelope to create the personalized envelope to deliver the letter. The letter communication application 401 provides vintage options for printing and packaging the paper letters, for example, seals, wax, and parchment paper, thereby bringing back the timeless nature of letters that has lasted for hundreds of years. The letter communication application 401 allows the user to place the user's return address on the printed paper letter, or place the post box number on the printed paper letter. At the main postal center, every paper letter is sealed by hand to mark its authenticity of origination and certification. The letter communication application 401 also provides the seal option in digital form.

The letter communication application 401 provides multiple payment options to deliver the personalized letter via postal mail. The cost of the personalized letter varies, for example, according to the type of paper selected, number of pages to be printed, the location of the recipients, etc. The letter communication application 401 acquires the billing details and card details from the user via the GUI for sending the personalized letter as exemplarily illustrated in FIG. 11C. The hand mailed paper letter that the users create and design can be mailed, for example, for about $2, about $4, about $8, etc. For international paper letter delivery an additional charge of, for example, about $3 is charged. Once the payment has been made, the letter communication application 401 delivers the personalized letter and sends digital notifications to the user via the GUI as exemplarily illustrated in FIGS. 11D-11E. The letter communication application 401 notifies the user on when the personalized letter has been sent and when the personalized letter is delivered. The letter communication application 401 then directs the user to a summary page on the GUI, showing the list of personalized letters sent, number of views of a personalized letter, options for providing permissions to the recipients to share the personalized letter, etc., as exemplarily illustrated in FIG. 11F.

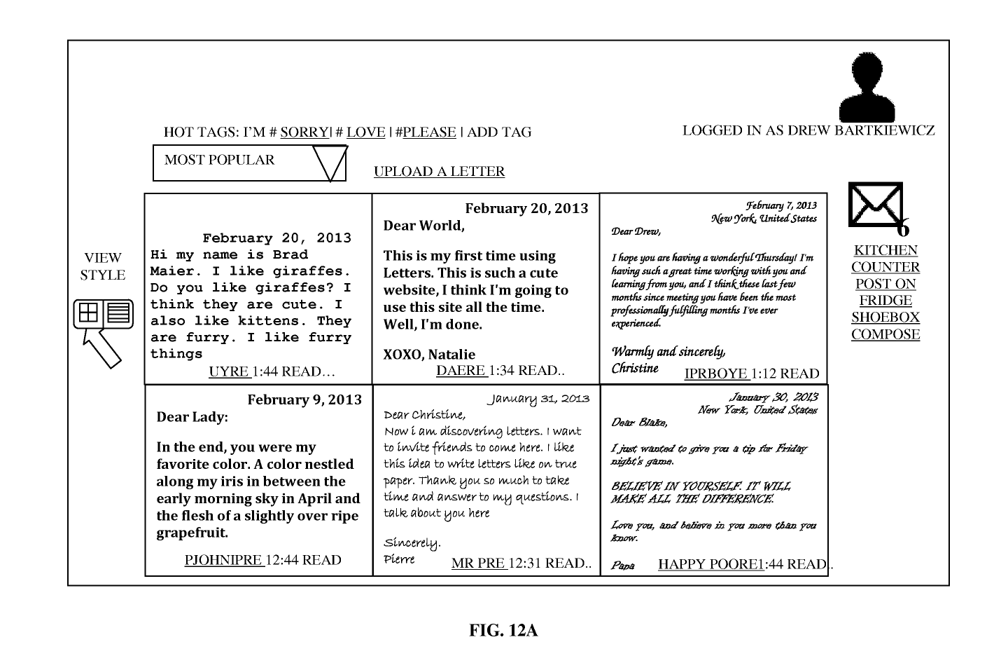

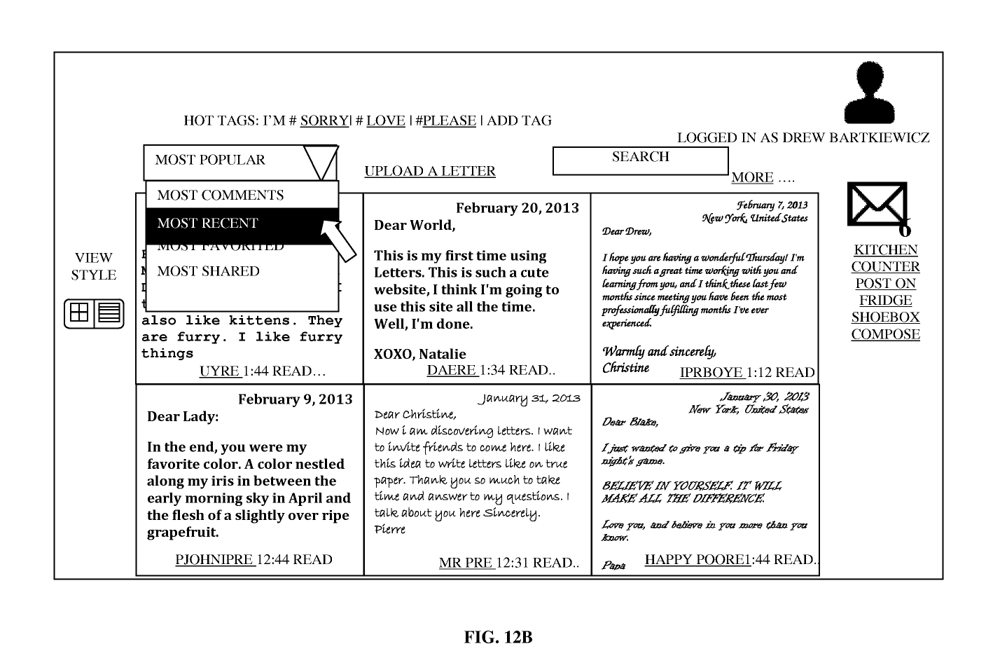

FIGS. 12A-12B exemplarily illustrate screenshots of a graphical user interface (GUI) provided by the letter communication application 401 exemplarily illustrated in FIG. 4, showing different viewing options provided by the letter communication application 401. The letter communication application 401 provides different viewing styles, for example, a grid view, a list view, etc., for viewing different letters stored in the letter management database as exemplarily illustrated in FIG. 12A. The letter communication application 401 also allows users to view letters, for example, by most popular, by most recent, by most comments, by most favorited, and by most shared as exemplarily illustrated in FIG. 12B.

FIGS. 13A-13C exemplarily illustrate screenshots of a graphical user interface (GUI) provided by the letter communication application 401 exemplarily illustrated in FIG. 4, for editing and composing a new personalized letter from an existing letter stored in the letter management database. The letter communication application 401 provides an “upload a letter” link on the GUI as exemplarily illustrated in FIGS. 13A-13C, for enabling a user to upload existing or old letters. The letter communication application 401 uploads and stores the existing letters in the letter management database. The letter communication application 401, in communication with the letter management database, is configured to preserve the existing letters and/or generate the personalized letter using the existing letters. The letter communication application 401 manages the letters in the cloud for each user to read, preserve, or share. The letter communication application 401 allows a user to select one of the most recent uploaded letters from the letter management database via the GUI as exemplarily illustrated in FIG. 13A, and create a text version of the selected uploaded letter on the GUI as exemplarily illustrated in FIG. 13B. The user can then compose a new mail using the selected uploaded letter on the GUI as exemplarily illustrated in FIG. 13C.

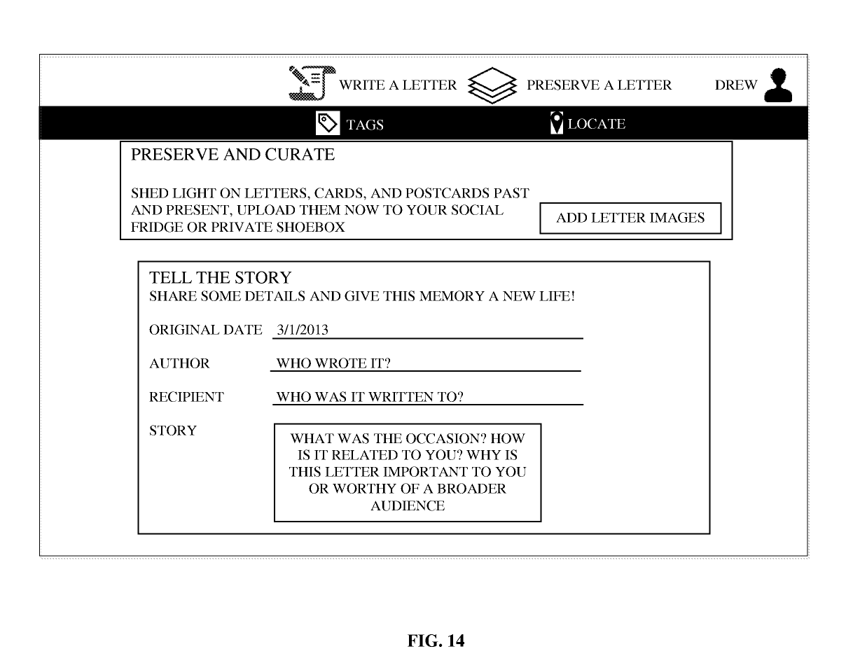

FIG. 14 exemplarily illustrates a screenshot of a graphical user interface (GUI) provided by the letter communication application 401 exemplarily illustrated in FIG. 4, for uploading and preserving letters and sharing information about the letters. The letter communication application 401 preserves and curates past and present letters, cards and postcards. A user can upload the letters, cards or postcards to the electronic dashboard 332 or “fridge” exemplarily illustrated in FIG. 3D, or store them in the private storage interface section 338 or “shoebox” exemplarily illustrated in FIG. 3D. The user can also add letter images, for example, by clicking on an “add letter images” interface element or button provided on the GUI. The letter communication application 401 allows the user to tell the story behind each letter, share some details about the letter, and give the memory of the letter a new life. The user can enter details about each uploaded letter, for example, the original date the letter was written, the author of the letter, the recipient of the letter, etc., via the GUI. The user can also add details such as the occasion for writing the letter, how the letter is related to the user, the importance of the letter to the user, etc., via the GUI, or share the letter with a wider audience through the electronic dashboard 332.

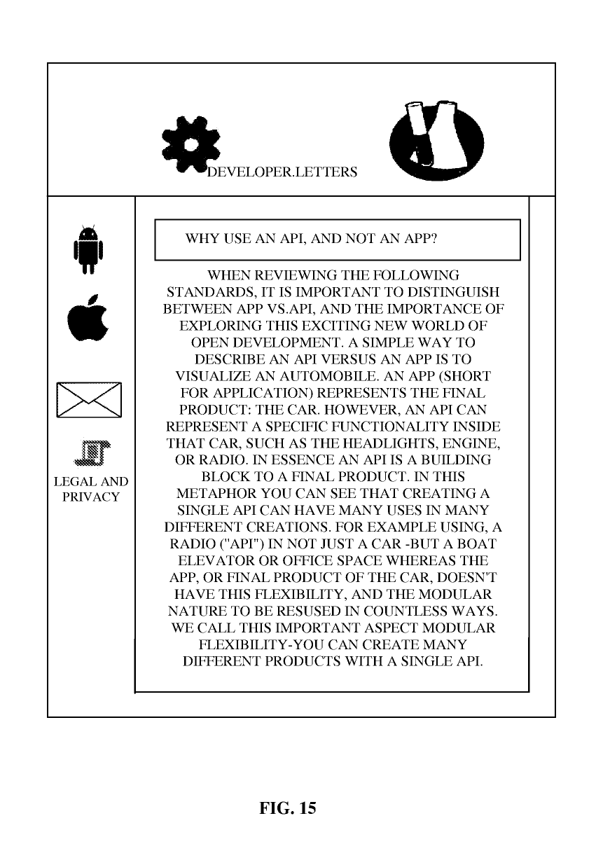

FIG. 15 exemplarily illustrates a screenshot of a graphical user interface (GUI) provided by the letter communication application 401 exemplarily illustrated in FIG. 4, showing letters from developers of the letter communication application 401. FIG. 15 exemplarily illustrates a letter from a developer stored in the letter management database detailing the usage of an application programming interface (API) and the differences between APIs and applications. Developers can upload, post, share letters on multiple topics, for example, new developments, new features added, bug information, bugs fixed, help topics, etc., concerning the letter communication application 401 and the letter management database via the GUI to help a user use the letter communication application 401.

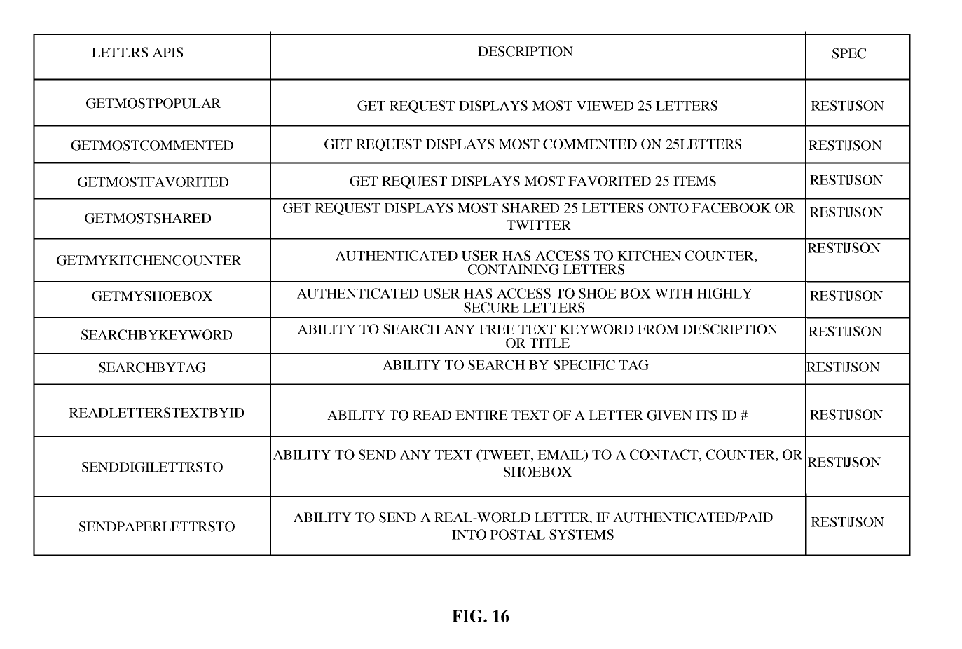

FIG. 16 exemplarily illustrates a screenshot of a graphical user interface (GUI) provided by the letter communication application 401 exemplarily illustrated in FIG. 4, showing various application programming interfaces (APIs) of the letter communication application 401. The letter communication application 401 incorporates multiple APIs for performing multiple functions of the letter communication application 401 as exemplarily illustrated in FIG. 16. The APIs of the letter communication application 401 comprise, for example, a getmostpopular API, a getmostcommented API, a getmostfavorited API, a getmostshared API, a getmykitchencounter API, a getmyshoebox API, a searchbykeyword API, a searchbytag API, a readletterstextbyID API, a senddigilettrsto API, and a sendpaperlettrsto API. The getmostpopular API request displays, for example, 25 of the most viewed letters on the GUI. The getmostcommented API request displays 25 of the most commented on letters on the GUI. The getmostfavorited API request displays 25 of the most favorite letters or items on the GUI. The getmostshared API request displays 25 of the most shared letters onto Facebook® or Twitter® on the GUI. The getmykitchencounter API request provides authenticated users access to the collection interface section 330, exemplarily labeled as the “kitchen counter”, containing letters. The getmyshoebox API provides the authenticated users access to the storage interface section 338, exemplarily labeled as the “shoebox”, with highly secure letters. The searchbykeyword API request enables the users to search the letter management database using any free text keyword from description or title. The searchbytag API request enables the users to search the letter management database using a specific tag. The readletterstextbyID API request enables the users to read the entire text of a letter given its digital access identifier (ID). The senddigilettrsto API request enables the users to send any text, for example, a tweet, an email, etc., to a contact, a counter, or the storage interface section 338. The sendpaperlettrsto API request enables the users to send a real-world letter, also referred to as paper letter, if authenticated into postal systems.

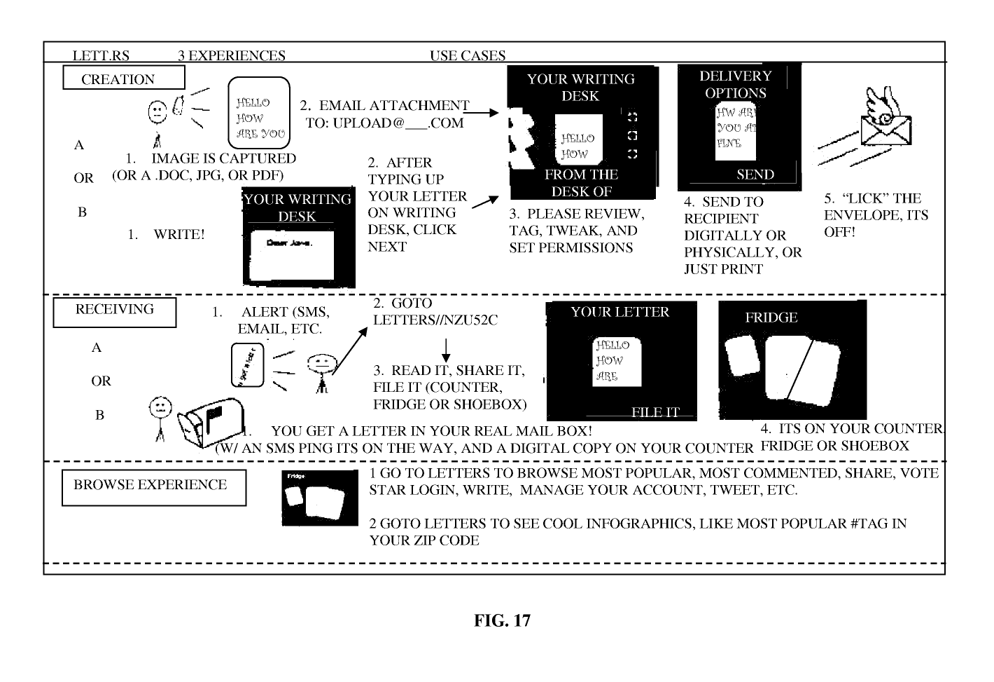

FIG. 17 exemplarily illustrates a screenshot of a graphical user interface (GUI) provided by the letter communication application 401 exemplarily illustrated in FIG. 4, showing the steps involved in generating and receiving a personalized letter as well as browsing options provided to a user by the letter communication application 401. A user can capture an image using his/her user device. The image can be of multiple formats, for example, a portable document format (PDF), a joint photographic experts group (JPEG) format, a document (DOC) format, etc. The user can email the image as an attachment to the letter communication application 401. Using the write interface section 301 of the letter communication application 401 exemplarily illustrated in FIG. 3A, the user can create and review a personalized letter that incorporates the image and can tag, tweak, and set permissions to the created personalized letter. The user can then send the personalized letter to a recipient digitally or physically or print the personalized letter. The user can also write a new letter via the write interface section 301, labeled as the “writing desk” and then send the letter. The letter communication application 401 sends alerts to the recipient device, for example, via a short messaging service, an electronic mail, etc., on receipt of a personalized letter. On receipt of the alerts, the recipient can login to the letter communication application 401 and view, share, or file the received personalized letter, or check his/her real world mailbox for a paper letter sent via postal mail. The recipient can file the received personalized letter in the storage interface section 338, exemplarily labeled as the “shoebox”, or on the collection interface section 330 exemplarily labeled as the “kitchen counter”, or display the received personalized letter on the electronic dashboard 332, exemplarily labeled as the “fridge” as exemplarily illustrated in FIGS. 3C-3D. The recipient can also tag the received personalized letter via the GUI. A digital copy of the paper letter is also available to the recipient via the GUI of the letter communication application 401. The user can also browse the letters stored in the letter management database, for example, by most popular, by most commented, by vote, by share, by star, by login, by write, by tweet, etc. The letter communication application 401 also provides information graphics to the user, for example, a most popular tag in the user's zip code.

FIGS. 18A-18D exemplarily illustrate screenshots of a graphical user interface (GUI) provided by the letter communication application 401 exemplarily illustrated in FIG. 4, showing customizable adornment objects 341 provided by the letter communication application 401 for display on an electronic dashboard 332 exemplarily illustrated in FIG. 3D, provided on the GUI. The customizable adornment objects 341, example, magnets, are configured for one or more of a static display, an integration of media files and digital links to electronic commerce destinations, advertisements, and revenue generation options, and triggering of one or more incentives. The media files comprise, for example, songs, announcements, video commercials, etc. The application programming interfaces (APIs) of the letter communication application 401 integrate the customizable adornment objects 341 that play a song or announcement or a video commercial. The incentives comprise, for example, coupons, promotions, etc. The customizable adornment objects 341, for example, magnets are free, sponsored by a brand, or are purchasable for monetary value. The customizable adornment objects 341 leverage APIs for multiple social and commercial purposes. The integrated customizable adornment objects 341 are configured as dynamic placeholders for digital links, displays, API calls, action buttons, advertising, and electronic commerce.

The customizable adornment objects 341, for example, magnets integrated with physical objects, pictures, and letters are exemplarily illustrated in FIGS. 18A-18D. Specific tiers of customizable adornment objects 341 integrate adverting and commerce into letter and picture displays. The customizable adornment objects 341 provided by the letter communication application 401 can generate a song, create a purchase, promote a business, a person or a cause, generate a video, maintain a count, drive advertising, and drive commerce. FIG. 18C exemplarily illustrates customizable adornment objects 341 such as magnets on sale for charity purposes, for example, to support kids in Vietnam and Cambodia living in desperate conditions. The customizable adornment objects 341 are configured as day to day objects, for example, glasses, doughnuts, letters, cassettes, park benches, a globe, musical instruments such as an accordion, etc., as exemplarily illustrated in FIG. 18D. In an embodiment, the letter communication application 401 generates a count of a customizable adornment object 341, for example, by maintaining a count of the number of users who have selected that particular customizable adornment object 341 to adorn their electronic dashboard 332, and a count of the aggregate number of views of all letters on that electronic dashboard 332. FIG. 18D exemplarily illustrates shows magnet counts which can become part of the displayed metadata on a magnet. The letter communication application 401 develops a content and commerce system around the customizable adornment objects 341, for example, magnets to develop advertising, electronic commerce, fundraising, and API mashups specific to the world of letter correspondence for the digital world.

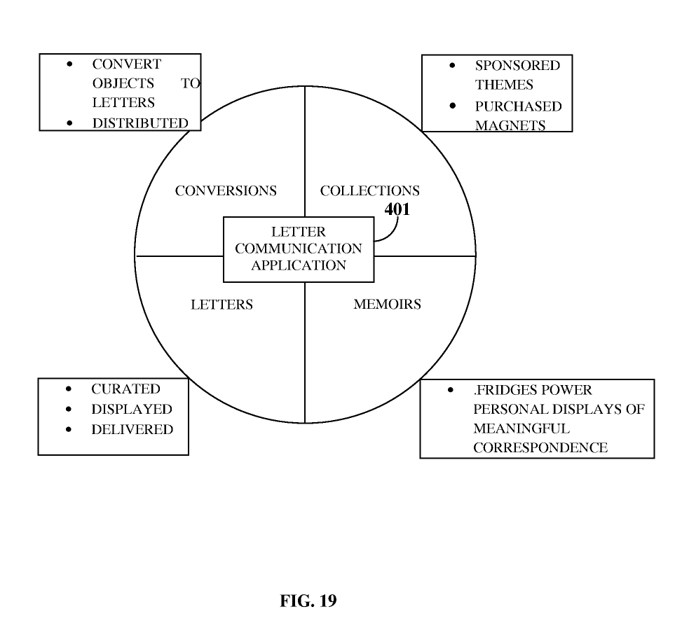

FIG. 19 exemplarily illustrates revenue generation options provided by the letter communication application 401. The revenue generation options comprise, for example, customizable adornment objects 341 such as magnets as exemplarily illustrated in FIGS. 18A-18D, themes, and postal mail. The letter communication application 401 generates revenue, for example, via conversions, collections, letters, memoirs, etc. The letter communication application 401 generates revenue by converting digital objects to letters and distributing the letters. In an embodiment, the letter communication application 401 generates revenue by providing customizable adornment objects 341 for display and selection on the electronic dashboard 332 exemplarily illustrated in FIG. 3D, provided on the GUI, and for sponsorship for a predetermined fee. In another embodiment, the letter communication application 401 also generates revenue by providing one or more themes for the generation of the personalized letter and for sponsorship for a predetermined fee. In another embodiment, the letter communication application 401 delivers the generated personalized letter to each of one or more recipients via postal mail. The letter communication application 401 curates, displays, and delivers the letters. The letter communication application 401 generates revenue via postal mail by providing different stationery options, for example, paper types, envelope types, etc., for printing and delivering the personalized letters for a fee. In an embodiment, the letter communication application 401 generates revenue by creating memoir type products, for example, books of letters, letters on canvas, mugs, shirts, etc., using the letters stored in the letter management database. The users can search the letter management database for stored personal letters via the GUI of the letter communication application 401 and create the memoir type products using the selected personal letters and other media objects.

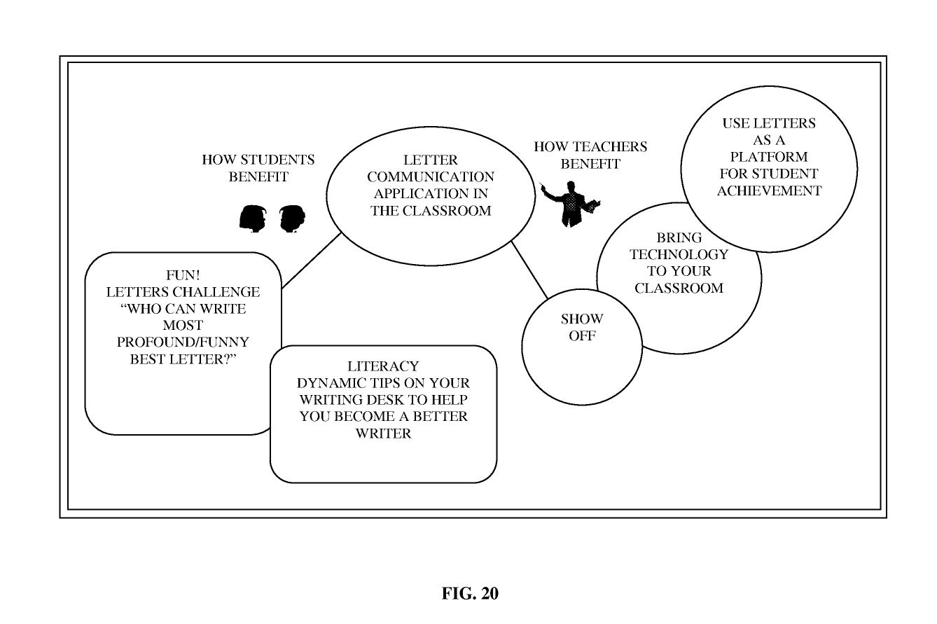

FIG. 20 exemplarily illustrates an implementation of the letter communication application 401 exemplarily illustrated in FIG. 4, in an online classroom environment. In an embodiment, the letter communication application 401 is implemented in an online classroom environment. The letter communication application 401 provides dynamic tips on the write interface section 301, exemplarily illustrated in FIG. 3A, to teach students. The letter communication application 401 also provides classroom displays of letter projects. The letter communication application 401 displays letters, for example, as commentable, likeable, tweetable writing objects. The letter communication application 401 provides fun letter challenges to students, for example, a challenge on who can write the most profound and/or funny letter. The letter communication application 401 provides dynamic tips on the write interface section 301 to help improve the writing skills of students. The students can use the letter communication application 401 to show off their talents, to bring technology to the classroom, and as a platform for achievements.

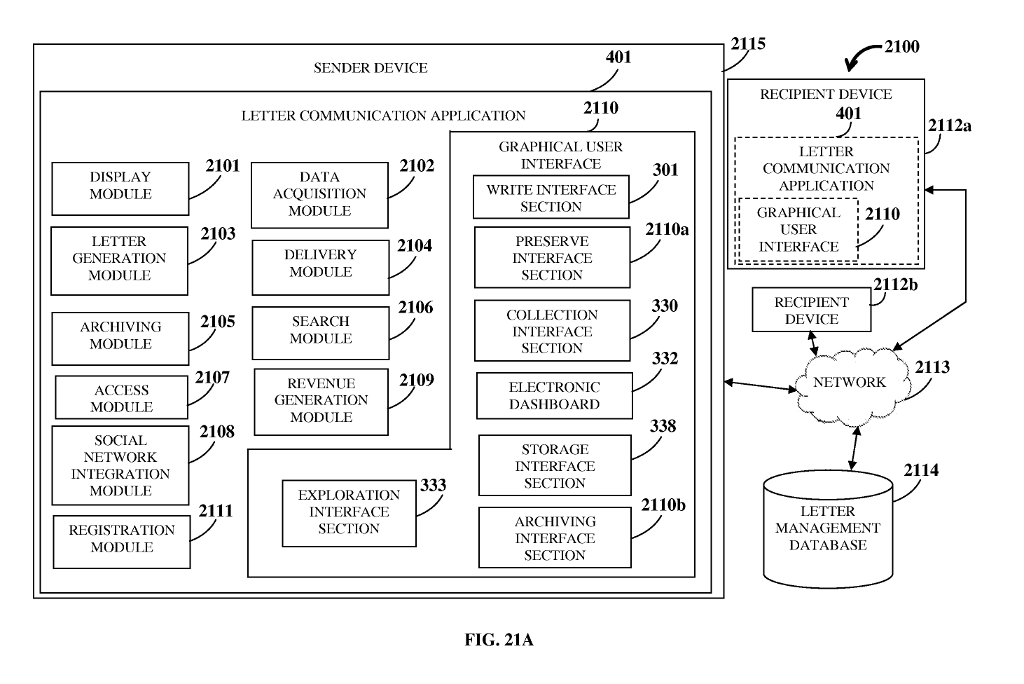

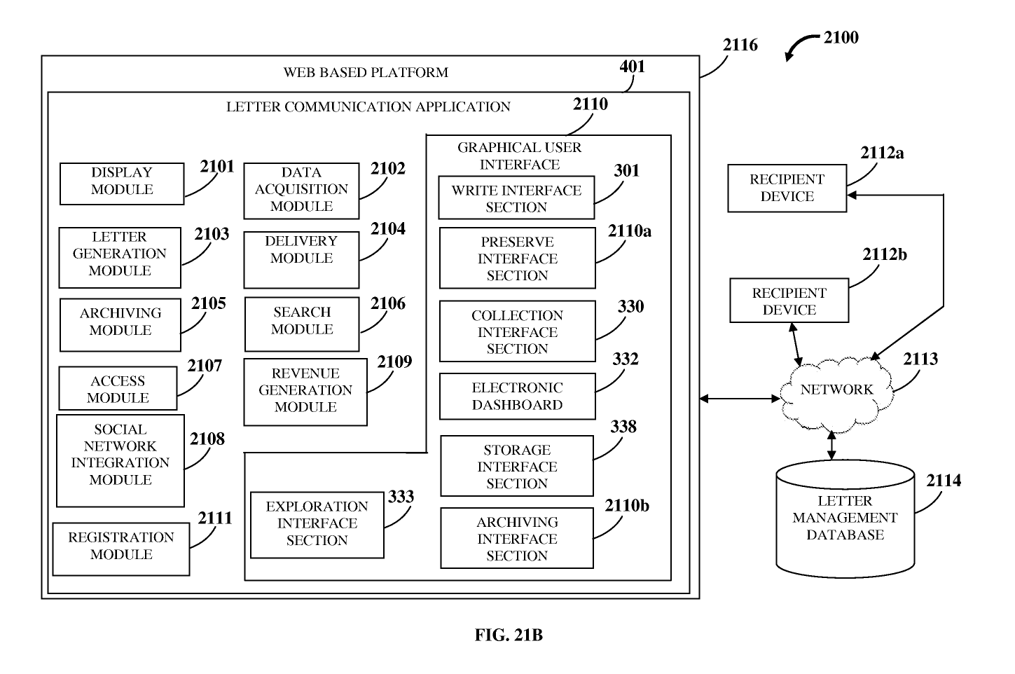

FIGS. 21A-21B illustrate embodiments of a computer implemented system 2100 for generating, communicating, and managing letters of multiple different formats, for example, a digital format and a non-digital format. The computer implemented system 2100 disclosed herein comprises the letter management database 2114 and the letter communication application 401 accessible via a sender device 2115 and one or more recipient devices 2112a and 2112b, for example, a mobile phone, a laptop, etc., over a network 2113. The network 2113 is, for example, a wired network, a wireless network, a communication network that implements Wi-Fi® of the Wireless Ethernet Compatibility Alliance, Inc., an ultra-wideband communication network (UWB), a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a long-term evolution (LTE) mobile communication network, etc., a local area communication network, an internet connection network, an infrared communication network, etc., or a network formed from a combination of these networks.

The computer implemented system 2100 disclosed herein further comprises at least one processor and a non-transitory computer readable storage medium communicatively coupled to the processor. The non-transitory computer readable storage medium is configured to store modules 2101, 2102, 2103, 2104, 2105, 2106, 2107, 2108, 2109, 2110, 2111, etc., of the letter communication application 401 of the computer implemented system 2100. The letter management database 2114 is configured to upload, store, aggregate, archive, curate, organize, search, and provide access to the letters in different formats. The letter management database 2114 is further configured to communicate with the letter communication application 401 via the network 2113. In an embodiment, the letter communication application 401 is downloaded on a sender device 2115 and a recipient device 2112a as exemplarily illustrated in FIG. 21A. In another embodiment, the letter communication application 401 is implemented on a web based platform 2116 as exemplarily illustrated in FIG. 21B. The sender device 2115 and the recipient devices 2112a and 2112b access the web based platform 2116 via the network 2113 as exemplarily illustrated in FIG. 21B.

The letter communication application 401 comprises modules executable by at least one processor configured to generate, communicate, manage, and provide access to letters in different formats. The modules of the letter communication application 401 comprise a display module 2101, a data acquisition module 2102, a letter generation module 2103, a delivery module 2104, an access module 2107, a search module 2106, an archiving module 2105, a social network integration module 2108, a revenue generation module 2109, a graphical user interface (GUI) 2110, and a registration module 2111. The GUI 2110 of the letter communication application 401 comprises a write interface section 301, a preserve interface section 2110a, the electronic dashboard 332, a collection interface section 330, a storage interface section 338, an archiving interface section 2110b, and an exploration interface section 333. The write interface section 301 is configured to enable writing and delivery of a personalized letter. The preserve interface section 2110a is configured to enable uploading, commenting, dating, and archiving of a hand written letter in the letter management database 2114 via the storage interface section 338 and the electronic dashboard 332. The electronic dashboard 332 is configured to display the personalized letter generated by the letter generation module 2103, the customized adornment objects 341, and other letters. The collection interface section 330 is configured to receive the generated personalized letter and enable viewing and organization of the generated personalized letter and other letters. The storage interface section 338 is configured to enable sliding and dragging of the generated personalized letter and other letters to the electronic dashboard 332. The archiving interface section 2110b is configured to maintain the generated personalized letter and other letters based on sort parameters comprising, for example, design, theme, content, origin, tags, destination, etc. The exploration interface section 333 is configured to enable a search for letters based on the search options.

The registration module 2111 is configured to register senders and recipients with the letter communication application 401. The registration module 2111 is configured to assign a unique identification code, for example, a post box number to each recipient on registration of the recipient with the letter communication application 401. The unique identification code is configured as a recipient identifier for the delivery of the personalized letter. The display module 2101 is configured to display multiple themes and writing style options on the sender device 2115 via the GUI 2110 provided by the letter communication application 401. The data acquisition module 2102 is configured to acquire a selection of one or more of the displayed themes and one or more of the displayed writing style options from the sender device 2115 via the GUI 2110 for generating a personalized letter. The data acquisition module 2102 is further configured to acquire media content, for example, textual content, image content, audio content, video content, multimedia content, digital content, electronic mail content, messaging content, voicemail content, document content, social media content, or any combination thereof, and tags for the generation of the personalized letter from the sender device 2115 via the GUI 2110.

The letter generation module 2103 is configured to generate the personalized letter based on the acquired selection of one or more of the displayed themes and one or more of the displayed writing style options, the acquired media content, and the tags. In an embodiment, the display module 2101 is further configured to display multiple customizable display elements on the sender device 2115 via the GUI 2110. The data acquisition module 2102 is further configured to acquire a selection of one or more customizable display elements from the sender device 2115 via the GUI 2110. The letter generation module 2103 is also configured to generate the personalized letter based on the acquired selection of one or more of the customizable display elements. The letter generation module 2103 is further configured to analyze the acquired media content and convert selective portions of the acquired media content into a consequent letter. The data acquisition module 2102 is further configured to upload and store existing letters in the letter management database 2114. The letter generation module 2103, in communication with the letter management database 2114, is configured to preserve the existing letters or generate the personalized letter using the existing letters.

The display module 2101 is further configured to display multiple delivery options on the sender device 2115 via the GUI 2110 for delivering the generated personalized letter. The delivery options comprise, for example, delivering the generated personalized letter on demand to each of one or more recipients via postal mail, printing the generated personalized letter for delivering the printed personalized letter, posting the generated personalized letter on an electronic dashboard 332 exemplarily illustrated in FIG. 3D, provided on the GUI 2110 by the letter communication application 401 of each of the recipients, and delivering a digital notification of the generated personalized letter to each of the recipient devices 2112a and 2112b via one or more of multiple communication modes. The data acquisition module 2102 is further configured to acquire a selection of one or more of the displayed delivery options and at least one recipient identifier, for example, a unique identification code, an electronic mail address, a postal address, a social network identification address, etc., of each of one or more recipients from the sender device 2115 via the GUI 2110. The data acquisition module 2102 is further configured to acquire transactional information comprising, for example, stationery options for printing the generated personalized letter, payment options for delivering the generated personalized letter via postal mail, etc., from the sender device 2115 via the GUI 2110.

The delivery module 2104 is configured to deliver the generated personalized letter in one or more different formats to each of one or more recipients and/or the recipient devices 2112a and 2112b of the recipients using the acquired selection of one or more of the displayed delivery options and at least one recipient identifier. The delivery module 2104 is further configured to create a physical address using at least one recipient identifier for delivering the generated personalized letter to each of one or more recipients via postal mail as disclosed in the detailed description of FIGS. 11A-11F. The delivery module 2104 is further configured to deliver the digital notification of the generated personalized letter to an electronic mail address of the recipients or post the digital notification on the electronic dashboard 332 of each of the recipients, or deliver the digital notification to a social network identification address of each of the recipients, or deliver the digital notification to each of one or more of multiple electronic platforms and channels via the electronic dashboard 332. The delivery module 2104 is further configured to deliver the generated personalized letter at a present date or a future date to each of the recipients via postal mail or digital mail. The delivery module 2104 is further configured to deliver the generated personalized letter to each of the recipients based on changes detected in a social graph of a sender and each of the recipients.

The access module 2107 is configured to facilitate access to the generated personalized letter through one or more of multiple access modes via the letter management database 2114 as disclosed in the detailed description of FIG. 1. In an embodiment, the access module 2107 is further configured to insert one of the access modes, for example, a digital access identifier such as a uniform resource locator (URL), a quick response (QR) code, etc., on the generated personalized letter as disclosed in the detailed description of FIG. 1 and FIGS. 3A-3D. The access module 2107 is further configured to acquire approval from the sender device 2115 and each of the recipient devices 2112a and 2112b via the GUI 2110 for sharing the generated personalized letter publicly on an electronic dashboard 332 provided on the GUI 2110 by the letter communication application 401.

The search module 2106 is configured to search for the generated personalized letter and other letters in the letter management database 2114 via one or more of multiple search options, for example, a category based search, a topic based search, a tag based search, a keyword based search, a timestamp based search, a user based search, a date based search, a popularity based search, etc. The archiving module 2105 is configured to archive the generated personalized letter from the electronic dashboard 332 displayed on the GUI 2110 on the sender device 2115 and each of the recipient devices 2112a and 2112b. The social network integration module 2108 is configured to integrate multiple social networking applications within the letter communication application 401 via the network 2113. The integration is configured to facilitate the generation and delivery of the personalized letter, and communication of the generated personalized letter via the network 2113.

In an embodiment, the display module 2101 is further configured to display customizable adornment objects 341 for display on the electronic dashboard 332 provided on the GUI 2110. The customizable adornment objects 341 are configured for static display, for integration of media files and digital links to electronic commerce destinations, advertisements, and revenue generation options, and for triggering of one or more incentives. The revenue generation module 2109 is configured to generate revenue, for example, by providing customizable adornment objects 341 for display and selection on the electronic dashboard 332 provided on the GUI 2110, and for sponsorship for a predetermined fee, by providing one or more themes for generation of the personalized letter and for sponsorship for a predetermined fee, and by delivering the generated personalized letter to each of the recipients via postal mail.

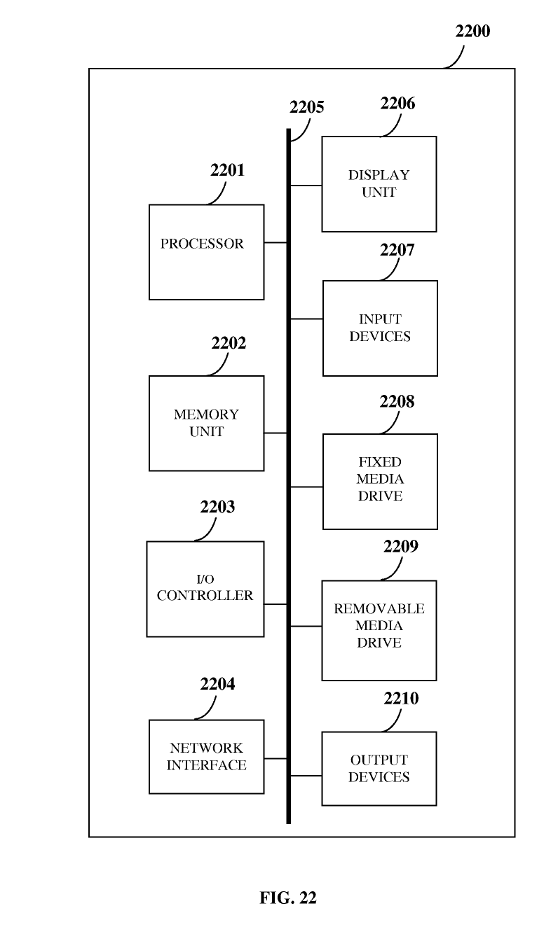

FIG. 22 exemplarily illustrates an architecture of a computer system 2200 employed by the letter communication application 401 for generating, communicating, and managing letters of multiple different formats. The letter communication application 401 of the computer implemented system 2100 exemplarily illustrated in FIGS. 21A-21B employs the architecture of the computer system 2200 exemplarily illustrated in FIG. 22. The computer system 2200 is programmable using a high level computer programming language. The computer system 2200 may be implemented using specially programmed, special purpose hardware.

The letter communication application 401 communicates with the sender device 2115 and the recipient devices 2112a and 2112b via a network 2113, for example, a short range network or a long range network. The network 2113 is, for example, the internet, a local area network, a wide area network, a wired network, a wireless network, a mobile communication network, etc. The computer system 2200 comprises, for example, a processor 2201, a memory unit 2202 for storing programs and data, an input/output (I/O) controller 2203, a network interface 2204, a data bus 2205, a display unit 2206, input devices 2207, a fixed media drive 2208, a removable media drive 2209 for receiving removable media, output devices 2210, etc.

The term “processor” refers to any one or more microprocessors, central processing unit (CPU) devices, finite state machines, computers, microcontrollers, digital signal processors, logic, a logic device, an electronic circuit, an application specific integrated circuit (ASIC), a field-programmable gate array (FPGA), a chip, etc., or any combination thereof, capable of executing computer programs or a series of commands, instructions, or state transitions. The processor 2201 may also be implemented as a processor set comprising, for example, a general purpose microprocessor and a math or graphics co-processor. The processor 2201 is selected, for example, from the Intel® processors such as the Itanium® microprocessor or the Pentium® processors, Advanced Micro Devices (AMD®) processors such as the Athlon® processor, UltraSPARC® processors, MicroSPARC™ processors, HP® processors, International Business Machines (IBM®) processors such as the PowerPC® microprocessor, the MIPS® reduced instruction set computer (RISC) processor of MIPS Technologies, Inc., RISC based computer processors of ARM Holdings, Motorola® processors, etc. The computer implemented system 2100 disclosed herein is not limited to a computer system 2200 employing a processor 2201. The computer system 2200 may also employ a controller or a microcontroller.

The memory unit 2202 is used for storing programs, applications, and data. For example, the display module 2101, the data acquisition module 2102, the letter generation module 2103, the delivery module 2104, the access module 2107, the search module 2106, the archiving module 2105, the social network integration module 2108, the revenue generation module 2109, the registration module 2111, etc., of the letter communication application 401 are stored in the memory unit 2202 of the computer system 2200. The memory unit 2202 is, for example, a random access memory (RAM) or another type of dynamic storage device that stores information and instructions for execution by the processor 2201. The memory unit 2202 also stores temporary variables and other intermediate information used during execution of the instructions by the processor 2201. The computer system 2200 further comprises a read only memory (ROM) or another type of static storage device that stores static information and instructions for the processor 2201.

The network interface 2204 enables connection of the computer system 2200 to the network 2113. For example, the letter communication application 401 connects to the network 2113 via the network interface 2204. In an embodiment, the network interface 2204 is provided as an interface card also referred to as a line card. The network interface 2204 comprises, for example, one or more of an infrared (IR) interface, an interface implementing Wi-Fi® of the Wireless Ethernet Compatibility Alliance, Inc., a universal serial bus (USB) interface, a FireWire® interface of Apple, Inc., an Ethernet interface, a frame relay interface, a cable interface, a digital subscriber line (DSL) interface, a token ring interface, a peripheral controller interconnect (PCI) interface, a local area network (LAN) interface, a wide area network (WAN) interface, interfaces using serial protocols, interfaces using parallel protocols, and Ethernet communication interfaces, asynchronous transfer mode (ATM) interfaces, a high speed serial interface (HSSI), a fiber distributed data interface (FDDI), interfaces based on transmission control protocol (TCP)/internet protocol (IP), interfaces based on wireless communications technology such as satellite technology, radio frequency (RF) technology, near field communication, etc. The I/O controller 2203 controls input actions and output actions performed by the letter communication application 401. The data bus 2205 permits communications between the modules, for example, 2101, 2102, 2103, 2104, 2105, 2106, 2107, 2108, 2109, 2110, 2111, etc., of the letter communication application 401.

The display unit 2206, via the graphical user interface (GUI) 2110, displays information, display interfaces, user interface elements such as text fields, checkboxes, text boxes, windows, etc., for example, for displaying multiple themes, writing style options, delivery options, etc., provided by the letter communication application 401. The display unit 2206 comprises, for example, a liquid crystal display, a plasma display, an organic light emitting diode (OLED) based display, etc. The input devices 2207 are used for inputting data into the computer system 2200. For example, a user types, uploads, comments, etc., a personalized letter, etc., using the input devices. The input devices 2207 are, for example, a keyboard such as an alphanumeric keyboard, a joystick, a pointing device such as a computer mouse, a touch pad, a light pen, a physical button, a pointing device, a touch sensitive display device, a track ball, a pointing stick, any device capable of sensing a tactile input, etc.

Computer applications and programs are used for operating the computer system 2200. The programs are loaded onto the fixed media drive 2208 and into the memory unit 2202 of the computer system 2200 via the removable media drive 2209. In an embodiment, the computer applications and programs may be loaded directly via the network 2113. Computer applications and programs are executed by double clicking a related icon displayed on the display unit 2206 using one of the input devices 2207. The output devices 2210 output the results of operations performed by the letter communication application 401. For example, the letter communication application 401 displays the generated personalized letter on the GUI 2110 using the output devices 2210.

The processor 2201 executes an operating system, for example, the Linux® operating system, the Unix® operating system, any version of the Microsoft® Windows® operating system, the Mac OS of Apple Inc., the IBM® OS/2, VxWorks® of Wind River Systems, inc., QNX Neutrino® developed by QNX Software Systems Ltd., Palm OS®, the Solaris operating system developed by Sun Microsystems, Inc., the Android operating system, Windows Phone™ operating system of Microsoft Corporation, BlackBerry® operating system of Research in Motion Limited, the iOS operating system of Apple Inc., the Symbian® operating system of Symbian Foundation Limited, etc. The computer system 2200 employs the operating system for performing multiple tasks. The operating system is responsible for management and coordination of activities and sharing of resources of the computer system 2200. The operating system further manages security of the computer system 2200, peripheral devices connected to the computer system 2200, and network connections. The operating system employed on the computer system 2200 recognizes, for example, inputs provided by the users using one of the input devices 2207, the output display, files, and directories stored locally on the fixed media drive 2208, for example, a hard drive. The operating system on the computer system 2200 executes different programs using the processor 2201. The processor 2201 and the operating system together define a computer platform for which application programs in high level programming languages are written.

The processor 2201 retrieves instructions for executing the modules, for example, 2101, 2102, 2103, 2104, 2105, 2106, 2107, 2108, 2109, 2111, etc., of the letter communication application 401 from the memory unit 2202. A program counter determines the location of each of the instructions in the memory unit 2202. The program counter stores a number that identifies the current position in the program of each of the modules, for example, 2101, 2102, 2103, 2104, 2105, 2106, 2107, 2108, 2109, 2111, etc., of the letter communication application 401. The instructions fetched by the processor 2201 from the memory unit 2202 after being processed are decoded. The instructions are stored in an instruction register in the processor 2201. After processing and decoding, the processor 2201 executes the instructions. For example, the registration module 2111 defines instructions for registering senders and recipients with the letter communication application 401. Furthermore, the registration module 2111 defines instructions for assigning a unique identification code, for example, a post box number to each of the recipients on registration of the recipients with the letter communication application 401. The display module 2101 defines instructions for displaying multiple themes and writing style options on the sender device 2115 via the GUI 2110 provided by the letter communication application 401. The data acquisition module 2102 defines instructions for acquiring a selection of one or more of the displayed themes and one or more of the displayed writing style options from the sender device 2115 via the GUI 2110 for generating a personalized letter. Furthermore, the data acquisition module 2102 defines instructions for acquiring media content and tags for the generation of the personalized letter from the sender device 2115 via the GUI 2110.

The letter generation module 2103 defines instructions for generating the personalized letter based on the acquired selection of one or more of the displayed themes and one or more of the displayed writing style options, the acquired media content and the tags. Furthermore, the letter generation module 2103 defines instructions for analyzing the acquired media content and converting selective portions of the acquired media content into a consequent letter. Furthermore, the display module 2101 defines instructions for displaying multiple customizable display elements on the sender device 2115 via the GUI 2110. The data acquisition module 2102 defines instructions for acquiring a selection of one or more customizable display elements from the sender device 2115 via the GUI 2110. The letter generation module 2103 defines instructions for generating the personalized letter based on the acquired selection of one or more the customizable display elements. The data acquisition module 2102 defines instructions for uploading and storing existing letters in the letter management database 2114. The letter generation module 2103, in communication with the letter management database 2114, defines instructions for preserving the existing letters or generating the personalized letter using the existing letters.

Furthermore, the display module 2101 defines instructions for displaying multiple delivery options on the sender device 2115 via the GUI 2110 for delivering the generated personalized letter. The data acquisition module 2102 defines instructions for acquiring a selection of one or more of the displayed delivery options and at least one recipient identifier of each of one or more recipients from the sender device 2115 via the GUI 2110. Furthermore, the data acquisition module 2102 defines instructions for acquiring transactional information from the sender device 2115 via the GUI 2110.

The delivery module 2104 defines instructions for delivering the generated personalized letter in one or more different formats to each of one or more recipients and/or the recipient devices 2112a and 2112b of the recipients using the acquired selection of one or more of the displayed delivery options and at least one recipient identifier. Furthermore, the delivery module 2104 defines instructions for creating a physical address using at least one recipient identifier for delivering the generated personalized letter to each of the recipients via postal mail. Furthermore, the delivery module 2104 defines instructions for delivering a digital notification of the generated personalized letter to an electronic mail address of each of the recipients, or posting the digital notification on an electronic dashboard 332 of each of the recipients, or delivering the digital notification to a social network identification address of each of the recipients, or delivering the digital notification to each of one or more of multiple electronic platforms and channels via the electronic dashboard 332. Furthermore, the delivery module 2104 defines instructions for delivering the generated personalized letter at a present date or a future date to each of the recipients via postal mail or digital mail. Furthermore, the delivery module 2104 defines instructions for delivering the generated personalized letter to each of the recipients based on changes detected in a social graph of a sender and each of the recipients.

The access module 2107 defines instructions for facilitating access to the generated personalized letter through one or more of multiple access modes via the letter management database 2114. Furthermore, the access module 2107 defines instructions for inserting one of the access modes, for example, the digital access identifier on the generated personalized letter. Furthermore, the access module 2107 defines instructions for acquiring approval from the sender device 2115 and each of the recipient devices 2112a and 2112b via the GUI 2110 for sharing the generated personalized letter publicly on the electronic dashboard 332. The search module 2106 defines instructions for searching the generated personalized letter and other letters in the letter management database 2114 via one or more of multiple search options. The archiving module 2105 defines instructions for archiving the generated personalized letter from the electronic dashboard 332 displayed on the GUI 2110 on the sender device 2115 and each of the recipient devices 2112a and 2112b. The social network integration module 2108 defines instructions for integrating multiple social networking applications within the letter communication application 401 via the network 2113.

Furthermore, the display module 2101 defines instructions for displaying customizable adornment objects 341 for display on the electronic dashboard 332 provided on the GUI 2110. The revenue generation module 2109 defines instructions for generating revenue by one or more of providing customizable adornment objects 341 for display and selection on the electronic dashboard 332 provided on the GUI 2110, and for sponsorship for a predetermined fee, providing one or more themes for the generation of the personalized letter and for sponsorship for a predetermined fee, and delivering the generated personalized letter to each of one or more recipients via postal mail.

The processor 2201 of the computer system 2200 employed by the letter communication application 401 retrieves the instructions defined by the registration module 2111, the display module 2101, the data acquisition module 2102, the letter generation module 2103, the delivery module 2104, the access module 2107, the search module 2106, the archiving module 2105, the social network integration module 2108, and the revenue generation module 2109 of the letter communication application 401, and executes the instructions, thereby performing one or more processes defined by those instructions.

At the time of execution, the instructions stored in the instruction register are examined to determine the operations to be performed. The processor 2201 then performs the specified operations. The operations comprise arithmetic operations and logic operations. The operating system performs multiple routines for performing a number of tasks required to assign the input devices 2207, the output devices 2210, and memory for execution of the modules, for example, 2101, 2102, 2103, 2104, 2105, 2106, 2107, 2108, 2109, 2111, etc., of the letter communication application 401. The tasks performed by the operating system comprise, for example, assigning memory to the modules, for example, 2101, 2102, 2103, 2104, 2105, 2106, 2107, 2108, 2109, 2111, etc., of the letter communication application 401, and to data used by the letter communication application 401, moving data between the memory unit 2202 and disk units, and handling input/output operations. The operating system performs the tasks on request by the operations and after performing the tasks, the operating system transfers the execution control back to the processor 2201. The processor 2201 continues the execution to obtain one or more outputs. The outputs of the execution of the modules, for example, 2101, 2102, 2103, 2104, 2105, 2106, 2107, 2108, 2109, 2111, etc., of the letter communication application 401 are displayed to the user on the display unit 2206.

For purposes of illustration, the detailed description refers to the letter communication application 401 being run locally on a computer system 2200; however the scope of the computer implemented method and system 2100 disclosed herein is not limited to the letter communication application 401 being run locally on the computer system 2200 via the operating system and the processor 2201, but may be extended to run remotely over the network 2113 by employing a web browser and a remote server, a mobile phone, or other electronic devices. One or more portions of the computer system 2200 may be distributed across one or more computer systems (not shown) coupled to the network 2113.

Disclosed herein is also a computer program product comprising a non-transitory computer readable storage medium that stores computer program codes comprising instructions executable by at least one processor 2201 for generating, communicating, and managing letters of multiple different formats. As used herein, the term “non-transitory computer readable storage medium” refers to all computer readable media, for example, non-volatile media such as optical discs or magnetic disks, volatile media such as a register memory, a processor cache, etc., and transmission media such as wires that constitute a system bus coupled to the processor 2201, except for a transitory, propagating signal.

The computer program codes comprise a first computer program code for displaying multiple themes and writing style options on a sender device 2115 via the GUI 2110; a second computer program code for acquiring a selection of one or more of the displayed themes and one or more of the displayed writing style options from the sender device 2115 via the GUI 2110 for generating a personalized letter; a third computer program code for acquiring media content and tags for the generation of the personalized letter from the sender device 2115 via the GUI 2110; a fourth computer program code for generating the personalized letter based on the acquired selection of one or more of the displayed themes and one or more of the displayed writing style options, the acquired media content, and the tags; a fifth computer program code for displaying multiple delivery options on the sender device 2115 via the GUI 2110 for delivering the generated personalized letter; a sixth computer program code for acquiring a selection of one or more of the displayed delivery options and at least one recipient identifier of each of one or more recipients from the sender device 2115 via the GUI 2110; a seventh computer program code for delivering the generated personalized letter in one or more of a digital format and a non-digital format to one or more recipient devices 2112a and 2112b using the acquired selection of one or more of the displayed delivery options and at least one recipient identifier; and a eighth computer program code for facilitating access to the generated personalized letter through one or more of multiple access modes via the letter management database 2114 as disclosed in the detailed description of FIG. 1.

The computer program product disclosed herein further comprises one or more additional computer program codes for performing additional steps that may be required and contemplated for generating, communicating, and managing letters of multiple different formats. In an embodiment, a single piece of computer program code comprising computer executable instructions performs one or more steps of the computer implemented method disclosed herein for generating, communicating, and managing letters of multiple different formats. The computer program codes comprising computer executable instructions are embodied on the non-transitory computer readable storage medium. The processor 2201 of the computer system 2200 retrieves these computer executable instructions and executes them. When the computer executable instructions are executed by the processor 2201, the computer executable instructions cause the processor 2201 to perform the steps of the computer implemented method for generating, communicating, and managing letters of multiple different formats.

It will be readily apparent that the various methods, algorithms, and computer programs disclosed herein may be implemented on computer readable media appropriately programmed for general purpose computers and computing devices. As used herein, the term “computer readable media” refers to non-transitory computer readable media that participate in providing data, for example, instructions that may be read by a computer, a processor or a similar device. Non-transitory computer readable media comprise all computer readable media, for example, non-volatile media, volatile media, and transmission media, except for a transitory, propagating signal. Non-volatile media comprise, for example, optical discs or magnetic disks and other persistent memory volatile media including a dynamic random access memory (DRAM), which typically constitutes a main memory. Volatile media comprise, for example, a register memory, a processor cache, a random access memory (RAM), etc. Transmission media comprise, for example, coaxial cables, copper wire, fiber optic cables, modems, etc., including wires that constitute a system bus coupled to a processor, etc. Common forms of computer readable media comprise, for example, a floppy disk, a flexible disk, a hard disk, magnetic tape, a laser disc, a Blu-ray Disc®, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

The computer programs that implement the methods and algorithms disclosed herein may be stored and transmitted using a variety of media, for example, the computer readable media in a number of manners. In an embodiment, hard wired circuitry or custom hardware may be used in place of, or in combination with, software instructions for implementation of the processes of various embodiments. Therefore, the embodiments are not limited to any specific combination of hardware and software. In general, the computer program codes comprising computer executable instructions may be implemented in any programming language. Other object-oriented, functional, scripting, and/or logical programming languages may also be used. The computer program codes or software programs may be stored on or in one or more mediums as object code. Various aspects of the computer implemented method and system disclosed herein may be implemented in a non-programmed environment comprising documents created, for example, in a hypertext markup language (HTML), an extensible markup language (XML), or other format that render aspects of a graphical user interface (GUI) or perform other functions, when viewed in a visual area or a window of a browser program. Various aspects of the method and system disclosed herein may be implemented as programmed elements, or non-programmed elements, or any suitable combination thereof. The computer program product disclosed herein comprises computer executable instructions embodied in a non-transitory computer readable storage medium, wherein the computer program product comprises one or more computer program codes for implementing the processes of various embodiments.

Where databases are described such as the letter management database 2114, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the system, the databases may be integrated to communicate with each other for enabling simultaneous updates of data linked across the databases, when there are any updates to the data in one of the databases.

The present invention can be configured to work in a network environment comprising one or more computers that are in communication with one or more devices via a network. The computers may communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices may comprise processors, for example, the Intel® processors, Advanced Micro Devices (AMD®) processors, UltraSPARC® processors, HP® processors, International Business Machines (IBM®) processors, RISC based computer processors of ARM Holdings, Motorola® processors, etc., that are adapted to communicate with the computers. In an embodiment, each of the computers is equipped with a network communication device, for example, a network interface card, a modem, or other network connection device suitable for connecting to a network. Each of the computers and the devices executes an operating system, for example, the Linux® operating system, the Unix® operating system, any version of the Microsoft® Windows® operating system, the Mac OS of Apple Inc., the IBM® OS/2, the Palm OS®, the Solaris operating system developed by Sun Microsystems, Inc., or any other operating system. Handheld devices execute operating systems, for example, the Android operating system, the Windows Phone™ operating system of Microsoft Corporation, the BlackBerry® operating system of Research in Motion Limited, the iOS operating system of Apple Inc., the Symbian® operating system of Symbian Foundation Limited, etc. While the operating system may differ depending on the type of computer, the operating system will continue to provide the appropriate communications protocols to establish communication links with the network. Any number and type of machines may be in communication with the computers.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

I claim:

1. A computer implemented method for generating, communicating, and managing letters in a plurality of different formats, comprising:
providing a letter management database configured to upload, store, aggregate, archive, curate, organize, search, and provide access to said letters of said different formats;
providing a letter communication application executable by at least one processor configured to generate, communicate, manage, and provide access to said letters of said different formats, wherein said letter communication application is accessible via a sender device and one or more recipient devices via a network, and wherein said letter communication application is configured to communicate with said letter management database via said network;
displaying a plurality of themes and writing style options on said sender device via a graphical user interface provided by said letter communication application;
acquiring a first selection of one or more of said displayed themes and one or more of said displayed writing style options from said sender device by said letter communication application via said graphical user interface for generating a personalized letter;
acquiring media content and tags for said generation of said personalized letter from said sender device by said letter communication application via said graphical user interface;
generating said personalized letter by said letter communication application based on said acquired first selection of said one or more of said displayed themes and said one or more of said displayed writing style options, and said acquired media content and said tags;
displaying a plurality of delivery options on said sender device by said letter communication application via said graphical user interface for delivering said generated personalized letter;
acquiring a second selection of one or more of said displayed delivery options and at least one recipient identifier of each of one or more recipients from said sender device by said letter communication application via said graphical user interface;
delivering said generated personalized letter in one or more of said different formats to one of said one or more recipients, said one or more recipient devices of said one or more recipients, and a combination thereof, by said letter communication application using said acquired second selection of said one or more of said displayed delivery options and said at least one recipient identifier; and
facilitating access to said generated personalized letter through one or more of a plurality of access modes by said letter communication application via said letter management database.

2. The computer implemented method of claim 1, wherein said different formats comprise a digital format and a non-digital format.

3. The computer implemented method of claim 1, wherein said media content comprises one or more of textual content, image content, audio content, video content, multimedia content, digital content, electronic mail content, messaging content, voicemail content, document content, social media content, and any combination thereof.

4. The computer implemented method of claim 1, further comprising creating a physical address using said at least one recipient identifier by said letter communication application for delivering said generated personalized letter to said each of said one or more recipients via postal mail.

5. The computer implemented method of claim 1, further comprising analyzing said acquired media content and converting selective portions of said acquired media content into a consequent letter by said letter communication application.

6. The computer implemented method of claim 1, wherein said access modes comprise:
a digital access identifier inserted on said generated personalized letter by said letter communication application, wherein said digital access identifier is configured to allow each of said one or more recipient devices to one of add said generated personalized letter to an electronic dashboard provided on said graphical user interface by said letter communication application, and retrieve said generated personalized letter from said letter management database, and to preserve and share said generated personalized letter;
said electronic dashboard provided on said graphical user interface by said letter communication application for sharing said generated personalized letter and other said letters;
said at least one recipient identifier for retrieval of said generated personalized letter from said letter management database by said each of said one or more recipients; and
digital notifications of said generated personalized letter delivered to said each of said one or more recipient devices via one of an electronic mail address of said each of said one or more recipients, said electronic dashboard, a social network identification address of said each of said one or more recipients, and one or more of a plurality of electronic platforms and channels.

7. The computer implemented method of claim 1, further comprising:
displaying a plurality of customizable display elements on said sender device by said letter communication application via said graphical user interface; and
acquiring a third selection of one or more of said customizable display elements from said sender device by said letter communication application via said graphical user interface, wherein said letter communication application is configured to generate said personalized letter based on said acquired third selection of said one or more of said customizable display elements.

8. The computer implemented method of claim 1, further comprising uploading and storing existing letters in said letter management database by said letter communication application, wherein said letter communication application, in communication with said letter management database, is configured to one of preserve said existing letters and generate said personalized letter using said existing letters.

9. The computer implemented method of claim 1, further comprising searching for said generated personalized letter and other said letters in said letter management database via one or more of a plurality of search options by said letter communication application, wherein said search options comprise a category based search, a topic based search, a tag based search, a keyword based search, a timestamp based search, a user based search, a date based search, and a popularity based search.

10. The computer implemented method of claim 1, wherein said delivery options comprise delivering said generated personalized letter on demand to said each of said one or more recipients via postal mail, printing said generated personalized letter for delivering said printed personalized letter, posting said generated personalized letter on an electronic dashboard provided on said graphical user interface by said letter communication application of said each of said one or more recipients, and delivering a digital notification of said generated personalized letter to each of said one or more recipient devices via one or more of a plurality of communication modes.

11. The computer implemented method of claim 10, wherein said delivery of said digital notification of said generated personalized letter to said each of said one or more recipient devices comprises one or more of delivering said digital notification to an electronic mail address of said each of said one or more recipients, posting said digital notification on said electronic dashboard, delivering said digital notification to a social network identification address of said each of said one or more recipients, and delivering said digital notification to each of one or more of a plurality of electronic platforms and channels via said electronic dashboard.

12. The computer implemented method of claim 10, wherein said delivery of said generated personalized letter on demand to said each of said one or more recipients via said postal mail comprises acquiring transactional information from said sender device by said letter communication application via said graphical user interface, wherein said transactional information comprises stationery options for printing said generated personalized letter and payment options for delivering said generated personalized letter via said postal mail.

13. The computer implemented method of claim 1, wherein said delivery options comprise:
delivering said generated personalized letter at one of a present date and a future date to said each of said one or more recipients via one of postal mail and digital mail; and
delivering said generated personalized letter to said each of said one or more recipients based on changes detected in a social graph of a sender and said each of said one or more recipients.

14. The computer implemented method of claim 1, further comprising archiving said generated personalized letter from an electronic dashboard displayed on said graphical user interface on said sender device and each of said one or more recipient devices by said letter communication application.

15. The computer implemented method of claim 1, further comprising acquiring approval from said sender device and each of said one or more recipient devices by said letter communication application via said graphical user interface for sharing said generated personalized letter publicly on an electronic dashboard provided on said graphical user interface by said letter communication application.

16. The computer implemented method of claim 1, wherein said at least one recipient identifier is one of a unique identification code, an electronic mail address, a postal address, and a social network identification address of said each of said one or more recipients.

17. The computer implemented method of claim 1, further comprising assigning a unique identification code to each of a plurality of recipients by said letter communication application on registration of said recipients with said letter communication application, wherein said unique identification code is configured as a recipient identifier for said delivery of said generalized personalized letter.

18. The computer implemented method of claim 1, further comprising providing customizable adornment objects by said letter communication application for display on an electronic dashboard provided on said graphical user interface, wherein said customizable adornment objects are configured for one or more of a static display, an integration of media files and digital links to electronic commerce destinations, advertisements, and revenue generation options, and triggering of one or more incentives.

19. The computer implemented method of claim 1, further comprising generating revenue by said letter communication application by one or more of:
providing customizable adornment objects for display and selection on an electronic dashboard provided on said graphical user interface by said letter communication application, and for sponsorship, for a predetermined fee;
providing one or more of said themes for said generation of said personalized letter and for sponsorship for a predetermined fee; and
delivering said generated personalized letter to said each of said one or more recipients via postal mail.

20. The computer implemented method of claim 1, further comprising sending and receiving digital notifications on a plurality of transaction events via one or more of a plurality of communication modes by said letter communication application.

21. The computer implemented method of claim 1, further comprising integrating a plurality of social networking applications within said letter communication application via said network, wherein said integration is configured to facilitate said generation and said delivery of said personalized letter, and communication of said generated personalized letter via said network.

22. The computer implemented method of claim 1, wherein said letter communication application is configured as one of a web based platform and a software application downloadable on said sender device and each of said one or more recipient devices.

23. A computer implemented system for generating, communicating, and managing letters in a plurality of different formats, comprising:
at least one processor;
a non-transitory computer readable storage medium communicatively coupled to said at least one processor, said non-transitory computer readable storage medium configured to store modules of a letter communication application in said computer implemented system;
a letter management database configured to upload, store, aggregate, archive, curate, organize, search, and provide access to said letters of said different formats, wherein said letter management database is further configured to communicate with said letter communication application via a network; and
said letter communication application comprising said modules executable by said at least one processor configured to generate, communicate, manage, and provide access to said letters of said different formats, wherein said letter communication application is accessible via a sender device and one or more recipient devices via said network, and wherein said modules of said letter communication application comprise:
a display module configured to display a plurality of themes and writing style options on said sender device via a graphical user interface provided by said letter communication application;
a data acquisition module configured to acquire a first selection of one or more of said displayed themes and one or more of said displayed writing style options from said sender device via said graphical user interface for generating a personalized letter;
said data acquisition module configured to acquire media content and tags for said generation of said personalized letter from said sender device via said graphical user interface;
a letter generation module configured to generate said personalized letter based on said acquired first selection of said one or more of said displayed themes and said one or more of said displayed writing style options, and said acquired media content and said tags;
said display module configured to display a plurality of delivery options on said sender device via said graphical user interface for delivering said generated personalized letter;
said data acquisition module configured to acquire a second selection of one or more of said displayed delivery options and at least one recipient identifier of each of one or more recipients from said sender device via said graphical user interface;
a delivery module configured to deliver said generated personalized letter in one or more of said different formats to one of said one or more recipients, said one or more recipient devices of said one or more recipients, and a combination thereof, using said acquired second selection of said one or more of said displayed delivery options and said at least one recipient identifier; and
an access module configured to facilitate access to said generated personalized letter through one or more of a plurality of access modes via said letter management database.

24. The computer implemented system of claim 23, wherein said different formats comprise a digital format and a non-digital format.

25. The computer implemented system of claim 23, wherein said media content comprises one or more of textual content, image content, audio content, video content, multimedia content, digital content, electronic mail content, messaging content, voicemail content, document content, social media content, and any combination thereof.

26. The computer implemented system of claim 23, wherein said delivery module is further configured to create a physical address using said at least one recipient identifier for delivering said generated personalized letter to said each of said one or more recipients via postal mail.

27. The computer implemented system of claim 23, wherein said letter generation module is further configured to analyze said acquired media content and convert selective portions of said acquired media content into a consequent letter.

28. The computer implemented system of claim 23, wherein said access module is further configured to insert one of said access modes on said generated personalized letter, wherein said one of said access modes is a digital access identifier configured to allow each of said one or more recipient devices to one of add said generated personalized letter to an electronic dashboard provided on said graphical user interface by said letter communication application, and retrieve said generated personalized letter from said letter management database, and to preserve and share said generated personalized letter.

29. The computer implemented system of claim 23, wherein said access modes comprise:
an electronic dashboard provided on said graphical user interface by said letter communication application for sharing said generated personalized letter and other said letters;
said at least one recipient identifier for retrieval of said generated personalized letter from said letter management database by said each of said one or more recipients; and
digital notifications of said generated personalized letter delivered to each of said one or more recipient devices via one of an electronic mail address of said each of said one or more recipients, said electronic dashboard, a social network identification address of said each of said one or more recipients, and one or more of a plurality of electronic platforms and channels.

30. The computer implemented system of claim 23, wherein said display module is configured to display a plurality of customizable display elements on said sender device via said graphical user interface, and wherein said data acquisition module is configured to acquire a third selection of one or more of said customizable display elements from said sender device via said graphical user interface, and wherein said letter generation module is configured to generate said personalized letter based on said acquired third selection of said one or more of said customizable display elements.

31. The computer implemented system of claim 23, wherein said data acquisition module is configured to upload and store existing letters in said letter management database, wherein said letter generation module, in communication with said letter management database, is configured to one of preserve said existing letters and generate said personalized letter using said existing letters.

32. The computer implemented system of claim 23, wherein said modules of said letter communication application further comprise a search module configured to search for said generated personalized letter and other said letters in said letter management database via one or more of a plurality of search options, wherein said search options comprise a category based search, a topic based search, a tag based search, a keyword based search, a timestamp based search, a user based search, a date based search, and a popularity based search.

33. The computer implemented system of claim 23, wherein said delivery options comprise delivering said generated personalized letter on demand to said each of said one or more recipients via postal mail, printing said generated personalized letter for delivering said printed personalized letter, posting said generated personalized letter on an electronic dashboard provided on said graphical user interface by said letter communication application of said each of said one or more recipients, and delivering a digital notification of said generated personalized letter to each of said one or more recipient devices via one or more of a plurality of communication modes.

34. The computer implemented system of claim 23, wherein said delivery module is further configured to deliver a digital notification of said generated personalized letter to each of said one or more recipient devices by one or more of:
delivering said digital notification to an electronic mail address of said each of said one or more recipients;
posting said digital notification on an electronic dashboard provided on said graphical user interface by said letter communication application of said each of said one or more recipients;
delivering said digital notification to a social network identification address of said each of said one or more recipients; and
delivering said digital notification to each of one or more of a plurality of electronic platforms and channels via said electronic dashboard.

35. The computer implemented system of claim 23, wherein said data acquisition module is configured to acquire transactional information from said sender device via said graphical user interface, wherein said transaction information comprises stationery options for printing said generated personalized letter and payment options for delivering said generated personalized letter via postal mail.

36. The computer implemented system of claim 23, wherein said delivery module is further configured to deliver said generated personalized letter at one of a present date and a future date to said each of said one or more recipients via one of postal mail and digital mail, and to deliver said generated personalized letter to said each of said one or more recipients based on changes detected in a social graph of a sender and said each of said one or more recipients.

37. The computer implemented system of claim 23, wherein said modules of said letter communication application further comprise an archiving module configured to archive said generated personalized letter from an electronic dashboard displayed on said graphical user interface on said sender device and each of said one or more recipient devices.

38. The computer implemented system of claim 23, wherein said access module is further configured to acquire approval from said sender device and each of said one or more recipient devices via said graphical user interface for sharing said generated personalized letter publicly on an electronic dashboard provided on said graphical user interface by said letter communication application.

39. The computer implemented system of claim 23, wherein said at least one recipient identifier is one of a unique identification code, an electronic mail address, a postal address, and a social network identification address of said each of said one or more recipients.

40. The computer implemented system of claim 23, wherein said modules of said letter communication application further comprise a registration module configured to register senders and recipients, wherein said registration module is configured to assign a unique identification code to each of said recipients on said registration of said recipients with said letter communication application, wherein said unique identification code is configured as a recipient identifier for said delivery of said generalized personalized letter.

41. The computer implemented system of claim 23, wherein said display module is configured to display customizable adornment objects on an electronic dashboard provided on said graphical user interface, wherein said customizable adornment objects are configured for one or more of a static display, an integration of media files and digital links to electronic commerce destinations, advertisements, and revenue generation options, and triggering of one or more incentives.

42. The computer implemented system of claim 23, wherein said modules of said letter communication application further comprise a revenue generation module configured to generate revenue by one or more of:
providing customizable adornment objects for display and selection on an electronic dashboard provided on said graphical user interface by said letter communication application, and for sponsorship, for a predetermined fee;
providing one or more of said themes for said generation of said personalized letter and for sponsorship for a predetermined fee; and
delivering said generated personalized letter to said each of said one or more recipients via postal mail.

43. The computer implemented system of claim 23, wherein said graphical user interface provided by said letter communication application comprises:
an exploration interface section configured to enable a search for said letters based on a plurality of search options;
a write interface section configured to enable writing and delivery of said personalized letter;
a preserve interface section configured to enable upload, commenting, dating, and archiving of a hand written letter in said letter management database via a storage interface section and an electronic dashboard;
said electronic dashboard configured to display said generated personalized letter, customized adornment objects, and other said letters;
a collection interface section configured to receive said generated personalized letter and enable viewing and organization of said generated personalized letter and other said letters;
said storage interface section configured to enable sliding and dragging of said generated personalized letter and other said letters to said electronic dashboard; and
an archiving interface section configured to maintain said generated personalized letter and other said letters based on sort parameters, wherein said sort parameters comprise design, theme, content, origin, said tags, and destination.

44. The computer implemented system of claim 23, wherein said modules of said letter communication application further comprise a social network integration module configured to integrate a plurality of social networking applications within said letter communication application via said network, wherein said integration is configured to facilitate said generation and said delivery of said personalized letter, and said communication of said generated personalized letter via said network.

45. A computer program product comprising a non-transitory computer readable storage medium, said non-transitory computer readable storage medium storing computer program codes that comprise instructions executable by at least one processor, said computer program codes comprising:
a first computer program code for displaying a plurality of themes and writing style options on a sender device via a graphical user interface;
a second computer program code for acquiring a first selection of one or more of said displayed themes and one or more of said displayed writing style options from said sender device via said graphical user interface for generating a personalized letter;
a third computer program code for acquiring media content and tags for said generation of said personalized letter from said sender device via said graphical user interface;
a fourth computer program code for generating said personalized letter based on said acquired first selection of said one or more of said displayed themes and said one or more of said displayed writing style options, and said acquired media content and said tags;
a fifth computer program code for displaying a plurality of delivery options on said sender device via said graphical user interface for delivering said generated personalized letter;
a sixth computer program code for acquiring a second selection of one or more of said displayed delivery options and at least one recipient identifier of each of one or more recipients from said sender device via said graphical user interface;
a seventh computer program code for delivering said generated personalized letter in one or more of a digital format and a non-digital format to said one or more recipient devices using said acquired second selection of said one or more of said displayed delivery options and said at least one recipient identifier; and
an eighth computer program code for facilitating access to said generated personalized letter through one or more of a plurality of access modes via a letter management database, wherein said access modes comprise:
a digital access identifier inserted on said generated personalized letter to allow each of said one or more recipient devices to one of add said generated personalized letter to an electronic dashboard provided on said graphical user interface and retrieve said generated personalized letter from said letter management database, and to preserve and share said generated personalized letter;
said electronic dashboard provided on said graphical user interface for sharing said generated personalized letter and other said letters;
said at least one recipient identifier for retrieval of said generated personalized letter from said letter management database by said each of said one or more recipients; and
digital notifications of said generated personalized letter delivered to said each of said one or more recipient devices via one of an electronic mail address of said each of said one or more recipients, said electronic dashboard, a social network identification address of said each of said one or more recipients, and one or more of a plurality of electronic platforms and channels.
